(19) United States
(12) Patent Application Publication
(10) Pub. No.: US 2024/0090522 A1
(43) Pub. Date: Mar. 21, 2024

(54) Glycelles: Methods and Compositions For Casein Micelles Comprising Non-Bioactive Hydrophilic Compounds

(71) Applicant: Mozza Foods Inc., Los Angeles, CA (US)

(72) Inventors: Cory Tobin, Los Angeles, CA (US); Keith Curtis Flanegan, Rapid City, SD (US); Brady Johnson, Rapid City, SD (US); Erica Everson, Rapid City, SD (US)

(21) Appl. No.: 18/478,477

(22) Filed: Sep. 29, 2023

Related U.S. Application Data
(63) Continuation of application No. PCT/US23/32929, filed on Sep. 15, 2023.
(60) Provisional application No. 63/376,223, filed on Sep. 19, 2022.
(60) Provisional application No. 63/444,189, filed on Feb. 8, 2023.
(60) Provisional application No. 63/519,989, filed on Aug. 16, 2023.

(51) Int. Cl. A23C 9/15; A23C 9/152

(52) U.S. Cl. CPC A23C 9/1512; A23C 9/1526

(57) ABSTRACT

By integrating casein proteins with non-milk particles (for example, soy proteins), Glycelles achieve enhanced nutritional value, improved digestibility, and superior sensory attributes. This innovation addresses challenges associated with non-milk particles such as soy proteins, offering a sustainable, versatile, and healthful protein source with broad applications in the food, beverage, nutraceutical, sports nutrition, and dietary supplement sectors.

### CROSS REFERENCE TO RELATED APPLICATIONS

This application is a Continuation of International Application No. PCT/US23/32929 filed on Sep. 15, 2023, which claims the benefit of priority from U.S. Provisional Patent Application No. 63/376,223, filed Sep. 19, 2022; U.S. Provisional Patent Application No. 63/444,189, filed Feb. 8, 2023; and U.S. Provisional Patent Application No. 63/519,989, filed Aug. 16, 2023; all of which are herein incorporated by reference in their entirety.

### BACKGROUND OF THE INVENTION

Protein is an essential nutrient that supports a multitude of functions within the human body. Soy proteins, in particular, offer many advantages over alternative sources of protein, as an environmentally sustainable, versatile, and healthy food. Although nutritionally valuable, soy proteins, for many, have a less palatable taste compared to animal proteins, may not be as easily digested and absorbed by the human body as some animal proteins, and may contain anti-nutritional factors that can interfere with protein digestion and utilization. Moreover, soy components unfortunately negatively impact the functionality of casein micelles resulting in poor coagulation, a loose curd, and lengthened clotting time during cheese production. Therefore, there is a need for enhanced bioavailability and sensory acceptance of proteins like soy proteins.

### SUMMARY OF THE INVENTION

Some aspects of the current disclosure provide compositions, methods, and systems for making “glycelles” comprising casein proteins and non-milk particles such as soy as a food ingredient with enhanced nutrition, digestibility, sensory characteristics, functional properties, and stability. In some instances, glycelles combine beneficial properties of both dairy and plant-based proteins. It is contemplated that glycelles have wide applicability to several domains, including but not limited to the food and beverage industry, nutraceuticals, sports nutrition, and dietary supplements. In some instances, the non-milk particles are a non-bioactive compound. In some instances, the non-milk particles are hydrophilic or amphophilic or both. In some instances, the non-milk particles comprise soy globulin 7S (e.g., β-conglycinin) and 11S (e.g., glycinin), wherein the ratio of the 7S and the 11S (7S/11S) is lower than a naturally occurring ratio.

Some aspects of the current disclosure provide compositions, methods, and systems for making cheese using a soy ingredient having one or more soy proteins. In some instances, the soy ingredient is a seed storage protein comprising at least one of 7S (i.e., β-conglycinin) and 11S (i.e., glycinin), wherein the weight or molar ratio of 7S/11S is less than a naturally occurring weight or molar ratio. In some aspects, the current disclosure provides a new composition of milk augmented with soy proteins that minimizes the negative effects of soy on coagulation of casein micelles. In some instances, the soy ingredient is modified to change the ratio of β-conglycinin to glycinin, resulting in improved coagulation and cheese production. In some instances, changing the ratio of β-conglycinin to glycinin can be achieved by enriching one component or by removing the other component, or both.

Some aspects of the current disclosure provide a structure, comprising: an outer layer comprising κ-casein; and an interior comprising a non-milk particle and a casein protein comprising at least one of α_{S1}-casein, α_{S2}-casein, and β-casein. In some cases, the non-milk particle is a plant protein. In some cases, the plant protein comprises legumin, lectin, vicilin, prolamin, gliadin, β-conglycinin, or glycinin, or any combination thereof. In some cases, the plant protein is a soy protein. In some cases, the structure does not comprise at least one of α_{S1}-casein, α_{S2}-casein, or β-casein. In some cases, the interior comprises at least two of α_{S1}-casein, α_{S2}-casein, and β-casein. In some cases, the interior comprises α_{S1}-casein, α_{S2}-casein, and β-casein. In some cases, the structure comprises at least two soy proteins.

In some cases, the non-milk particle is a protein that is less than 5% (w/w), less than 3% (w/w), less than 1% (w/w), less than 0.5% (w/w), less than 0.1% (w/w), less than 0.05% (w/w), less than 0.01% (w/w), less than 0.005% (w/w), less than 0.001% (w/w), less than 0.0005% (w/w), less than 0.0001% (w/w), less than 0.00005% (w/w), or less than 0.00001% (w/w) of total protein content (i.e., weight) of the structure. In some cases, the non-milk particle is a protein that is more than 0.00001% (w/w), more than 0.00005% (w/w), more than 0.0001% (w/w), or more than 0.0005% (w/w), more than 0.001% (w/w), more than 0.005% (w/w), more than 0.01% (w/w), more than 0.05% (w/w), more than 0.1% (w/w), more than 0.5% (w/w), more than 1% (w/w), or more than 3% (w/w) of total protein content (i.e., weight) of the structure. For example, the non-milk particle is a soy protein that comprises, between 1% and 2% weight, between 1% and 5% weight, between 0.1% and 1% weight, between 0.01% and 0.05% weight, or between 0.001% and 0.01% weight of total protein content (i.e., weight) of the structure. In some cases, the non-milk particle is a soy protein that comprises, between 30% and 40% weight, between 31% and 36% weight, between 29% and 38% weight, between 25% and 35% weight, or between 20% and 40% weight of total protein content of the structure.

In some cases, the non-milk particle is hydrophilic as measured by the Kyte-Doolittle scale. The Kyte-Doolittle Scale, as well as related and relevant terms, including the grand average of hydropathicity (“GRAVY”), may be found in reference works, including but not limited to, Kyte, J., & Doolittle, R. F. (1982). A Simple Method for Displaying the Hydropathic Character of a Protein, Journal of Molecular Biology, 157(1), 105-132. https://doi.org/10.1016/0022-2836(82)90515-0. In some cases, the Kyte-Doolittle GRAVY score for the non-milk particle is less than 0 (i.e., hydrophilic), less than −0.01, less than −0.03, less than −0.07, less than −0.13, less than −0.21, less than −0.30, less than −0.41, less than −0.53, less than −0.67, less than −0.83, less than −1.01, less than −1.20, less than −1.40, less than −1.63, less than −1.87, less than −2.13, less than −2.40, less than −2.69, or less than −3.00.

Some aspects of the current disclosure provide a dairy or dairy-like composition comprising disclosed glycelles, wherein the glycelles confer upon characteristics of a dairy product selected from the group consisting of: taste, flavor, aroma, appearance, mouthfeel, density, structure, texture, elasticity, springiness, coagulation, binding, leavening, aeration, foaming, creaminess, and emulsification. In some cases, the dairy product is milk, milk powder, cheese, yogurt, ghee, or butter. In some cases, the food or beverage product is protein shakes, dairy alternatives, nutraceuticals, sports nutrition products, or dietary supplements. In some cases, the structure provides enhanced sensory characteristics.

Some aspects of the current disclosure provide a nutraceutical product, comprising the herein disclosed glycelles. In some cases, the nutraceutical product reduces cholesterol in a human after consumption of the nutraceutical product. Some aspects of the current disclosure provide a method of making the herein disclosed glycelles, comprising providing a solution comprising a non-milk particles; and mixing at least two casein proteins in a solution comprising a non-milk particle.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### DETAILED DESCRIPTION

Soy proteins are recognized for their high nutritional value, containing all essential amino acids required by the human body, and also for their beneficial health effects, such as cholesterol-lowering properties. Disclosed herein is a novel structure (i.e., glycelles) comprising casein proteins and non-milk particles (e.g., soy proteins). By incorporating the non-milk particles and casein proteins into glycelles, beneficial properties of both casein and the non-milk particles are conferred, as well as additional beneficial properties not found in either in isolation. In some aspects, the present disclosure provides a method for making glycelles.

In some cases, the non-milk particle is a protein. In some cases, the non-milk particle is a soy protein, for example, soy globulin 7S (e.g., β-conglycinin), 11S (e.g., glycinin), or both. In some embodiments of the present invention, the non-milk particles comprise 7S and 11S, wherein the ratio of the 7S and the 11S (7S/11S) is lower than a naturally occurring ratio. In some cases, the non-milk particle is inside the micellar core. In some cases, the non-milk particle is attached to the exterior layer. It is contemplated that glycelles can vary in size and in ratios of different molecules that comprise the glycelles. In some cases, a glycelle comprises more than 1000 α_{S1}-casein molecules, more than 1000 α_{S2}-casein molecules, more than 1000 β-casein molecules, more than 1000 κ-casein molecules, more than 1000 β-conglycinin molecules, or more than 1000 glycinin molecules.

In an ideal embodiment, a glycelle comprises soy proteins. In some cases, the soy proteins are lectins, enzymes, proteases, or protease inhibitors. In some cases, the soy proteins comprise specific isoflavone-conjugated proteins, leveraging the health benefits of isoflavones. In some cases, the soy proteins comprise lunasin. In some cases, the soy proteins are hydrolyzed. In some cases, the soy proteins are fermented. In some cases, the soy proteins are specially treated or processed proteins, such as those that have undergone heat treatment, enzymatic treatment, or high-pressure processing to modify their functional properties. In some cases, the soy proteins comprise β-conglycinin In some cases, a glycelle comprises a combination of soy proteins.

In some embodiments, a glycelle comprises non-milk particles incorporated within the interior of the glycelle structure, forming a core-shell structure where the casein forms the shell and the non-milk particles form the core.

In some embodiments, a glycelle comprises non-milk particles attached directly to the κ-casein layer on the exterior of the glycelle structure, forming a bimodal protein distribution with non-milk particles dispersed on the surface of the glycelle.

In some embodiments, non-milk particles are distributed throughout the glycelle structure, embedded within the casein matrix and contributing to the overall structure of the glycelle.

In some embodiments, non-milk particles are affixed to the κ-casein ring of the glycelle. In some cases, non-milk particles are integrated into the glycelle structure. In some cases, additional non-milk particles are located at the interface between the casein proteins and the serum phase of the milk, enhancing the stability of the glycelle in the liquid. In some cases, non-milk particles are arranged in a multi-layered configuration, with alternating layers of casein and non-milk particles within the micelle, improving its structural integrity and protein density. In some cases, non-milk particles are interspersed among the casein proteins, providing a homogeneous distribution of both types of proteins within the glycelle structure.

The unique glycelle structures can be used to create dairy products with enhanced properties, for example, cheese, yogurt and fermented dairy products, milk beverages, ice cream, infant formula, dietary supplements, sports nutrition products, and nutraceuticals, among other things. These hybrid protein structures exhibit improved functionality such as better emulsifying, gelling, or foaming properties, opening up new avenues in food processing and formulation.

In some instances, the glycelle offers a balanced nutritional profile, integrating the high-quality protein content and comprehensive essential amino acid spectrum of dairy proteins with beneficial phytochemicals like isoflavones from soy proteins. The nutritional properties of the glycelle are examined using a range of methods. Proximate analysis assesses basic nutritional content such as moisture, which is in some cases at least 3-4%, in others at least 4-5%, and in some cases at least 5-6%. The total protein content, indicative of the high protein content of both casein and soy, is in some cases at least 25-27%, in others at least 27-29%, in still others at least 29-31%, and in some cases at least 31-35%. Total fat content, typically determined around 1-3% using Soxhlet extraction, is in some cases at least 1-2%, and in others at least 2-3%. Carbohydrate content, often determined by difference or through specific enzymatic and chromatographic methods, varies widely, with some cases showing at least 2-4%, others at least 4-6%, still others at least 6-8%, and some at least 8-10%. Fiber content, typically low, is in some cases at least 0-1%, and in others at least 1-2%. Ash or mineral content, typically around 2-4%, is in some cases at least 2-3%, and in others at least 3-4%. Protein, vitamin and mineral contents, amino acid content, bioactive compound content, and allergen content are all determined and analyzed using suitable methods.

In some cases, the glycelle exhibits reduced allergenicity as compared with a casein micelle. In some cases, the non-milk particles such as soy proteins in the glycelle mask the epitopes on casein proteins that are responsible for triggering allergic reactions. Conversely, in some cases, the casein proteins could similarly obscure allergenic epitopes present on the non-milk particles. In some cases, the rate and extent of protein digestion is different for the glycelle compared to a pure casein micelle. This has implications for the feeling of satiety and the release of amino acids into the bloodstream. In some cases, the glycelles exhibit reduced ELISA (Enzyme-Linked Immunosorbent Assay) values for certain casein dairy allergens as compared to a pure casein micelle. In some cases, the glycelles exhibit a reduction of allergenicity level for α_{S1}-casein, α_{S2}-casein, β-casein, or κ-casein of at least 2 ppm, at least 4 ppm, at least 8 ppm, at least 16 ppm, or at least 32 ppm as compared to a pure casein micelle. In some cases, the glycelles exhibit higher allergenicity levels for α_{S1}-casein, α_{S2}-casein, casein, or κ-casein as compared to pure casein micelles.

The functional properties of the glycelle differ from a casein micelle found in bovine milk. In some cases, the glycelle differs with respect to solubility, emulsification capability, foaming and whipping characteristics, gelling and thickening properties, water and fat binding capacities, heat stability, viscosity, texture and mouthfeel, ability to form and stabilize dispersions, adherence and cohesiveness, susceptibility to enzymatic breakdown, impact on flavor release, and potential for modulating allergenicity.

In some cases, the glycelles display an enhanced pH stability compared to casein micelles found in bovine milk, remaining stable across a wider pH range. In some cases, the glycelles have a narrower pH range at which they are stable as compared to casein micelles found in bovine milk. In some cases, the temperature at which the glycelles remain stable, before they start to aggregate or denature, is higher or lower as compared to casein micelles found in bovine milk. In some cases, the glycelle has a higher or lower zeta potential as compared to casein micelles found in bovine milk. In some cases, glycelles have a higher or lower polydispersity index (PDI) as compared to casein micelles found in bovine milk. In some cases, glycelles have a higher or lower sedimentation rate as compared to casein micelles found in bovine milk.

The stability of the glycelles can be different from casein micelles found in bovine milk in different conditions (e.g., temperature, pH). For instance, glycelles can be more resistant to coagulation under acidic conditions than casein micelles found in bovine milk, for example, in making dairy beverages.

### Alternative Embodiments of Glycelles

### Encapsulating Drugs or Other Bioactive Agents

In some embodiments of the present invention, glycelles can be utilized as a versatile platform for the encapsulation of drugs and other bioactive agents. The encapsulation of these substances within casein micelles offers several potential advantages:

Improved Stability: Many drugs and bioactive agents are sensitive to environmental factors such as light, oxygen, or pH. Encapsulation within the glycelle structure may offer protection against such external factors, thereby enhancing the stability and shelf-life of the encapsulated substance.

Controlled Release: The unique structure of glycelles can provide a controlled release mechanism. As the glycelle structure interacts with physiological conditions, the encapsulated drug or agent can be released in a sustained manner, ensuring prolonged therapeutic effects and reducing the need for frequent dosing.

Enhanced Bioavailability: Some drugs and bioactive agents may face challenges in absorption when administered orally due to their poor solubility or permeability. Encapsulation within glycelles can enhance their solubility and potentially improve their absorption profile, leading to increased bioavailability.

Targeted Delivery: By modifying the surface properties of glycelles or by adding targeting ligands, it may be possible to direct the glycelles to specific cells or tissues, thereby achieving targeted drug delivery.

Versatility: The glycelle platform is compatible with a wide range of drugs and bioactive agents, ranging from small molecule drugs to larger biologics such as proteins or nucleic acids. This versatility allows for a broad spectrum of therapeutic applications.

To encapsulate drugs or bioactive agents within glycelles, one can follow a procedure similar to that described for non-milk particles such as soy proteins, with modifications tailored to the specific properties of the drug or agent in question. For instance, the pH, ionic strength, or temperature conditions might be adjusted to optimize the encapsulation efficiency and stability of the specific drug or agent.

Potential applications of drug-loaded glycelles include, but are not limited to, oral drug delivery systems, injectable drug formulations, or topical applications for conditions such as skin disorders or wounds.

### Alternative Embodiments of Glycelles Encapsulating

### Enzymes, Collagen, Gelatin, Albumin, Hemoglobin, or Mycoprotein

In some embodiments of the present invention, glycelles are used to encapsulate various enzymes. Enzymes, as biocatalysts, play crucial roles in numerous biochemical processes, and their encapsulation within glycelles can offer several advantages, such as stability enhancement, controlled release, protection from proteolysis, and targeted delivery. In some embodiments, digestive enzymes, such as amylase, lipase, protease, or lactase are encapsulated. While soy proteins, such as soy protein isolates, can be included, they are not mandatory and can be optional. In some embodiments, therapeutic enzymes are encapsulated, such as superoxide dismutase, L-asparaginase, or urokinase. In some embodiments, industrial enzymes are encapsulated, such as cellulase, xylanase, or pectinase. In some embodiments, food-processing enzymes are encapsulated, such as rennet, bromelain, or invertase. In some embodiments, research and biotechnological enzymes are encapsulated, such as Taq polymerase, restriction endonucleases, or alkaline phosphatases.

In some embodiments of the present invention, glycelles are used to encapsulate collagen. Collagen, as the main structural protein in the extracellular matrix in various connective tissues, plays vital roles in maintaining the structural integrity of skin, tendons, ligaments, and bones. While soy proteins, such as soy protein isolates, can be included, they are not mandatory and can be optional. Its encapsulation within glycelles can offer several advantages, such as stability enhancement, controlled release, protection from proteolysis, and enhanced bioavailability. In some embodiments, marine-derived collagen is encapsulated. In some embodiments, bovine-derived collagen is encapsulated. In some embodiments, porcine-derived collagen is encapsulated. In some embodiments, avian-derived collagen is encapsulated. In some embodiments, recombinant collagen is encapsulated, produced using yeast, bacteria, or plant cells that have been genetically modified to produce collagen, ensuring a consistent and animal-free source. In some embodiments, specific types of collagen are encapsulated, such as type I collagen, type II collagen, type III collagen, type IV collagen, or type V collagen.

In some embodiments of the present invention, glycelles are used to encapsulate various types of gelatin. While soy proteins, such as soy protein isolates, can be included, they are not mandatory and can be optional. Gelatin, derived from the partial hydrolysis of collagen, is a mixture of peptides and proteins and is widely used in the food, pharmaceutical, cosmetic, and photographic industries. Its encapsulation within glycelles can offer several advantages, such as stability enhancement, controlled release, protection from adverse conditions, and enhanced functionality. The biofunctional properties of gelatin, such as its ability to promote skin health or joint health, could be enhanced when encapsulated, due to improved delivery and absorption. In some embodiments, glycelles are used to encapsulate porcine-derived gelatin. In some embodiments, glycelles are used to encapsulate bovine-derived gelatin. In some embodiments, glycelles are used to encapsulate fish-derived gelatin. In some embodiments, glycelles are used to encapsulate cold-water fish-derived gelatin. In some embodiments, glycelles are used to encapsulate jellyfish-derived gelatin. In some embodiments, glycelles are used to encapsulate high bloom gelatin. In some embodiments, glycelles are used to encapsulate medium bloom gelatin. In some embodiments, glycelles are used to encapsulate low bloom gelatin. In some embodiments, glycelles are used to encapsulate hydrolyzed gelatin or collagen peptides.

In embodiments of the present invention, glycelles are used to encapsulate various types of albumin. While soy proteins, such as soy protein isolates, can be included, they are not mandatory and can be optional. Albumin, a globular protein, plays a vital role in maintaining the osmotic pressure of blood and is commonly found in blood plasma, egg whites, and various plant tissues. In some embodiments, glycelles are used to encapsulate human serum albumin (HSA), which is the most abundant protein in human plasma and has applications in drug delivery and therapeutics. In some embodiments, glycelles are used to encapsulate bovine serum albumin (BSA), which is commonly used in laboratory research and various biotechnological applications. In some embodiments, glycelles are used to encapsulate rat serum albumin (RSA), which is often used in specific research contexts. In some embodiments, glycelles are used to encapsulate ovalbumin, which is the primary protein found in egg whites and is used in food and pharmaceutical formulations. In some embodiments, glycelles are used to encapsulate ricin communis albumin, derived from the castor bean plant. In some embodiments, glycelles are used to encapsulate watermelon seed albumin, which is an emerging source of plant-based albumin with potential food and therapeutic applications. In some embodiments, glycelles are used to encapsulate osmotin, a plant-derived albumin from tobacco that has been researched for its potential therapeutic properties. In some embodiments, glycelles are used to encapsulate pea albumins, which are derived from pea seeds and are gaining attention in plant-based food formulations.

In some embodiments of the present invention, glycelles are used to encapsulate various types of hemoglobin. While soy proteins, such as soy protein isolates, can be included, they are not mandatory and can be optional. Hemoglobin is an iron-containing protein found in the red blood cells of many organisms and is responsible for oxygen transport from the lungs to the rest of the body. In some embodiments, glycelles are used to encapsulate human hemoglobin (HbA), fetal hemoglobin (HbF), or myoglobin. In some embodiments, glycelles are used to encapsulate hemoglobin from other mammalian species, such as bovine or porcine hemoglobin. In some embodiments, glycelles are used to encapsulate avian hemoglobins derived from bird species, which have different oxygen affinities and structural properties. In some embodiments, glycelles are used to encapsulate fish hemoglobins, which can vary widely in their structure and function based on the species and their specific environments. In some embodiments, glycelles are used to encapsulate recombinant or genetically modified hemoglobins, which are produced using biotechnological techniques to have specific properties or functionalities. In some embodiments, glycelles are used to encapsulate hemoglobin variants, such as HbS in sickle cell anemia or HbC, which have distinct structural and functional properties.

In some embodiments of the present invention, glycelles are used to encapsulate various types of mycoprotein. While soy proteins, such as soy protein isolates, can be included, they are not mandatory and can be optional. In some embodiments, glycelles are used to encapsulate whole mycoprotein, which includes the entire fungal biomass with its natural nutrient composition. In some embodiments, glycelles are used to encapsulate hydrolyzed mycoprotein, where the protein component has been broken down into simpler peptides for easier digestion or specific functional properties. In some embodiments, glycelles are used to encapsulate mycoprotein isolates, which are specific fractions derived from the whole mycoprotein, focusing on particular nutrients like proteins or fibers. In some embodiments, glycelles are used to encapsulate fortified mycoprotein, where additional nutrients, vitamins, or minerals have been added to the mycoprotein to enhance its nutritional profile. In some embodiments, glycelles are used to encapsulate mycoprotein blends, where mycoprotein is combined with other plant-based proteins or ingredients to create a specific taste or nutrient profile. In some embodiments, glycelles are used to encapsulate flavored or seasoned mycoprotein, where specific flavors or seasonings have been added to the mycoprotein to cater to different culinary preferences.

### Alternative Embodiments of Glycelles Encapsulating

### Alternative Plant Proteins, Antibodies, or Zeins

In some embodiments of the present invention, glycelles are used to encapsulate alternative plant proteins to soy proteins. While soy proteins, such as soy protein isolates, can be included, they are not mandatory and can be optional. In some embodiments, glycelles are used to encapsulate pea protein, rice protein, hemp protein, algae protein, potato protein, soy protein isolates, mung bean protein, chia protein, flaxseed protein, pumpkin seed protein, sunflower seed protein, quinoa protein, amaranth protein, buckwheat protein, lentil protein, chickpea protein, faba bean protein, lupin protein, canola protein, oat protein, teff protein, millet protein, corn protein, barley protein, wheat gluten, watermelon seed protein, sesame seed protein, macadamia nut protein, walnut protein, almond protein, pistachio protein, cashew protein, brazil nut protein, hazelnut protein, pine nut protein, coconut protein, sorghum protein, fonio protein, black bean protein, navy bean protein, kidney bean protein, garbanzo bean protein, adzuki bean protein, black-eyed pea protein, pigeon pea protein, yam protein, taro protein, chestnut protein, tigernut protein, lotus seed protein, moringa leaf protein, artichoke protein, broccoli protein, spinach protein, mustard seed protein, rapeseed protein, cacao protein, coffee bean protein, green pea protein, jackfruit seed protein or some combination. In an ideal embodiment, the plant protein is a non-bioactive compound.

In some embodiments of the present invention, glycelles are used to encapsulate antibodies. While soy proteins, such as soy protein isolates, can be included, they are not mandatory and can be optional. In some embodiments, glycelles are used to encapsulate monoclonal antibodies (mAbs) such as Rituximab, Adalimumab, or Trastuzumab. In some embodiments, glycelles are used to encapsulate polyclonal antibodies. In some embodiments, glycelles are used to encapsulate bispecific antibodies, engineered to recognize two different epitopes, potentially on two different antigens. In some embodiments, glycelles are used to encapsulate antibody-drug conjugates (ADCs). In some embodiments, glycelles are used to encapsulate nanobodies or single-domain antibodies. In some embodiments, glycelles are used to encapsulate antibody fragments, such as Fab, F(ab′)2, or scFv. In some embodiments, glycelles are used to encapsulate neutralizing antibodies.

In some embodiments of the present invention, glycelles are used to encapsulate zeins, i.e., one of the group of prolamin proteins derived from maize (corn) endosperm. While soy proteins, such as soy protein isolates, can be included, they are not mandatory and can be optional. In some embodiments glycelles are used to encapsulate α-zeins, β-zeins, γ-zeins, δ-zeins, or some combination. In some embodiments modified zeins are used, which have been chemically or enzymatically modified to alter their properties, such as improving their solubility or binding capacity. In some embodiments, glycelles are used to encapsulate zein hydrolysates.

Certain aspects of the disclosure have other steps or elements in addition to or in place of those mentioned above. The steps or elements will become apparent to those skilled in the art from a reading of the following detailed description when taken with reference to the accompanying drawings.

While some embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

The following embodiments are described in sufficient detail to enable those skilled in the art to make and use the invention. It is to be understood that other embodiments would be evident based on the present disclosure, and that system, process, or mechanical changes can be made without departing from the scope of an embodiment of the present disclosure.

In the following description, numerous specific details are given to provide a thorough understanding of the invention. However, it will be apparent that the invention can be practiced without these specific details. In order to avoid obscuring an embodiment of the present disclosure, some well-known techniques, system configurations, and process steps are not disclosed in detail. Throughout this disclosure, various publications, patents and published patent specifications are referenced by an identifying citation. The disclosures of these publications, patents and published patent specifications are hereby incorporated by reference into the present disclosure.

### Glycelle-Derived Cheese

In some embodiments, the texture and consistency, or both, of glycelle-derived cheese differ from casein-micelle-derived cheese. In certain embodiments, glycelle-derived cheese has a Texture Profile Analysis (TPA) firmness that is higher compared to casein-micelle-derived cheese by at least a 0.5 to 1%, at least 1 to 3%, at least 3 to 5%, at least 5 to 10%, or at least 10 to 15%. Similarly, in other embodiments, glycelle-derived cheese exhibits a TPA springiness (elasticity) that surpasses casein-micelle-derived cheese by at least a 0.5 to 1%, at least 1 to 3%, at least 3 to 5%, at least 5 to 10%, or at least 10 to 15%. Additionally, in some embodiments, the graininess of the glycelle-derived cheese differs from casein-micelle-derived cheese by increments ranging from 0.2 to 0.5%, 0.5 to 2%, 2 to 4%, 4 to 8%, or 8 to 12%. Furthermore, in specific embodiments, the moisture content in glycelle-derived cheese is higher or lower than casein-micelle-derived cheese by a range of 0.2 to 0.5%, 0.5 to 2%, 2 to 4%, 4 to 8%, or 8 to 12%. In some embodiments, the cohesiveness of glycelle-derived cheese varies from casein-micelle-derived cheese by increments of 0.1 to 0.5%, 0.5 to 2%, 2 to 5%, 5 to 8%, or 8 to 11%. In other instances, the chewiness of glycelle-derived cheese is distinct from casein-micelle-derived cheese, with differences spanning 0.3 to 0.7%, 0.7 to 2.5%, 2.5 to 5%, 5 to 9%, or 9 to 14%. Additionally, in certain scenarios, the resilience of the glycelle-derived cheese diverges from that of casein-micelle-derived cheese by at least a 0.2 to 0.6%, 0.6 to 2.2%, 2.2 to 4.5%, 4.5 to 7.5%, or 7.5 to 10.5%. Finally, in some embodiments, the adhesiveness of glycelle-derived cheese contrasts with casein-micelle-derived cheese by margins of 0.15 to 0.5%, 0.5 to 1.5%, 1.5 to 3.5%, 3.5 to 6%, or 6 to 9%.

It is known in the art that casein-micelle-derived cheese comes with a range of values with respect to firmness, elasticity, graininess, moisture content, cohesiveness, chewiness, resilience, and adhesiveness. In some embodiments, the central tendency or mean of the texture and consistency TPA values for firmness, elasticity, graininess, moisture content, cohesiveness, chewiness, resilience, adhesiveness, or some combination, of glycelle-derived cheese are shifted by at least a range of 0.2 to 0.5%, 0.5 to 2%, 2 to 4%, 4 to 7%, or 7 to 10% when compared to casein-micelle-derived cheese. In some embodiments, the variance or spread of TPA values for firmness, elasticity, graininess, moisture content, cohesiveness, chewiness, resilience, adhesiveness, or some combination, in glycelle-derived cheese differs by at least 0.1 to 0.4%, 0.4 to 1.5%, 1.5 to 3%, 3 to 5.5%, or 5.5 to 8% from casein-micelle-derived cheese. In some embodiments, the skewness or asymmetry in the distribution of values for firmness, elasticity, graininess, moisture content, cohesiveness, chewiness, resilience, adhesiveness, or some combination, of glycelle-derived cheese may be altered by a range of 0.05 to 0.2%, 0.2 to 0.7%, 0.7 to 1.5%, 1.5 to 2.5%, or 2.5 to 3.5% in comparison to casein-micelle-derived cheese. In some embodiments, the kurtosis, or “tailedness” of the distribution of TPA values for glycelle-derived cheese, with respect to firmness, elasticity, graininess, moisture content, cohesiveness, chewiness, resilience, adhesiveness, or some combination, varies by increments of at least 0.1 to 0.3%, 0.3 to 1%, 1 to 2%, 2 to 3.5%, or 3.5 to 5% as against casein-micelle-derived cheese. In some embodiments, the outlier presence, in the distribution of TPA values for firmness, elasticity, graininess, moisture content, cohesiveness, chewiness, resilience, adhesiveness, or some combination, for glycelle-derived cheese, is increased or decreased by a span of 0.05 to 0.15%, 0.15 to 0.5%, 0.5 to 1%, 1 to 1.8%, or 1.8 to 2.7% as compared to casein-micelle-derived cheese.

In some embodiments, the color of glycelle-derived cheese differs from that of casein-micelle-derived cheese. In certain embodiments, the lightness (L*) of glycelle-derived cheese, as measured using the CIELAB color system, is shifted by at least a 0.5 to 1%, at least 1 to 3%, at least 3 to 5%, at least 5 to 10%, or at least 10 to 15% compared to casein-micelle-derived cheese. Similarly, in other embodiments, the a* value (red-green axis) for glycelle-derived cheese surpasses that of casein-micelle-derived cheese by a range of 0.2 to 0.5%, 0.5 to 2%, 2 to 4%, 4 to 8%, or 8 to 12%. Furthermore, in specific embodiments, the b* value (yellow-blue axis) of glycelle-derived cheese contrasts with casein-micelle-derived cheese by margins of 0.1 to 0.5%, 0.5 to 2%, 2 to 5%, 5 to 8%, or 8 to 11%.

It is known in the art that casein-micelle-derived cheese exhibits a range of values with respect to color, specifically in the CIELAB color space parameters L*, a*, and b*. In some embodiments, the central tendency or mean of the color values L*, a*, and b* for glycelle-derived cheese is shifted by at least a range of 0.2 to 0.5%, 0.5 to 2%, 2 to 4%, 4 to 7%, or 7 to 10% when compared to casein-micelle-derived cheese. In some embodiments, the variance or spread of color values L*, a*, and b* in glycelle-derived cheese differs by at least 0.1 to 0.4%, 0.4 to 1.5%, 1.5 to 3%, 3 to 5.5%, or 5.5 to 8% from casein-micelle-derived cheese. In certain scenarios, the skewness or asymmetry in the distribution of color values L*, a*, and b* for glycelle-derived cheese may be altered by a range of 0.05 to 0.2%, 0.2 to 0.7%, 0.7 to 1.5%, 1.5 to 2.5%, or 2.5 to 3.5% in comparison to casein-micelle-derived cheese. In some embodiments, the kurtosis, or “tailedness” of the distribution of color values for glycelle-derived cheese, in terms of L*, a*, and b*, varies by increments of at least 0.1 to 0.3%, 0.3 to 1%, 1 to 2%, 2 to 3.5%, or 3.5 to 5% compared to casein-micelle-derived cheese. In certain instances, the outlier presence in the distribution of color values L*, a*, and b* for glycelle-derived cheese is increased or decreased by a span of 0.05 to 0.15%, 0.15 to 0.5%, 0.5 to 1%, 1 to 1.8%, or 1.8 to 2.7% in relation to casein-micelle-derived cheese.

In some embodiments, the melting properties of glycelle-derived cheese is different than casein-micelle-derived cheese. In some embodiments, glycelle-derived cheese offers different meltability, flow, browning, or some combination, as compared to casein-micelle-derived cheese.

In some embodiments, the melting properties of glycelle-derived cheese differ from those of casein-micelle-derived cheese. In certain embodiments, glycelle-derived cheese demonstrates a meltability, as assessed by the Schreiber Test, that is higher compared to casein-micelle-derived cheese by at least a 0.5 to 1 mm, at least 1 to 3 mm, at least 3 to 5 mm, at least 5 to 10 mm, or at least 10 to 15 mm. Furthermore, in specific embodiments, the flowability of the melted glycelle-derived cheese varies from casein-micelle-derived cheese by increments ranging from at least 0.2 to 0.5 mm, at least 0.5 to 2 mm, at least 2 to 4 mm, at least 4 to 8 mm, or at least 8 to 12 mm. Additionally, in select scenarios, the stretchability of the melted glycelle-derived cheese contrasts with that of casein-micelle-derived cheese by margins of at least 0.1 to 0.5 mm, 0.5 to 2 mm, 2 to 5 mm, 5 to 8 mm, or 8 to 11 mm.

It is known in the art that casein-micelle-derived cheese has a range of meltability values as determined by the Schreiber Test. In some embodiments, the central tendency or mean of the meltability values for glycelle-derived cheese are shifted by at least a range of 0.2 to 0.5 mm, 0.5 to 2 mm, 2 to 4 mm, 4 to 7 mm, or 7 to 10 mm when compared to casein-micelle-derived cheese. In some embodiments, the variance or spread of meltability values for glycelle-derived cheese differs by at least 0.1 to 0.4 mm, 0.4 to 1.5 mm, 1.5 to 3 mm, 3 to 5.5 mm, or 5.5 to 8 mm from casein-micelle-derived cheese. In certain instances, the skewness or asymmetry in the distribution of meltability values for glycelle-derived cheese may be altered by a range of 0.05 to 0.2 mm, 0.2 to 0.7 mm, 0.7 to 1.5 mm, 1.5 to 2.5 mm, or 2.5 to 3.5 mm in comparison to casein-micelle-derived cheese. In some embodiments, the kurtosis, or “tailedness” of the distribution of meltability values for glycelle-derived cheese varies by increments of at least 0.1 to 0.3 mm, 0.3 to 1 mm, 1 to 2 mm, 2 to 3.5 mm, or 3.5 to 5 mm compared to casein-micelle-derived cheese. Lastly, in some embodiments, the outlier presence in the distribution of meltability values for glycelle-derived cheese is increased or decreased by a span of 0.05 to 0.15 mm, 0.15 to 0.5 mm, 0.5 to 1 mm, 1 to 1.8 mm, or 1.8 to 2.7 mm as compared to casein-micelle-derived cheese.

In some embodiments, the nutritional profile of glycelle-derived cheese is different than casein-micelle-derived cheese. In some embodiments, glycelle-derived cheese offers different protein content, fat levels, carbohydrate content, sugar content, vitamin and mineral content, probiotic content, or some combination, as compared to casein-micelle-derived cheese.

In some embodiments, the flavor, aroma, or both of glycelle-derived cheese is different than cheese derived from traditional casein micelles. In some embodiments, new flavors are introduced, the natural flavor of cheese is enhanced or reduced, the affected aftertaste is impacted, the aroma is altered, or some combination.

In some embodiments, the shelf life and stability of glycelle-derived cheese is different than casein-micelle-derived cheese. In some embodiments, glycelle-derived cheese offers different shelf-life duration, either longer or shorter, mold growth, either inhibited or accelerated, or some combination, as compared to casein-micelle-derived cheese. In some embodiments, glycelle-derived cheese offers different oil separation when heated as compared to casein-micelle-derived cheese.

In some embodiments, the digestibility of glycelle-derived cheese is different than casein-micelle-derived cheese. In some embodiments, glycelle-derived cheese offers different shelf-life duration, either longer or shorter, mold growth, either inhibited or accelerated, or some combination, as compared to casein-micelle-derived cheese. In some embodiments, glycelle-derived cheese offers different oil separation when heated as compared to casein-micelle-derived cheese.

In some embodiments, the ripening and aging of glycelle-derived cheese is different than casein-micelle-derived cheese. In some embodiments, glycelle-derived cheese offers accelerated or decelerated ripening as compared to casein-micelle-derived cheese. In some embodiments, glycelle-derived cheese affects the flavor, texture, aroma, or some combination during aging, as compared to casein-micelle-derived cheese.

In some embodiments, the microbial content of glycelle-derived cheese is different than casein-micelle-derived cheese. In some embodiments, glycelle-derived cheese offers altered types, quantities, or both of bacteria present. In some embodiments, glycelle derived cheese influences the growth of beneficial microbes during cheese fermentation as compared to casein-micelle-derived cheese.

In some embodiments, the number, size, or both of holes or air pockets in glycelle-derived cheese is different than casein-micelle-derived cheese. In some embodiments, glycelle-derived cheese offers altered ability to slice, grate, or crumble, as compared to casein-micelle-derived cheese.

### Glycelle-Derived Milk

In some embodiments, the composition and properties, or both, of glycelle-derived milk differ from casein-micelle-derived milk. In certain embodiments, glycelle-derived milk has a fat content that is higher compared to casein-micelle-derived milk by at least a 0.5 to 1%, at least 1 to 3%, at least 3 to 5%, at least 5 to 10%, or at least 10 to 15%. Similarly, in other embodiments, the protein content in glycelle-derived milk surpasses that of casein-micelle-derived milk by at least a 0.5 to 1%, at least 1 to 3%, at least 3 to 5%, at least 5 to 10%, or at least 10 to 15%. Additionally, in some embodiments, the lactose content of the glycelle-derived milk differs from casein-micelle-derived milk by increments ranging from 0.2 to 0.5%, 0.5 to 2%, 2 to 4%, 4 to 8%, or 8 to 12%. Furthermore, in specific embodiments, the mineral content in glycelle-derived milk is higher or lower than casein-micelle-derived milk by a range of 0.2 to 0.5%, 0.5 to 2%, 2 to 4%, 4 to 8%, or 8 to 12%.

It is known in the art that casein-micelle-derived milk comes with a range of values with respect to fat, protein, lactose, and mineral content. [cite] In some embodiments, the central tendency or mean of the composition values for fat, protein, lactose, and mineral content, or some combination, of glycelle-derived milk are shifted by at least a range of 0.2 to 0.5%, 0.5 to 2%, 2 to 4%, 4 to 7%, or 7 to 10% when compared to casein-micelle-derived milk. In some embodiments, the variance or spread of composition values for fat, protein, lactose, and minerals, or some combination, in glycelle-derived milk differs by at least 0.1 to 0.4%, 0.4 to 1.5%, 1.5 to 3%, 3 to 5.5%, or 5.5 to 8% from casein-micelle-derived milk.

In some embodiments, the color of glycelle-derived milk differs from that of casein-micelle-derived milk. In certain embodiments, the lightness (L*) of glycelle-derived milk, as measured using the CIELAB color system, is shifted by at least a 0.5 to 1%, at least 1 to 3%, at least 3 to 5%, at least 5 to 10%, or at least 10 to 15% compared to casein-micelle-derived milk. Similarly, in other embodiments, the a* value (red-green axis) and the b* value (yellow-blue axis) for glycelle-derived milk differ from those of casein-micelle-derived milk by specified margins.

In some embodiments, the shelf life and stability of glycelle-derived milk differ from casein-micelle-derived milk. Glycelle-derived milk may offer different shelf-life duration, either longer or shorter, or microbial growth patterns, either inhibited or accelerated, as compared to casein-micelle-derived milk.

In some embodiments, the microbial content of glycelle-derived milk is different than casein-micelle-derived milk. Glycelle-derived milk might have altered types, quantities, or both of bacteria present. In certain scenarios, glycelle-derived milk may influence the growth of beneficial microbes during storage as compared to casein-micelle-derived milk.

In some embodiments, the sensory properties, such as flavor and aroma, of glycelle-derived milk are different than those of casein-micelle-derived milk. These differences might include alterations in taste, smell, or overall mouthfeel.

### Compositions with Unnatural Soy Ratios

In some aspects, the current disclosure provides a composition, comprising casein

micelles; and a soy ingredient comprising at least one of 7S (e.g., β-conglycinin) or 11S (e.g., glycinin). In some cases, the composition is milk, cheese, or a curd. In some cases, the soy ingredient comprises only one of 7S (e.g., β-conglycinin) or 11S (e.g., glycinin), but not both. In some cases, the soy ingredient comprises both 7S (e.g., β-conglycinin) and 11S (e.g., glycinin), and the weight or molar ratio of 7S/11S is lower than a naturally occurring ratio. In some instances, a decreased ratio of 7S/11S is achieved by decreasing the amount of 7S (e.g., β-conglycinin) in the soy ingredient, for example, by using RNAi or CRISPR-Cas9 to knock out or knock down the gene expression of a plant protein, in this instance, 7S (e.g., β-conglycinin). In some instances, a decreased weight ratio of 7S/11S is achieved by increasing the amount of 11 S (e.g., glycinin) in the soy ingredient, for example, by overexpressing a 11S protein (e.g., glycinin)

In some cases, the soy ingredient comprises both 7S (e.g., β-conglycinin) and 11S (e.g., glycinin), and the weight ratio of 11S/7S is lower than a naturally occurring ratio. In some instances, a decreased ratio of 11S/7S is achieved by decreasing the amount of 11S (e.g., glycinin) in the soy ingredient, for example, by using RNAi or CRISPR-Cas9 to knock out or knock down the gene expression of a plant protein, in this instance, 11S (e.g., glycinin). In some instances, a decreased weight ratio of 11S/7S is achieved by increasing the amount of 7S (e.g., β-conglycinin) in the soy ingredient, for example, by overexpressing a 7S protein.

In some instances, at least one of the soy ingredients is recombinant or genetically modified. In some cases, 7S (e.g., β-conglycinin) is recombinant or genetically modified. In some cases, 11S (e.g., glycinin) is recombinant or genetically modified. In some instances, at least one of the casein ingredients is recombinant or genetically modified. In some instances, the glycelle comprises recombinant casein that has not undergone prior micellar assembly.

In some cases, the naturally occurring weight ratio of 7S/11S is between 0.5 and 1.3. In some cases, the naturally occurring weight ratio of 7S/11S is 0.5. In some cases, the naturally occurring weight ratio of 7S/11S is 0.6. In some cases, the naturally occurring weight ratio of 7S/11S is 0.7. In some cases, the naturally occurring weight ratio of 7S/11S is 0.8. In some cases, the naturally occurring weight ratio of 7S/11S is 0.75. In some cases, the naturally occurring weight ratio of 7S/11S is 0.9. In some cases, the naturally occurring weight ratio of 7S/11S is 1. In some cases, the naturally occurring weight ratio of 7S/11S is 1.1. In some cases, the naturally occurring weight ratio of 7S/11S is 1.2. In some cases, the naturally occurring weight ratio of 7S/11S is 1.3.

In some cases, the weight ratio of 7S/11S is lower than 0.5. In some cases, the weight ratio of 7S/11S is lower than 0.45. In some cases, the weight ratio of 7S/11S is lower than 0.4. In some cases, the weight ratio of 7S/11S is lower than 0.35. In some cases, the weight ratio of 7S/11S is lower than 0.3. In some cases, the weight ratio of 7S/11S is lower than 0.25. In some cases, the weight ratio of 7S/11S is lower than 0.2. In some cases, the weight ratio of 7S/11S is lower than 0.15. In some cases, the weight ratio of 7S/11S is lower than 0.1. In some cases, the weight ratio of 7S/11S is lower than 0.05. In some cases, the weight ratio of 7S/11S is lower than 0.01. In some cases, the weight ratio of 7S/11S is lower than 0.001. In some cases, the weight ratio of 7S/11S is lower than 0.0001. In some cases, the weight ratio of 7S/11S is lower than 0.00001. In some cases, the weight ratio of 7S/11S is lower than 0.000001. In some cases, the weight ratio of 7S/11S is lower than 0.0000001. In some cases, the weight ratio of 7S/11S is 0 or close to 0, wherein the soy ingredient comprises a trace amount of 7S (e.g., β-conglycinin), or does not comprise a detectable amount of 7S (e.g., β-conglycinin).

Some aspects of the current disclosure provide compositions comprising 7S or 11S. In some cases, the weight ratio of 11S/7S is lower than 0.77. In some cases, the weight ratio of 11S/7S is lower than 0.7. In some cases, the weight ratio of 11S/7S is lower than 0.6. In some cases, the weight ratio of 11S/7S is lower than 0.5. In some cases, the weight ratio of 11S/7S is lower than 0.45. In some cases, the weight ratio of 11S/7S is lower than 0.4. In some cases, the weight ratio of 11S/7S is lower than 0.35. In some cases, the weight ratio of 11S/7S is lower than 0.3. In some cases, the weight ratio of 11S/7S is lower than 0.25. In some cases, the weight ratio of 11S/7S is lower than 0.2. In some cases, the weight ratio of 11S/7S is lower than 0.15. In some cases, the weight ratio of 11S/7S is lower than 0.1. In some cases, the weight ratio of 11S/7S is lower than 0.05. In some cases, the weight ratio of 11S/7S is lower than 0.01. In some cases, the weight ratio of 11S/7S is lower than 0.001. In some cases, the weight ratio of 11S/7S is lower than 0.0001. In some cases, the weight ratio of 11S/7S is lower than 0.00001. In some cases, the weight ratio of 11S/7S is lower than 0.000001. In some cases, the weight ratio of 11S/7S is lower than 0.0000001. In some cases, the weight ratio of 11S/7S is close to 0, wherein the soy ingredient comprises only trace amount of 11S (e.g., glycinin), or does not comprise a detectable amount of 11S (e.g., glycinin).

Some aspects of the current disclosure provide compositions comprising casein micelles; and a soy ingredient comprising at least one of 7S or 11S, wherein the weight or molar ratio of the 7S and the 11S (7S/11S) is higher than a naturally occurring ratio. In some cases, the naturally occurring weight ratio of the 7S and the 11S (7S/11S) is between 0.5-1.3. In some cases, the ratio of the 7S and the 11S (7S/11S) in the composition is higher than 1.3. In some cases, the ratio of the 7S and the 11S (7S/11S) is higher than 2. In some cases, the ratio of the 7S and the 11S (7S/11S) is higher than 5. In some cases, the ratio of the 7S and the 11S (7S/11S) is higher than 10. In some cases, the ratio of the 7S and the 11S (7S/11S) is higher than 20. In some cases, the ratio of the 7S and the 11S (7S/11S) is higher than 50. In some cases, the ratio of the 7S and the 11S (7S/11S) is higher than 100. In some cases, the ratio of the 7S and the 11S (7S/11S) is higher than 1000. In some cases, the casein micelle comprises recombinant casein proteins.

In some cases, the disclosed composition comprises 7S and 11S, where the molar ratio of 7S/11S is lower than 0.5. In some cases, the molar ratio of 7S/11S is lower than 0.45. In some cases, the molar ratio of 7S/11S is lower than 0.4. In some cases, the molar ratio of 7S/11S is lower than 0.35. In some cases, the molar ratio of 7S/11S is lower than 0.3. In some cases, the molar ratio of 7S/11S is lower than 0.25. In some cases, the molar ratio of 7S/11S is lower than 0.2. In some cases, the molar ratio of 7S/11S is lower than 0.15. In some cases, the molar ratio of 7S/11S is lower than 0.1. In some cases, the molar ratio of 7S/11S is lower than 0.05. In some cases, the molar ratio of 7S/11S is lower than 0.01. In some cases, the molar ratio of 7S/11S is lower than 0.001. In some cases, the molar ratio of 7S/11S is lower than 0.0001. In some cases, the molar ratio of 7S/11S is lower than 0.00001. In some cases, the molar ratio of 7S/115 is lower than 0.000001. In some cases, the molar ratio of 7S/115 is lower than 0.0000001. In some cases, the molar ratio of 7S/11S is 0 or close to 0, wherein the soy ingredient comprises a trace amount of 7S (e.g., β-conglycinin), or does not comprise a detectable amount of 7S (e.g., β-conglycinin).

In some cases, the disclosed composition comprises 7S and 11S, where molar ratio of 11S/7S is lower than 0.77. In some cases, the molar ratio of 11S/7S is lower than 0.7. In some cases, the molar ratio of 11S/7S is lower than 0.6. In some cases, the molar ratio of 11S/7S is lower than 0.5. In some cases, the molar ratio of 11S/7S is lower than 0.45. In some cases, the molar ratio of 11S/7S is lower than 0.4. In some cases, the molar ratio of 11S/7S is lower than 0.35. In some cases, the molar ratio of 11S/7S is lower than 0.3. In some cases, the molar ratio of 11S/7S is lower than 0.25. In some cases, the molar ratio of 11S/7S is lower than 0.2. In some cases, the molar ratio of 11S/7S is lower than 0.15. In some cases, the molar ratio of 11S/7S is lower than 0.1. In some cases, the molar ratio of 11S/7S is lower than 0.05. In some cases, the molar ratio of 11S/7S is lower than 0.01. In some cases, the molar ratio of 11S/7S is lower than 0.001. In some cases, the molar ratio of 11S/7S is lower than 0.0001. In some cases, the molar ratio of 11S/7S is lower than 0.00001. In some cases, the molar ratio of 11S/7S is lower than 0.000001. In some cases, the molar ratio of 11S/7S is lower than 0.0000001. In some cases, the molar ratio of 11S/7S is close to 0, wherein the soy ingredient comprises only trace amount of 11S (e.g., glycinin), or does not comprise a detectable amount of 11S (e.g., glycinin).

In some cases, the soy ingredient is in the form of soy protein isolate. In some cases, the soy ingredient is in the form of soymilk. It is contemplated that disclosed ratios, weight percentages of different proteins are present in a dairy product, milk, cheese, cheese curd, or an intermediate product made during the process of making a dairy product (e.g., cheese). In some cases, the source of the casein micelles is from an animal, for example a mammal, for example, a human. In some cases, the mammal is a ruminant. In some cases, the ruminant is bovine, sheep, or goat. In some cases, the source of the casein micelles is from a genetically modified microorganism, for example, yeast, fungi, or bacteria. In some cases, the source of the casein micelles is from a genetically modified plant. In some cases, the genetically modified plant is a soybean plant.

In some cases, the composition is a dairy product (e.g., milk, cheese), or an intermediate product (e.g., cheese curd) made during the process of making a dairy product. In some cases, casein protein is more than 50% (w/w) of total protein in the composition. In some cases, casein protein is more than 40% (w/w) of total protein in the composition. In some cases, casein protein is more than 30% (w/w) of total protein in the composition. In some cases, casein protein is more than 20% (w/w) of total protein in the composition. In some cases, casein protein is more than 10% (w/w) of total protein in the composition. In some cases, casein protein is more than 5% (w/w) of total protein in the composition. In some cases, casein protein is less than 50% (w/w) of total protein in the composition. In some cases, casein protein is less than 60% (w/w) of total protein in the composition. In some cases, casein protein is less than 70% (w/w) of total protein in the composition. In some cases, casein protein is less than 80% (w/w) of total protein in the composition. In some cases, casein protein is less than 90% (w/w) of total protein in the composition. In some cases, the weight ratio of total casein protein and total soy protein in the disclosed composition is lower than 0.8. In some cases, the weight ratio of total casein protein and total soy protein is lower than 0.7. In some cases, the weight ratio of total casein protein and total soy protein is lower than 0.6. In some cases, the weight ratio of total casein protein and total soy protein is lower than 0.5. In some cases, the weight ratio of total casein protein and total soy protein is lower than 0.4. In some cases, the weight ratio of total casein protein and total soy protein is lower than 0.3. In some cases, the weight ratio of total casein protein and total soy protein is lower than 0.2. In some cases, the weight ratio of total casein protein and total soy protein is lower than 0.1. In some cases, the weight ratio of total casein protein and total soy protein in the disclosed composition is higher than 0.8. In some cases, the weight ratio of total casein protein and total soy protein is higher than 0.7. In some cases, the weight ratio of total casein protein and total soy protein is higher than 0.6. In some cases, the weight ratio of total casein protein and total soy protein is higher than 0.5. In some cases, the weight ratio of total casein protein and total soy protein is higher than 0.4. In some cases, the weight ratio of total casein protein and total soy protein is higher than 0.3. In some cases, the weight ratio of total casein protein and total soy protein is higher than 0.2. In some cases, the weight ratio of total casein protein and total soy protein is higher than 0.1.

In some cases, soy protein is more than 30% (w/w) of total protein in the composition. In some cases, soy protein is more than 40% (w/w) of total protein in the composition. In some cases, soy protein is more than 50% (w/w) of total protein in the composition. In some cases, soy protein is more than 60% (w/w) of total protein in the composition. In some cases, soy protein is more than 70% (w/w) of total protein in the composition. In some cases, soy protein is more than 80% (w/w) of total protein in the composition. In some cases, soy protein is more than 90% (w/w) of total protein in the composition. In some cases, the composition is a dairy product or an intermediate product made during the process of making a dairy product (e.g., cheese).

Some aspects of the disclosure provide a composition comprising a casein micelle and a soy ingredient, wherein the soy ingredient comprises 11S (e.g., glycinin) in an amount greater than 50% (w/w) of total soy proteins in the composition. In some cases, the 11S (e.g., glycinin) is in an amount greater than 60% (w/w) of total soy proteins. In some cases, the 11S (e.g., glycinin) is in an amount greater than 70% (w/w) of total soy proteins. In some cases, the 11S (e.g., glycinin) is in an amount greater than 75% (w/w) of total soy proteins. In some cases, the 11S (e.g., glycinin) is in an amount greater than 80% (w/w) of total soy proteins. In some cases, the 11S (e.g., glycinin) is in an amount greater than 85% (w/w) of total soy proteins. In some cases, the 11S (e.g., glycinin) is in an amount greater than 90% (w/w) of total soy proteins. In some cases, the 11S (e.g., glycinin) is in an amount greater than 95% (w/w) of total soy proteins. In some cases, the 11S (e.g., glycinin) is in an amount greater than 99% (w/w) of total soy proteins.

Some aspects of the disclosure provide a composition comprising a casein micelle and a soy ingredient, wherein the soy ingredient comprises 11S (e.g., glycinin) in an amount greater than 50% (w/w) of total seed storage protein in the composition. In some cases, the 11S (e.g., glycinin) is in an amount greater than 60% (w/w) of total seed storage protein in the composition. In some cases, the 11S (e.g., glycinin) is in an amount greater than 70% (w/w) of total seed storage protein in the composition. In some cases, the 11S (e.g., glycinin) is in an amount greater than 75% (w/w) of total seed storage protein in the composition. In some cases, the 11S (e.g., glycinin) is in an amount greater than 80% (w/w) of total seed storage protein in the composition. In some cases, the 11S (e.g., glycinin) is in an amount greater than 85% (w/w) of total seed storage protein in the composition. In some cases, the 11S (e.g., glycinin) is in an amount greater than 90% (w/w) of total seed storage protein in the composition. In some cases, the 11S (e.g., glycinin) is in an amount greater than 95% (w/w) of total seed storage protein in the composition. In some cases, the 11S (e.g., glycinin) is in an amount greater than 99% (w/w) of total seed storage protein in the composition.

Some aspects of the disclosure provide a composition comprising a casein micelle and a soy ingredient, wherein the soy ingredient comprises 11S (e.g., glycinin) in an amount greater than 50% (w/w) of total protein in the composition. In some cases, the 11S (e.g., glycinin) is in an amount greater than 60% (w/w) of total protein in the composition. In some cases, the 11S (e.g., glycinin) is in an amount greater than 70% (w/w) of total protein in the composition. In some cases, the 11S (e.g., glycinin) is in an amount greater than 75% (w/w) of total protein in the composition. In some cases, the 11S (e.g., glycinin) is in an amount greater than 80% (w/w) of total protein in the composition. In some cases, the 11S (e.g., glycinin) is in an amount greater than 85% (w/w) of total protein in the composition. In some cases, the 11S (e.g., glycinin) is in an amount greater than 90% (w/w) of total protein in the composition. In some cases, the 11S (e.g., glycinin) is in an amount greater than 95% (w/w) of total protein in the composition. In some cases, the 11S (e.g., glycinin) is in an amount greater than 99% (w/w) of total protein in the composition.

Some aspects of the disclosure provide a composition comprising a casein micelle and a soy ingredient, wherein the soy ingredient comprises 7S (e.g., β-conglycinin) in an amount greater than 50% (w/w) of total soy proteins in the composition. In some cases, the 7S (e.g., β-conglycinin) is in an amount greater than 60% (w/w) of total soy proteins. In some cases, the 7S (e.g., β-conglycinin) is in an amount greater than 70% (w/w) of total soy proteins. In some cases, the 7S (e.g., β-conglycinin) is in an amount greater than 75% (w/w) of total soy proteins. In some cases, the 7S (e.g., β-conglycinin) is in an amount greater than 80% (w/w) of total soy proteins. In some cases, the 7S (e.g., β-conglycinin) is in an amount greater than 85% (w/w) of total soy proteins. In some cases, the 7S (e.g., β-conglycinin) is in an amount greater than 90% (w/w) of total soy proteins. In some cases, the 7S (e.g., β-conglycinin) is in an amount greater than 95% (w/w) of total soy proteins.

Some aspects of the disclosure provide a composition comprising a casein micelle and a soy ingredient, wherein the soy ingredient comprises 7S (e.g., β-conglycinin) in an amount greater than 50% (w/w) of total protein in the composition. In some cases, the 7S (e.g., β-conglycinin) is in an amount greater than 60% (w/w) of total protein in the composition. In some cases, the 7S (e.g., β-conglycinin) is in an amount greater than 70% (w/w) of total protein in the composition. In some cases, the 7S (e.g., β-conglycinin) is in an amount greater than 75% (w/w) of total protein in the composition. In some cases, the 7S (e.g., β-conglycinin) is in an amount greater than 80% (w/w) of total protein in the composition. In some cases, the 7S (e.g., β-conglycinin) is in an amount greater than 85% (w/w) of total protein in the composition. In some cases, the 7S (e.g., β-conglycinin) is in an amount greater than 90% (w/w) of total protein in the composition. In some cases, the 7S (e.g., β-conglycinin) is in an amount greater than 95% (w/w) of total protein in the composition.

Some aspects of the disclosure provide a composition comprising a casein micelle and a soy ingredient, wherein the soy ingredient comprises 7S (e.g., β-conglycinin) in an amount greater than 50% (w/w) of total seed storage protein in the composition. In some cases, the 7S (e.g., β-conglycinin) is in an amount greater than 60% (w/w) of total seed storage protein in the composition. In some cases, the 7S (e.g., β-conglycinin) is in an amount greater than 70% (w/w) of total seed storage protein in the composition. In some cases, the 7S (e.g., β-conglycinin) is in an amount greater than 75% (w/w) of total seed storage protein in the composition. In some cases, the 7S (e.g., β-conglycinin) is in an amount greater than 80% (w/w) of total seed storage protein in the composition. In some cases, the 7S (e.g., β-conglycinin) is in an amount greater than 85% (w/w) of total seed storage protein in the composition. In some cases, the 7S (e.g., β-conglycinin) is in an amount greater than 90% (w/w) of total seed storage protein in the composition. In some cases, the 7S (e.g., β-conglycinin) is in an amount greater than 95% (w/w) of total seed storage protein in the composition.

Some aspects of the disclosure provide a composition comprising a casein micelle and a soy ingredient, wherein the soy ingredient comprises 11S (e.g., glycinin) in an amount less than 50% (w/w) of total soy proteins in the composition. In some cases, the 11S (e.g., glycinin) is in an amount less than 40% (w/w) of total soy proteins. In some cases, the 11S (e.g., glycinin) is in an amount less than 30% (w/w) of total soy proteins. In some cases, the 11S (e.g., glycinin) is in an amount less than 20% (w/w) of total soy proteins. In some cases, the 11S (e.g., glycinin) is in an amount less than 10% (w/w) of total soy proteins. In some cases, the 11S (e.g., glycinin) is in an amount less than 5% (w/w) of total soy proteins. In some cases, the 11S (e.g., glycinin) is in an amount less than 1% (w/w) of total soy proteins. In some cases, the 11S (e.g., glycinin) is in an amount less than 0.1% (w/w) of total soy proteins. In some cases, the 11S (e.g., glycinin) is in an amount less than 0.01% (w/w) of total soy proteins. In some cases, the 11S (e.g., glycinin) is in an amount less than 0.001% (w/w) of total soy proteins. In some cases, the 11S (e.g., glycinin) is in an amount less than 0.0001% (w/w) of total soy proteins. In some cases, the 11S (e.g., glycinin) is in an amount less than 0.00001% (w/w) of total soy proteins. In some cases, the 11S (e.g., glycinin) is in an amount less than 0.000001% (w/w) of total soy proteins.

Some aspects of the disclosure provide a composition comprising a casein micelle and a soy ingredient, wherein the soy ingredient comprises 11S (e.g., glycinin) in an amount less than 50% (w/w) of total protein in the composition. In some cases, the 11S (e.g., glycinin) is in an amount less than 40% (w/w) of total protein in the composition. In some cases, the 11S (e.g., glycinin) is in an amount less than 30% (w/w) of total protein in the composition. In some cases, the 11S (e.g., glycinin) is in an amount less than 20% (w/w) of total protein in the composition. In some cases, the 11S (e.g., glycinin) is in an amount less than 10% (w/w) of total protein in the composition. In some cases, the 11S (e.g., glycinin) is in an amount less than 5% (w/w) of total protein in the composition. In some cases, the 11S (e.g., glycinin) is in an amount less than 1% (w/w) of total protein in the composition. In some cases, the 11S (e.g., glycinin) is in an amount less than 0.1% (w/w) of total protein in the composition. In some cases, the 11S (e.g., glycinin) is in an amount less than 0.01% (w/w) of total protein in the composition. In some cases, the 11S (e.g., glycinin) is in an amount less than 0.001% (w/w) of total protein in the composition. In some cases, the 11S (e.g., glycinin) is in an amount less than 0.0001% (w/w) of total protein in the composition. In some cases, the 11S (e.g., glycinin) is in an amount less than 0.00001% (w/w) of total protein in the composition. In some cases, the 11S (e.g., glycinin) is in an amount less than 0.000001% (w/w) of total protein in the composition.

Some aspects of the disclosure provide a composition comprising a casein micelle and a soy ingredient, wherein the soy ingredient comprises 11S (e.g., glycinin) in an amount less than 50% (w/w) of total seed storage protein in the composition. In some cases, the 11S (e.g., glycinin) is in an amount less than 40% (w/w) of total seed storage protein in the composition. In some cases, the 11S (e.g., glycinin) is in an amount less than 30% (w/w) of total seed storage protein in the composition. In some cases, the 11S (e.g., glycinin) is in an amount less than 20% (w/w) of total seed storage protein in the composition. In some cases, the 11S (e.g., glycinin) is in an amount less than 10% (w/w) of total seed storage protein in the composition. In some cases, the 11S (e.g., glycinin) is in an amount less than 5% (w/w) of total seed storage protein in the composition. In some cases, the 11S (e.g., glycinin) is in an amount less than 1% (w/w) of total seed storage protein in the composition. In some cases, the 11S (e.g., glycinin) is in an amount less than 0.1% (w/w) of total seed storage protein in the composition. In some cases, the 11S (e.g., glycinin) is in an amount less than 0.01% (w/w) of total seed storage protein in the composition. In some cases, the 11S (e.g., glycinin) is in an amount less than 0.001% (w/w) of total seed storage protein in the composition. In some cases, the 11S (e.g., glycinin) is in an amount less than 0.0001% (w/w) of total seed storage protein in the composition. In some cases, the 11S (e.g., glycinin) is in an amount less than 0.00001% (w/w) of total seed storage protein in the composition. In some cases, the 11S (e.g., glycinin) is in an amount less than 0.000001% (w/w) of total seed storage protein in the composition.

Some aspects of the disclosure provide a composition comprising a casein micelle and a soy ingredient, wherein the soy ingredient comprises 7S (e.g., β-conglycinin) in an amount less than 50% (w/w) of total soy proteins in the composition. In some cases, the 7S (e.g., β-conglycinin) is in an amount less than 40% (w/w) of total soy proteins. In some cases, the 7S (e.g., β-conglycinin) is in an amount less than 30% (w/w) of total soy proteins. In some cases, the 7S (e.g., β-conglycinin) is in an amount less than 20% (w/w) of total soy proteins. In some cases, the 7S (e.g., β-conglycinin) is in an amount less than 10% (w/w) of total soy proteins. In some cases, the 7S (e.g., β-conglycinin) is in an amount less than 5% (w/w) of total soy proteins. In some cases, the 7S (e.g., β-conglycinin) is in an amount less than 1% (w/w) of total soy proteins. In some cases, the 7S (e.g., β-conglycinin) is in an amount less than 0.1% (w/w) of total soy proteins. In some cases, the 7S (e.g., β-conglycinin) is in an amount less than 0.01% (w/w) of total soy proteins. In some cases, the 7S (e.g., β-conglycinin) is in an amount less than 0.001% (w/w) of total soy proteins. In some cases, the 7S (e.g., β-conglycinin) is in an amount less than 0.0001% (w/w) of total soy proteins. In some cases, the 7S (e.g., β-conglycinin) is in an amount less than 0.00001% (w/w) of total soy proteins. In some cases, the 7S (e.g., β-conglycinin) is in an amount less than 0.000001% (w/w) of total soy proteins.

Some aspects of the disclosure provide a composition comprising a casein micelle and a soy ingredient, wherein the soy ingredient comprises 7S (e.g., β-conglycinin) in an amount less than 50% (w/w) of total protein in the composition. In some cases, the 7S (e.g., β-conglycinin) is in an amount less than 40% (w/w) of total protein in the composition. In some cases, the 7S (e.g., β-conglycinin) is in an amount less than 30% (w/w) of total protein in the composition. In some cases, the 7S (e.g., β-conglycinin) is in an amount less than 20% (w/w) of total protein in the composition. In some cases, the 7S (e.g., β-conglycinin) is in an amount less than 10% (w/w) of total protein in the composition. In some cases, the 7S (e.g., β-conglycinin) is in an amount less than 5% (w/w) of total protein in the composition. In some cases, the 7S (e.g., β-conglycinin) is in an amount less than 1% (w/w) of total protein in the composition. In some cases, the 7S (e.g., β-conglycinin) is in an amount less than 0.1% (w/w) of total protein in the composition. In some cases, the 7S (e.g., β-conglycinin) is in an amount less than 0.01% (w/w) of total protein in the composition. In some cases, the 7S (e.g., β-conglycinin) is in an amount less than 0.001% (w/w) of total protein in the composition. In some cases, the 7S (e.g., β-conglycinin) is in an amount less than 0.0001% (w/w) of total protein in the composition. In some cases, the 7S (e.g., β-conglycinin) is in an amount less than 0.00001% (w/w) of total protein in the composition. In some cases, the 7S (e.g., β-conglycinin) is in an amount less than 0.000001% (w/w) of total protein in the composition.

Some aspects of the disclosure provide a composition comprising a casein micelle and a soy ingredient, wherein the soy ingredient comprises 7S (e.g., β-conglycinin) in an amount less than 50% (w/w) of total seed storage protein in the composition. In some cases, the 7S (e.g., β-conglycinin) is in an amount less than 40% (w/w) of total seed storage protein in the composition. In some cases, the 7S (e.g., β-conglycinin) is in an amount less than 30% (w/w) of total seed storage protein in the composition. In some cases, the 7S (e.g., β-conglycinin) is in an amount less than 20% (w/w) of total seed storage protein in the composition. In some cases, the 7S (e.g., β-conglycinin) is in an amount less than 10% (w/w) of total seed storage protein in the composition. In some cases, the 7S (e.g., β-conglycinin) is in an amount less than 5% (w/w) of total seed storage protein in the composition. In some cases, the 7S (e.g., β-conglycinin) is in an amount less than 1% (w/w) of total seed storage protein in the composition. In some cases, the 7S (e.g., β-conglycinin) is in an amount less than 0.1% (w/w) of total seed storage protein in the composition. In some cases, the 7S (e.g., β-conglycinin) is in an amount less than 0.01% (w/w) of total seed storage protein in the composition. In some cases, the 7S (e.g., β-conglycinin) is in an amount less than 0.001% (w/w) of total seed storage protein in the composition. In some cases, the 7S (e.g., β-conglycinin) is in an amount less than 0.0001% (w/w) of total seed storage protein in the composition. In some cases, the 7S (e.g., β-conglycinin) is in an amount less than 0.00001% (w/w) of total seed storage protein in the composition. In some cases, the 7S (e.g., β-conglycinin) is in an amount less than 0.000001% (w/w) of total seed storage protein in the composition.

In some cases, the total soy protein comprises one or more of seed storage proteins, for example, legumin, vicilin, prolamin, gliadin, β-conglycinin, or glycinin In some cases, the composition is a dairy product (e.g., cheese) or an intermediate product made during the process of making a dairy product.

In some cases, the composition forms a cheese curd in a cheese making process. In some cases, the composition forms a firm cheese curd in a cheese making process. In some cases, the composition forms a firm cheese curd in a cheese making process within 15 minutes in the cheese making process. In some cases, the composition forms a firm cheese curd in a cheese making process within 30 minutes in the cheese making process. In some cases, the composition forms a firm cheese curd in a cheese making process within 60 minutes in the cheese making process. In some cases, the composition forms a firm cheese curd in a cheese making process within 100 minutes in the cheese making process.

In some cases, the composition forms a soft cheese curd in a cheese making process. In some cases, the composition forms a soft cheese curd within 15 minutes in the cheese making process. In some cases, the composition forms a soft cheese curd within 30 minutes in the cheese making process. In some cases, the composition forms a soft cheese curd within 60 minutes in the cheese making process. In some cases, the composition forms a soft cheese curd within 100 minutes in the cheese making process.

In some cases, the cheese-making process is performed at pH between 6.0-7.0. In some cases, the cheese making process is performed at pH between 6.0-6.5. In some cases, the cheese making process is performed at pH between 6.5-7.0. In some cases, the cheese making process comprises adding an enzyme (e.g., one or more enzymes found in rennet, or other suitable proteases) to the composition to cause the casein micelle to precipitate.

In some aspects, the current disclosure provides a cheese product comprising the composition disclosed herein. In some aspects, the current disclosure provides a method of making cheese, comprising providing the composition disclosed herein, and adding rennet to the composition to cause the casein micelles to precipitate. In some aspects, the method disclosed herein comprises mixing soy ingredient with soluble casein micelles.

In some aspects, the current disclosure provides compositions, methods and systems for making cheese using a modified soy ingredient. In some aspects, the modified soy ingredient comprises a non-detectable or reduced level of an anti-nutritional or toxin in soybean (for example, including trypsin inhibitors, phytic acid, lectins, or soybean toxin), compared to a natural occurring level found in non-modified soybeans. For example, the non-detectable or reduced levels of anti-nutritional or toxin can be achieved by knocking out or down one or more of the following genes: anti-nutritional/toxins in soybean, including trypsin inhibitors, phytic acid, lectins, soybean toxin.

In some aspects, the current disclosure provides compositions, methods and systems for making cheese using one or more seed storage proteins (e.g., legumin, vicilin, prolamin gliadin, etc.), in lieu of soy proteins as disclosed herein.

In some aspects, the current disclosure provides a method of making a dairy product, comprising, providing a liquid mixture comprising casein micelles and at least one soy protein; removing a portion of the soy protein from the liquid mixture; and adding an enzyme to the liquid mixture to cause the casein micelles to precipitate. In some cases, the at least one soy protein to be removed comprises a subunit of conglycinin In some cases, removing the portion of the soy protein from the liquid mixture decreases the ratio of conglycinin to glycinin (conglycinin/glycinin). In some cases, the enzyme comprises at least one enzyme found in rennet. In some cases, the enzyme comprises a protease. In some cases, the enzyme comprises at least one of chymosin, pepsin or lipase.

In some cases, removing the portion of soy protein from the mixture comprises adding a salt to the liquid mixture to precipitate the portion of soy protein. In some cases, the salt is at least one of sodium phosphate, calcium chloride, or potassium chloride. In some cases, removing the portion of soy protein from the mixture further comprises filtering the composition to produce a supernatant.

In some cases, filtering the composition comprises using a microfiltration (MF) membrane to filter the composition. In some cases, filtering the composition comprises using a benchtop tangential flow filtration system to filter the composition. In some cases, the microfiltration (MF) membrane has a pore size between 0.1 and 10 μm. In some cases, the microfiltration (MF) membrane has a pore size between 0.1 and 1 μm. In some cases, the microfiltration (MF) membrane has a pore size between 1 and 10 μm. In some cases, the casein micelles precipitate to form a curd. In some cases, the casein micelles precipitate to form a solid or semi-solid.

Some aspects of the disclosure provide a composition, comprising a casein micelle derived from a plant; and a plant protein comprising one of legumin, vicilin, prolamin, gliadin, β-conglycinin, or glycinin, or any combination thereof. In some cases, the plant protein is a seed storage protein. In some cases, one or more of the plant proteins described herein is a soy protein. In some cases, the plant protein described herein is non-soy protein, including, for example, a protein from maize, pea, peanut, rice, sesame, lima bean, pea, chickpea, maize, wheat, rice, barley, or oat, etc. In some cases, the plant protein comprises 11S (e.g., glycinin). In some cases, the plant protein further comprises 7S (e.g., β-conglycinin). In some cases, the ratio of 7S/11S is lower than a naturally occurring ratio. In some cases, the ratio of 7S/11S (w/w) is lower than 0.5. In some cases, the ratio of 7S/11S (w/w) is lower than 0.75. In some cases, the ratio of 7S/11S (w/w) is lower than 1. In some cases, the ratio of 7S/11S (w/w) is lower than 1.3. In some cases, the ratio of 7S/11 s(w/w) is lower than 0.4. In some cases, the ratio of 7S/11S (w/w) is lower than 0.3. In some cases, the ratio of 7S/11S (w/w) is lower than 0.25. In some cases, the ratio of 7S/11S (w/w) is lower than 0.2. In some cases, the ratio of 7S/11S (w/w) is lower than 0.1. In some cases, the ratio of 7S/11S (w/w) is lower than 0.05. In some cases, the ratio of 7S/11S (w/w) is lower than 0.01. In some cases, the ratio of 7S/11S (w/w) is lower than 00.1. In some cases, the composition does not comprise a detectable amount of 7S (e.g., β-conglycinin).

In some cases, the ratio of 11S/7S is lower than a naturally occurring ratio. In some cases, the ratio of 11S/7S (w/w) is lower than 0.5. In some cases, the ratio of 11S/7S (w/w) is lower than 0.75. In some cases, the ratio of 11S/7S (w/w) is lower than 1. In some cases, the ratio of 11S/7S (w/w) is lower than 1.3. In some cases, the ratio of 7S/11 s(w/w) is lower than 0.4. In some cases, the ratio of 11S/7S (w/w) is lower than 0.3. In some cases, the ratio of 11S/7S (w/w) is lower than 0.25. In some cases, the ratio of 11S/7S (w/w) is lower than 0.2. In some cases, the ratio of 11S/7S (w/w) is lower than 0.1. In some cases, the ratio of 11S/7S (w/w) is lower than 0.01. In some cases, the ratio of 11S/7S (w/w) is lower than 0.001. In some cases, the ratio of 11S/7S (w/w) is lower than 0.0001. In some cases, the ratio of 11S/7S (w/w) is lower than 0.00001. In some cases, the ratio of 11S/7S (w/w) is lower than 0.000001. In some cases, the ratio of 11S/7S (w/w) is lower than 0.0000001. In some cases, the composition does not comprise a detectable amount of 11S (e.g., glycinin).

In some instances, the plant protein is inside the casein micelle. In some cases, an outer layer of the casein micelle is enriched with a κ-casein, and an inner matrix of the casein micelle comprises at least one of α_{S}1-casein, α_{S}2-casein, or β-casein. In some cases, the plant protein (e.g., 7S, 11S, or both) interacts with one or more of the casein proteins in the inner matrix. In some cases, the plant protein binds to any one of α_{S}1-casein, α_{S}2-casein, or β-casein. In some instances, the binding between the plant protein and the α_{S}1-casein, α_{S}2-casein, or β-casein is noncovalent. In some cases, the plant protein is at least partially embedded in the inner matrix. In some cases, the plant protein is fully embedded in the inner matrix. In some cases, the plant protein is on the surface of the casein micelle. In some cases, the plant protein (e.g., 7S, 11S, or both) interacts with a κ-casein on an outer layer of the casein micelle. In some cases, the plant protein binds to the κ-casein. In some instances, the binding between the plant protein and the κ-casein is noncovalent. In some cases, the plant protein is at least partially embedded in the outer layer of the casein micelle. In some cases, the composition is a dairy product or an intermediate product made during the process of making a dairy product (e.g., cheese).

In some cases, the plant protein that is present inside the casein micelle or attached to the surface of the casein micelle is present in a trace amount in the composition, as described herein. For example, in some cases, the trace amount plant protein is less than 5% (w/w) of total protein in the composition. In some cases, the trace amount plant protein is less than 4% (w/w) of total protein in the composition. In some cases, the trace amount plant protein is less than 3% (w/w) of total protein in the composition. In some cases, the trace amount plant protein is less than 2% (w/w) of total protein in the composition. In some cases, the trace amount plant protein is less than 1% (w/w) of total protein in the composition. In some cases, the trace amount plant protein is less than 0.5% (w/w) of total protein in the composition. In some cases, the trace amount plant protein is less than 0.4% (w/w) of total protein in the composition. In some cases, the trace amount plant protein is less than 0.3% (w/w) of total protein in the composition. In some cases, the trace amount plant protein is less than 0.2% (w/w) of total protein in the composition. In some cases, the trace amount plant protein is less than 0.1% (w/w) of total protein in the composition. In some cases, the trace amount plant protein is less than 0.09% (w/w) of total protein in the composition. In some cases, the trace amount plant protein is less than 0.08% (w/w) of total protein in the composition. In some cases, the trace amount plant protein is less than 0.07% (w/w) of total protein in the composition. In some cases, the trace amount plant protein is less than 0.06% (w/w) of total protein in the composition. In some cases, the trace amount plant protein is less than 0.05% (w/w) of total protein in the composition. In some cases, the trace amount plant protein is less than 0.04% (w/w) of total protein in the composition. In some cases, the trace amount plant protein is less than 0.03% (w/w) of total protein in the composition. In some cases, the trace amount plant protein is less than 0.02% (w/w) of total protein in the composition. In some cases, the trace amount plant protein is less than 0.01% (w/w) of total protein in the composition. In some cases, the trace amount plant protein is less than 0.005% (w/w) of total protein in the composition. In some cases, the trace amount plant protein is less than 0.001% (w/w) of total protein in the composition. In some cases, the trace amount plant protein is less than 0.0005% (w/w) of total protein in the composition. In some cases, the trace amount plant protein is less than 0.0001% (w/w) of total protein in the composition. In some cases, the trace amount plant protein is less than 0.00005% (w/w) of total protein in the composition. In some cases, the trace amount plant protein is more than 4% (w/w) of total protein in the composition. In some cases, the trace amount plant protein is more than 3% (w/w) of total protein in the composition. In some cases, the trace amount plant protein is more than 2% (w/w) of total protein in the composition. In some cases, the trace amount plant protein is more than 1% (w/w) of total protein in the composition. In some cases, the trace amount plant protein is more than 0.5% (w/w) of total protein in the composition. In some cases, the trace amount plant protein is more than 0.4% (w/w) of total protein in the composition. In some cases, the trace amount plant protein is more than 0.3% (w/w) of total protein in the composition. In some cases, the trace amount plant protein is more than 0.2% (w/w) of total protein in the composition. In some cases, the trace amount plant protein is more than 0.1% (w/w) of total protein in the composition. In some cases, the trace amount plant protein is more than 0.09% (w/w) of total protein in the composition. In some cases, the trace amount plant protein is more than 0.08% (w/w) of total protein in the composition. In some cases, the trace amount plant protein is more than 0.07% (w/w) of total protein in the composition. In some cases, the trace amount plant protein is more than 0.06% (w/w) of total protein in the composition. In some cases, the trace amount plant protein is more than 0.05% (w/w) of total protein in the composition. In some cases, the trace amount plant protein is more than 0.04% (w/w) of total protein in the composition. In some cases, the trace amount plant protein is more than 0.03% (w/w) of total protein in the composition. In some cases, the trace amount plant protein is more than 0.02% (w/w) of total protein in the composition. In some cases, the trace amount plant protein is more than 0.01% (w/w) of total protein in the composition. In some cases, the trace amount plant protein is more than 0.005% (w/w) of total protein in the composition. In some cases, the trace amount plant protein is more than 0.001% (w/w) of total protein in the composition. In some cases, the trace amount plant protein more than 0.0005% (w/w) of total protein in the composition. In some cases, the trace amount plant protein is more than 0.0001% (w/w) of total protein in the composition. In some cases, the trace amount plant protein is more than 0.00005% (w/w) of total protein in the composition. In some cases, the trace amount plant protein is more than 0.00003% (w/w) of total protein in the composition. In some cases, the trace amount plant protein is more than 0.00001% (w/w) of total protein in the composition. In some cases, the composition is a dairy product or an intermediate product made during the process of making a dairy product (e.g., cheese).

In some cases, the plant protein present in the compositions disclosed herein is not in a trace amount. For example, in some cases, the plant protein is more than 5% (w/w) of total protein content in the composition. In some cases, the plant protein is more than 10% (w/w) of total protein content in the composition. In some cases, the plant protein is more than 20% (w/w) of total protein content in the composition. In some cases, the plant protein is more than 30% (w/w) of total protein content in the composition. In some cases, the plant protein is more than 40% (w/w) of total protein content in the composition. In some cases, the plant protein is more than 50% (w/w) of total protein content in the composition. In some cases, the plant protein is more than 60% (w/w) of total protein content in the composition. In some cases, the plant protein is more than 70% (w/w) of total protein content in the composition. In some cases, the plant protein is more than 80% (w/w) of total protein content in the composition. In some cases, the plant protein is less than 10% (w/w) of total protein content in the composition. In some cases, the plant protein is less than 20% (w/w) of total protein content in the composition. In some cases, the plant protein is less than 30% (w/w) of total protein content in the composition. In some cases, the plant protein is less than 40% (w/w) of total protein content in the composition. In some cases, the plant protein is less than 50% (w/w) of total protein content in the composition. In some cases, the plant protein is less than 60% (w/w) of total protein content in the composition. In some cases, the plant protein is less than 70% (w/w) of total protein content in the composition. In some cases, the plant protein is less than 80% (w/w) of total protein content in the composition. In some cases, the plant protein is less than 90% (w/w) of total protein content in the composition. In some cases, the composition is a dairy product or an intermediate product made during the process of making a dairy product (e.g., cheese).

In some cases, the plant protein that is present inside the casein micelle or attached to the surface of the casein micelle is present in a trace amount in the composition, as described herein. For example, in some cases, the trace amount plant protein is less than 5% (w/w) of casein protein weight in the composition. In some cases, the trace amount plant protein is less than 4% (w/w) of casein protein weight in the composition. In some cases, the trace amount plant protein is less than 3% (w/w) of casein protein weight in the composition. In some cases, the trace amount plant protein is less than 2% (w/w) of casein protein weight in the composition. In some cases, the trace amount plant protein is less than 1% (w/w) of casein protein weight in the composition. In some cases, the trace amount plant protein is less than 0.5% (w/w) of casein protein weight in the composition. In some cases, the trace amount plant protein is less than 0.4% (w/w) of casein protein weight in the composition. In some cases, the trace amount plant protein is less than 0.3% (w/w) of casein protein weight in the composition. In some cases, the trace amount plant protein is less than 0.2% (w/w) of casein protein weight in the composition. In some cases, the trace amount plant protein is less than 0.1% (w/w) of casein protein weight in the composition. In some cases, the trace amount plant protein is less than 0.09% (w/w) of casein protein weight in the composition. In some cases, the trace amount plant protein is less than 0.08% (w/w) of casein protein weight in the composition. In some cases, the trace amount plant protein is less than 0.07% (w/w) of casein protein weight in the composition. In some cases, the trace amount plant protein is less than 0.06% (w/w) of casein protein weight in the composition. In some cases, the trace amount plant protein is less than 0.05% (w/w) of casein protein weight in the composition. In some cases, the trace amount plant protein is less than 0.04% (w/w) of casein protein weight in the composition. In some cases, the trace amount plant protein is less than 0.03% (w/w) of casein protein weight in the composition. In some cases, the trace amount plant protein is less than 0.02% (w/w) of casein protein weight in the composition. In some cases, the trace amount plant protein is less than 0.01% (w/w) of casein protein weight in the composition. In some cases, the trace amount plant protein is less than 0.005% (w/w) of casein protein weight in the composition. In some cases, the trace amount plant protein is less than 0.001% (w/w) of casein protein weight in the composition. In some cases, the trace amount plant protein is less than 0.0005% (w/w) of casein protein weight in the composition. In some cases, the trace amount plant protein is less than 0.0001% (w/w) of casein protein weight in the composition. In some cases, the trace amount plant protein is less than 0.00005% (w/w) of casein protein weight in the composition. In some cases, the trace amount plant protein is more than 4% (w/w) of casein protein weight in the composition. In some cases, the trace amount plant protein is more than 3% (w/w) of casein protein weight in the composition. In some cases, the trace amount plant protein is more than 2% (w/w) of casein protein weight in the composition. In some cases, the trace amount plant protein is more than 1% (w/w) of casein protein weight in the composition. In some cases, the trace amount plant protein is more than 0.5% (w/w) of casein protein weight in the composition. In some cases, the trace amount plant protein is more than 0.4% (w/w) of casein protein weight in the composition. In some cases, the trace amount plant protein is more than 0.3% (w/w) of casein protein weight in the composition. In some cases, the trace amount plant protein is more than 0.2% (w/w) of casein protein weight in the composition. In some cases, the trace amount plant protein is more than 0.1% (w/w) of casein protein weight in the composition. In some cases, the trace amount plant protein is more than 0.09% (w/w) of casein protein weight in the composition. In some cases, the trace amount plant protein is more than 0.08% (w/w) of casein protein weight in the composition. In some cases, the trace amount plant protein is more than 0.07% (w/w) of casein protein weight in the composition. In some cases, the trace amount plant protein is more than 0.06% (w/w) of casein protein weight in the composition. In some cases, the trace amount plant protein is more than 0.05% (w/w) of casein protein weight in the composition. In some cases, the trace amount plant protein is more than 0.04% (w/w) of casein protein weight in the composition. In some cases, the trace amount plant protein is more than 0.03% (w/w) of casein protein weight in the composition. In some cases, the trace amount plant protein is more than 0.02% (w/w) of casein protein weight in the composition. In some cases, the trace amount plant protein is more than 0.01% (w/w) of casein protein weight in the composition. In some cases, the trace amount plant protein is more than 0.005% (w/w) of casein protein weight in the composition. In some cases, the trace amount plant protein is more than 0.001% (w/w) of casein protein weight in the composition. In some cases, the trace amount plant protein more than 0.0005% (w/w) of casein protein weight in the composition. In some cases, the trace amount plant protein is more than 0.0001% (w/w) of casein protein weight in the composition. In some cases, the trace amount plant protein is more than 0.00005% (w/w) of casein protein weight in the composition. In some cases, the trace amount plant protein is more than 0.00003% (w/w) of casein protein weight in the composition. In some cases, the trace amount plant protein is more than 0.00001% (w/w) of casein protein weight in the composition. In some cases, the composition is a dairy product or an intermediate product made during the process of making a dairy product (e.g., cheese).

In some cases, the plant protein present in the compositions disclosed herein (e.g., a dairy product, or an intermediate product made during the process of making a dairy product (e.g., cheese)) is not in a trace amount. For example, in some cases, the plant protein is more than 5% (w/w) of casein protein weight in the composition. In some cases, the plant protein is more than 10% (w/w) of casein protein weight in the composition. In some cases, the plant protein is more than 20% (w/w) of casein protein weight in the composition. In some cases, the plant protein is more than 30% (w/w) of casein protein weight in the composition. In some cases, the plant protein is more than 40% (w/w) of casein protein weight in the composition. In some cases, the plant protein is more than 50% (w/w) of casein protein weight in the composition. In some cases, the plant protein is more than 60% (w/w) of casein protein weight in the composition. In some cases, the plant protein is more than 70% (w/w) of casein protein weight in the composition. In some cases, the plant protein is more than 80% (w/w) of casein protein weight in the composition. In some cases, the plant protein is less than 10% (w/w) of casein protein weight in the composition. In some cases, the plant protein is less than 20% (w/w) of casein protein weight in the composition. In some cases, the plant protein is less than 30% (w/w) of casein protein weight in the composition. In some cases, the plant protein is less than 40% (w/w) of casein protein weight in the composition. In some cases, the plant protein is less than 50% (w/w) of casein protein weight in the composition. In some cases, the plant protein is less than 60% (w/w) of casein protein weight in the composition. In some cases, the plant protein is less than 70% (w/w) of casein protein weight in the composition. In some cases, the plant protein is less than 80% (w/w) of casein protein weight in the composition. In some cases, the plant protein is less than 90% (w/w) of casein protein weight in the composition. In some cases, the composition is a dairy product or an intermediate product made during the process of making a dairy product (e.g., cheese).

In some cases, the number of plant proteins inside the casein micelle over the number of casein proteins of the casein micelle is less than 1:50000, less than 1:40000, less than 1:30000, less than 1:20000, less than 1:10000, less than 1:9000, less than 1:8000, less than 1:7000, less than 1:6000, less than 1:5000, less than 1:4000, less than 1:3000, less than 1:2000, less than 1:1000, less than 1:900, less than 1:800, less than 1:700, less than 1: 600, less than 1:500, less than 1:400, less than 1:300, less than 1:200, less than 1:100, less than 1:50, less than 1:10, less than 1:9, less than 1:8, less than 1:7, less than 1:6, less than 1:5, less than 1:4, less than 1:3, less than 1:2, or less than 1. In some cases, the number of plant proteins inside the casein micelle over the number of casein proteins of the casein micelle is more than 1:50000, more than 1:40000, more than 1:30000, more than 1:20000, more than 1:10000, more than 1:9000, more than 1:8000, more than 1:7000, more than 1:6000, more than 1:5000, more than 1:4000, more than 1:3000, more than 1:2000, more than 1: 1000, more than 1:900, more than 1:800, more than 1:700, more than 1:600, more than 1: 500, more than 1:400, more than 1:300, more than 1:200, more than 1:100, more than 1:50, more than 1:10, more than 1:9, more than 1:8, more than 1:7, more than 1:6, more than 1: 5, more than 1:4, more than 1:3, more than 1:2, or more than 1.

In some cases, the composition does not comprise a detectable amount of α-lactalbumin.

In some cases, the composition does not comprise a detectable amount of β-lactoglobulin. In some cases, the composition does not comprise a detectable amount of α_{S2}-casein. In some cases, the composition does not comprise a detectable amount of lactoferrin. In some cases, the composition does not comprise a detectable amount of transferrin. In some cases, the composition does not comprise a detectable amount of serum albumin. In some cases, the composition does not comprise a detectable amount of lysozyme. In some cases, the composition does not comprise a detectable amount of lactoperoxidase. In some cases, the composition does not comprise a detectable amount of immunoglobulin-A. In some cases, the composition does not comprise a detectable amount of lipase.

In some cases, the composition is free of α-lactalbumin. In some cases, the composition is free of β-lactoglobulin. In some cases, the composition is free of α_{S2}-casein. In some cases, the composition is free of α_{S1}-casein. In some cases, the composition is free of β-casein. In some cases, the composition is free of lactoferrin. In some cases, the composition is free of transferrin. In some cases, the composition is free of serum albumin. In some cases, the composition is free of lysozyme. In some cases, the composition is free of lactoperoxidase. In some cases, the composition is free of immunoglobulin-A. In some cases, the composition is free of lipase.

In some cases, the composition is essentially free of α-lactalbumin. In some cases, the composition is essentially free of β-lactoglobulin. In some cases, the composition is essentially free of α_{S2}-casein. In some cases, the composition is essentially free of β-casein. In some cases, the composition is essentially free of α_{S1}-casein. In some cases, the composition is essentially free of lactoferrin. In some cases, the composition is essentially free of transferrin. In some cases, the composition is essentially free of serum albumin. In some cases, the composition is essentially free of lysozyme. In some cases, the composition is essentially free of lactoperoxidase. In some cases, the composition is essentially free of immunoglobulin-A. In some cases, the composition is essentially free of lipase.

In some cases, the composition further comprises a coagulant. In some cases, the

coagulant is in a detectable amount. In some cases, the coagulant is a magnesium salt. In some cases, the magnesium salt is at least one of magnesium chloride (MgCl₂) or magnesium sulfate (MgSO₄). In some cases, the coagulant is a calcium salt. In some cases, the calcium salt is at least one of calcium chloride (CaCl2) or calcium sulfate (CaSO₄). In some cases, the coagulant is glucono-delta-lactone (GDL). In some cases, the coagulant is less than 0.1% (w/w) the composition. In some cases, the coagulant is less than 0.05% (w/w) the composition. In the coagulant is less than 0.01% (w/w) the composition. In some cases, the coagulant is less than 0.005% (w/w) the composition. In some cases, the coagulant is less than 0.001% (w/w) the composition. In some cases, the coagulant is more than 0.0005% (w/w) the composition. In some cases, the coagulant is more than 0.0001% (w/w) the composition. In some cases, the composition further comprises a fat. In some cases, the composition has a total fat content below 1%. In some cases, the fat is plant fat. In some cases, the composition has a total fat content below 0.1%. In some cases, the composition has a total fat content below 0.01%. In some cases, the composition does not comprise a detectable amount of animal fat. In some cases, the composition does not comprise a detectable amount of lactose. In some cases, the composition does not comprise a detectable amount of animal hormone. In some cases, the composition does not comprise a detectable amount of estrogen. In some cases, the composition does not comprise a detectable amount of progesterone. In some cases, the composition does not comprise a detectable amount of corticoid. In some cases, the composition does not comprise a detectable amount of androgen. In some cases, the composition is a substitute dairy product. In some instances, the composition is a powder. In some cases, the casein micelles derived from plants confer on the composition one or more characteristics of a dairy product selected from the group consisting of: taste, flavor, aroma, appearance, mouthfeel, density, structure, texture, elasticity, springiness, coagulation, binding, leavening, aeration, foaming, creaminess, and emulsification. In some cases, the dairy product is at least one of milk, cheese, yogurt, ghee, or butter.

In some instances, this disclosure provides methods of producing curds with improved elasticity over curds made with naturally-occurring ratios of soy proteins. In some cases, a ratio of conglycinin to glycinin provided herein produces curds with an elasticity of greater than 60%, 70%, 80%, 90%, 91%, 92%, 93%, 94%, 95%, 96%, 97%, 98%, 99%, or 99.5%, or 100%. In some cases, the ratio of conglycinin to glycinin is greater than 60%, 70%, 80%, 90%, 91%, 92%, 93%, 94%, 95%, 96%, 97%, 98%, 99%, or 99.5%, or 100%, combined with a composition with a percentage of casein that is at least 10%, 20%, 30%, 40%, 50%, 60%, 70%, 80%, 90%, 95%, 96%, 97%, 98%, 99%, or 99.5%, or 100% of total protein within the composition. For example, in some cases, the composition may have about 95% casein and about 5% total soy protein, or about 85% casein and about 15% total soy protein.

In some instances, the composition further comprises a solvent. In some cases, the solvent is water. In some cases, the composition further comprises a plant lipid, a plant sugar, a plant polyphenol, or plant DNA molecule, or any combination thereof. In some cases, the plant lipid, a plant sugar, a plant polyphenol, or plant DNA molecule is present in a trace amount in the composition. In some cases, the plant lipoid comprises at least one of stigmasterol, sitosterol, campesterol, or brassicasterol. In some cases, the plant polyphenol comprises isoflavone. In some cases, the plant DNA comprises plant DNA fragments.

The current disclosure provides compositions, methods, and systems for separating recombinant protein expressed in a plant from other plant materials.

In some aspects, the current disclosure provides methods for extracting one or more recombinant proteins expressed in a plant, comprising obtaining a mixture comprising water, the recombinant protein, and a component from the plant; adding a coagulant to the mixture to cause at least a portion of the plant component to coagulant; and extracting supernatant from the mixture, wherein the supernatant comprises the recombinant protein. In some aspects, the current disclosure provides methods for extracting a recombinant casein micelle expressed in a plant, comprising obtaining a mixture comprising water, the recombinant protein, and a component from the plant; adding a coagulant to the mixture to cause at least a portion of the plant component to coagulant; and extracting supernatant from the mixture, wherein the supernatant comprises the recombinant protein. Unexpectedly, under the conditions disclosed herein, only plant proteins coagulated, while the casein protein(s) and/or micelles remain soluble. In some cases, the methods are performed in sequence. In some cases, the mixture comprises a slurry made by blending the plant in water. In some cases, the disclosed methods further comprise separating insoluble plant components from the slurry to produce a plant-based milk before adding the coagulant to the mixture.

In some cases, the plant is a legume. In some cases, the plant is at least one of alfalfa, cassava, cotton, cowpea, maize, pea, peanut, rice, sesame, sorghum, soybean, or yam. In some cases, the plant component comprises a plant protein, a plant sugar, or plant fat. In some cases, the plant protein comprises a soy protein. In some cases, the soy protein is a storage protein comprising at least one of 7S (e.g., β-conglycinin) and 11S (e.g., glycinin).

In some cases, the recombinant protein is a casein protein. In some cases, the recombinant protein is a whey protein. In some cases, the recombinant protein is an egg white protein. In some cases, the recombinant protein is a collagen protein.

In some cases, the disclosed methods further comprise adjusting pH of the mixture after adding the coagulant. In some cases, the disclosed methods further comprise adding additional coagulant after adjusting pH of the mixture. In some cases, additional coagulant is different from the coagulant. In some cases, additional coagulant is the same as the coagulant. In some cases, the disclosed methods further comprise further adjusting pH of the mixture after adding the additional coagulant. In some cases, the coagulant or the additional coagulant is at least one of a magnesium salt, a calcium salt, glucono-delta-lactone (GDL), or any combination thereof. In some cases, the calcium salt is at least one of calcium chloride (CaCl₂) or calcium sulfate (CaSO₄). In some cases, the magnesium salt is at least one of magnesium chloride (MgCl₂) or magnesium sulfate (MgSO₄).

In some cases, the coagulant is added to the mixture reach a concentration above 1 mM, above 2 mM, above 3 mM, above 4 mM, above 5 mM, above 6 mM, above 7 mM, above 8 mM, above 9 mM, above 10 mM, above 11 mM, above 12 mM, above 13 mM, above 14 mM, above 15 mM, above 16 mM, above 17 mM, above 18 mM, above 19 mM, above 20 mM, above 30 mM, above 40 mM, above 50 mM, above 60 mM, above 70 mM, above 80 mM, above 90 mM, above 100 mM, above 150 mM, or above 200 mM.

In some cases, the coagulant is added to the mixture reach a concentration below 400 mM, below 390 mM, below 380 mM, below 370 mM, below 360 mM, below 350 mM, below 340 mM, below 330 mM, below 320 mM, below 310 mM, below 300 mM, below 290 mM, below 280 mM, below 270 mM, below 260 mM, below 250 mM, below 240 mM, below 230 mM, below 220 mM, below 210 mM, or below 200 mM.

In some cases, the coagulant is added to the mixture to reach a concentration between 20 and 400 mM. In some cases, the coagulant is added to the mixture to reach a concentration between 20 and 350 mM. In some cases, the coagulant is added to the mixture to reach a concentration between 20 and 300 mM. In some cases, the coagulant is added to the mixture to reach a concentration between 20 and 250 mM. In some cases, the coagulant is added to the mixture to reach a concentration between 20 and 200 mM.

In some aspects, the current disclosure provides methods for extracting one or more recombinant proteins expressed in a plant, comprising obtaining a mixture from the plant comprising water, the recombinant protein(s), and 7S and 11S proteins in a 7S/11S ratio which is smaller than the natural ratio. In some aspects, the current disclosure provides methods for extracting a recombinant casein micelle expressed in a plant, comprising obtaining a mixture from the plant comprising water, the recombinant protein, and 7S and 11S proteins in a 7S/11S ratio which is smaller than the natural ratio.

In some cases, the disclosed methods further comprise at least one of cleaning the plant material to remove dirt and foreign material; dehulling or deshelling the plant material; flaking the plant material; reducing the particle size of the plant material; extracting oil from the plant material with a hexane based solvent; desolventizing the plant material without cooking and denaturing the recombinant protein; soaking the plant material in water; or any combination thereof.

In some cases, the disclosed methods are performed below 80° C. In some cases, the disclosed methods are performed between 0° C. and 80° C. In some cases, the disclosed methods are performed between 0° C. and 70° C. In some cases, the disclosed methods are performed between 0° C. and 60° C. In some cases, the disclosed methods are performed between 0° C. and 50° C. In some cases, the disclosed methods are performed between 0° C. and 40° C. In some cases, the disclosed methods are performed between 0° C. and 30° C. In some cases, the disclosed methods are performed between 10° C. and 25° C. In some cases, the disclosed methods are performed at ambient temperature.

In some aspects, the disclosed methods further comprise filtering the supernatant. In some cases, filtering the supernatant comprises using a microfiltration (MF) membrane. In some cases, the MF membrane has a pore size between 0.1 and 0.2 μm, between 0.2 and 0.3 μm, between 0.3 and 0.4 μm, between 0.4 and 0.5 μm, between 0.5 and 0.6 μm, between 0.6 and 0.9 μm, between 0.9 and 1.5 μm, between 1.5 and 2 μm, between 2 and 2.5 μm, between 2.5 and 3 μm, between 3 and 4 μm, between 4 and 4.5 μm, between 4.5 and 5 μm, between 5 and 5.5 μm, between 5.5 and 6 μm, or between 6 and 10 μm. In some cases, filtering the supernatant comprising at least partially removes a plant component including soluble plant proteins, plant sugars, and minerals. In some cases, the membrane filtration comprises a diafiltration step to purify a target protein. In some cases, the diafiltration solution comprises one or more salts: magnesium chloride, sodium chloride, or calcium chloride.

In some aspects, the current disclosure provides a dairy product or dairy product substitute comprising the supernatant or a substance derived from the supernatant. In some aspects, the current disclosure provides a dairy product or dairy product substitute made using the methods disclosed herein. In some cases, the dairy product or dairy product substitute is cheese.

In some aspects, the current disclosure provides the dairy product or dairy product substitute comprising a recombinant casein protein and a coagulant. In some aspects, the coagulant is in a detectable amount using a standard testing method for indicating the presence of the coagulant in the dairy product or dairy product substitute. In some cases, the coagulant detectable in the dairy product or dairy product substitute is a magnesium salt, for example, at least one of magnesium chloride (MgCl₂) or magnesium sulfate (MgSO₄). In some cases, the coagulant detectable in the dairy product or dairy product substitute is a calcium salt, for example, at least one of calcium chloride (CaCl₂) or calcium sulfate (CaSO₄). In some cases, the coagulant detectable in the dairy product or dairy product substitute is glucono-delta-lactone (GDL).

In some cases, the coagulant detectable in the dairy product or dairy product substitute is less than 0.1% (w/w) the cheese product. In some cases, the coagulant detectable in the dairy product or dairy product substitute is less than 0.05% (w/w) the cheese product. In some cases, the coagulant detectable in the dairy product or dairy product substitute is less than 0.01% (w/w) the cheese product. In some cases, the coagulant detectable in the dairy product or dairy product substitute is less than 0.005% (w/w) the cheese product. In some cases, the coagulant detectable in the dairy product or dairy product substitute is less than 0.001% (w/w) the cheese product. In some cases, the coagulant detectable in the dairy product or dairy product substitute is more than 0.0005% (w/w) the cheese product. In some cases, the coagulant detectable in the dairy product or dairy product substitute is more than 0.0001% (w/w) the cheese product.

In some cases, the dairy product or dairy product substitute provided herein has a total fat content below 1%. In some cases, the dairy product or dairy product substitute provided herein has a total fat content below 0.1%. In some cases, the dairy product or dairy product substitute provided herein has a total fat content below 0.01%. In some cases, the dairy product or dairy product substitute provided herein has no detectable amount of animal fat. In some cases, the dairy product or dairy product substitute provided herein has no detectable amount of lactose. In some cases, the dairy product or dairy product substitute provided herein has no detectable amount of animal hormone, including, for example, at least one of estrogens, progesterone, corticoid, and androgen. In some cases, the dairy product or dairy product substitute provided herein is at least one of milk, cheese, yogurt, ghee, or butter. In some cases, the casein micelles derived from plants confer on the composition one or more characteristics of a dairy product selected from the group consisting of: taste, flavor, aroma, appearance, mouthfeel, density, structure, texture, elasticity, springiness, coagulation, binding, leavening, aeration, foaming, creaminess, and emulsification. In some cases, the composition is homogenous. In some cases, the composition is substantially homogenous.

Some aspects of the disclosure provide a composition comprising milk solids and soy proteins; wherein the soy proteins comprise glycinin and conglycinin, wherein the ratio of glycinin/conglycinin is elevated compared to a naturally occurring ratio, wherein the elevated glycinin/conglycinin ratio leads to better curd formation when the composition is subject to a curd forming condition. Some aspects of the disclosure provide a composition comprising milk solids and soy proteins; wherein the soy proteins comprise glycinin and conglycinin, wherein the ratio of glycinin/conglycinin is reduced compared to a naturally occurring ratio, wherein the reduced glycinin/conglycinin ratio leads to better curd formation when the composition is subject to a curd forming condition. In some instances, the weight ratio of the milk solids and the soy proteins is at least 60:40, at least 61:39, at least 62:38, at least 63:37, at least 64:36, at least 65:35, at least 66:34, at least 67:33, at least 68:32, at least 69:31, or at least 70:30.

In some instances, the weight ratio of the milk solids and the soy proteins is at least 75:25. In some instances, the weight ratio of the milk solids and the soy proteins is at least 80:20. In some instances, the weight ratio of the milk solids and the soy proteins is at most 65:35. In some instances, the weight ratio of the milk solids and the soy proteins is at most 70:30. In some instances, the weight ratio of the milk solids and the soy proteins is at most 75:25. In some instances, the weight ratio of the milk solids and the soy proteins is at most 80:20.

In some instances UHT milk is used. In some instances raw milk is used. In some instances vat pasteurized milk is used.

### Definitions

These and other valuable aspects of the embodiments of the present disclosure consequently further the state of the technology to at least the next level. While the disclosure has been described in conjunction with a specific best mode, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Use of absolute or sequential terms, for example, “will,” “will not,” “shall,” “shall not,” “must,” “must not,” “first,” “initially,” “next,” “subsequently,” “before,” “after,” “lastly,” and “finally,” are not meant to limit scope of the present embodiments disclosed herein but as exemplary.

As used herein, “or” may refer to “and”, “or,” or “and/or” and may be used both exclusively and inclusively. For example, the term “A or B” may refer to “A or B”, “A but not B”, “B but not A”, and “A and B”. In some cases, context may dictate a particular meaning.

Any systems, methods, software, and platforms described herein are modular and not limited to sequential steps. Accordingly, terms such as “first” and “second” do not necessarily imply priority, order of importance, or order of acts.

As used herein, the term “about” or the symbol “˜” when referring to a number or a numerical range means that the number or numerical range referred to is an approximation within experimental variability (or within statistical experimental error), and the number or numerical range may vary from, for example, from 1% to 10% of the stated number or numerical range. Unless otherwise indicated by context, the term “about” refers to ±10% of a stated number or value.

As used herein, the term “approximately” means within an acceptable error range for the particular value as determined by one of ordinary skill in the art, which will depend in part on how the value is measured or determined, e.g., the limitations of the measurement system. For example, “approximately” can mean within 1 or more than 1 standard deviation, per the practice in the given value. Where particular values are described in the application and claims, unless otherwise stated the term “approximately” should be assumed to mean an acceptable error range for the particular value.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure.

All ranges disclosed herein also encompass any and all possible sub-ranges and combinations of sub-ranges thereof. Any listed range can be recognized as sufficiently describing and enabling the same range being broken down into at least equal halves, thirds, quarters, fifths, tenths, and so forth. As a non-limiting example, each range discussed herein can be readily broken down into a lower third, middle third and upper third, and the like. All language such as “up to,” “at least,” “greater than,” “less than,” and the like include the number recited and refer to ranges which can be subsequently broken down into sub-ranges as discussed above. Finally, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

Whenever the term “at least,” “greater than,” “greater than or equal to”, or a similar phrase precedes the first numerical value in a series of two or more numerical values, the term “at least,” “greater than,” “greater than or equal to” or similar phrase applies to each of the numerical values in that series of numerical values. For example, “at least 1, 2, or 3” is equivalent to “at least 1, at least 2, and/or at least 3.”

Whenever the term “no more than,” “less than,” “less than or equal to,” “no greater than,” “at most” or a similar phrase, precedes the first numerical value in a series of two or more numerical values, the term “no more than,” “less than,” “less than or equal to,” “no greater than,” “at most,” or similar phrase applies to each of the numerical values in that series of numerical values. For example, “less than 3, 2, or 1” is equivalent to “less than 3, less than 2, and/or less than 1.”

As used herein, the following meanings apply unless otherwise specified. The word “may” is used in a permissive sense (i.e., meaning having the potential to), rather than the mandatory sense (i.e., meaning must). The words “include”, “including”, and “includes” and the like mean including, but not limited to. The singular forms “a,” “an,” and “the” include plural referents. Thus, for example, reference to “an element” includes a combination of two or more elements, notwithstanding use of other terms and phrases for one or more elements, such as “one or more.” The phrase “at least one” includes “one”, “one or more”, “one or a plurality” and “a plurality.” The term “or” is, unless indicated otherwise, non-exclusive, i.e., encompassing both “and” and “or.” The term “any of” between a modifier and a sequence means that the modifier modifies each member of the sequence. So, for example, the phrase “at least any of 1, 2 or 3” means “at least 1, at least 2 or at least 3.” The term “consisting essentially of” refers to the inclusion of recited elements and other elements that do not materially affect the basic and novel characteristics of a claimed combination.

Definition of standard chemistry terms may be found in reference works, including but not limited to, Carey and Sundberg “Advanced Organic Chemistry 4th Ed.” Vols. A (2000) and B (2001), Plenum Press, New York.

Where a definition or use of a term in an incorporated reference is inconsistent or contrary to the definition of that term provided herein, the definition of that term provided herein applies and the definition of that term in the reference does not apply

As used herein, the phrase “essentially free of” is used to indicate the indicated component, if present, is present in an amount that does not contribute, or contributes only in a de minimus fashion, to the properties of the composition. In various embodiments, where a composition is essentially free of a particular component, the component is present in less than a functional amount. In various embodiments, the component may be present in trace amounts. Particular limits will vary depending on the nature of the component, but may be, for example, selected from less than 10% by weight, less than 9% by weight, less than 8% by weight, less than 7% by weight, less than 6% by weight, less than 5% by weight, less than 4% by weight, less than 3% by weight, less than 2% by weight, less than 1% by weight, less than 0.5% by weight, less than 0.1% by weight, or less than 0.05% by weight, or less than 0.01% by weight.

As used herein, the term “a detectable amount” refers to an amount of a composition (e.g., a molecule) that can be detected using the most sensitive analytical techniques up to date, including for example, liquid chromatography methods (e.g., reverse phase HPLC, size exclusion, normal phase chromatography), mass spectrometry (e.g., electrospray tandem mass spectrometry, and electrospray FT-ICR mass spectrometry), or a combination of analytical techniques (e.g., liquid chromatography-tandem mass spectrometry (LC-MS/MS)). In some cases, a detectable amount is at a concentration above 10⁻² mol/L, 10⁻³ mol/L, 10⁻⁴ mol/L, 10⁻⁵ mol/L, 10⁻⁶ mol/L, 10⁻⁷ mol/L, 10^{'8} mol/L, 10⁻⁹ mol/L, or 10⁻¹⁰ mol/L.

As used herein, the term “dairy characteristic” means a characteristic selected from one of the following characteristics of a dairy food: adhesiveness, airiness, appearance, aroma, binding, chewdown, chewiness, coagulation, cohesiveness, compactness, creaminess, crispiness, crumbliness, density, elasticity, emulsification, fattiness, firmness, flavor, foaminess, graininess, greasiness, hardness, handling, juiciness, leavening, mouthcoating, mouthfeel, richness, roughness, slipperiness on tongue, smoothness, springiness, structure, taste, tenderness, texture, thickness, uniformity, and wetness.

As used herein, the term “dicot” refers to a flowering plant whose embryos have two seed leaves or cotyledons. Examples of dicots include Arabidopsis, tobacco, tomato, potato, sweet potato, cassava, alfalfa, lima bean, pea, chick pea, soybean, carrot, strawberry, lettuce, oak, maple, walnut, rose, mint, squash, daisy, quinoa, buckwheat, mung bean, cow pea, lentil, lupin, peanut, fava bean, French beans, mustard, or cactus.

As used herein, the term “casein micelle” refers to a micelle that is typically found in milk, formed by casein proteins. For example, a bovine casein micelle is typically found in bovine milk. Typically, a casein micelle has an outer layer comprising κ-casein proteins, and an interior comprising one or more casein proteins comprising one or more casein proteins comprising α_{S1}-casein, α_{S2}-casein, or β-casein, or any combination thereof.

As used herein, the term “glycelle” refers to a structure, having an exterior layer comprising κ-casein proteins, and an interior comprising a non-milk particle and one or more casein proteins comprising α_{S1}-casein, α_{S2}-casein, or β-casein, or any combination thereof. As used herein, a “non-milk particle” is a particle that is not normally found in bovine milk. Examples of particles that are normally found in bovine milk include α_{S1}-casein, α_{S2}-casein, β-casein, κ-casein, colloidal calcium phosphate (CCP), water, magnesium, citrate, and alkaline phosphatase. In some cases, the non-milk particle is a protein. In some cases, the non-milk particle is a soy protein, for example, soy globulin 7S (e.g., β-conglycinin) or 11S (e.g., glycinin). In some cases, the non-milk particle is inside the micellar core. In some cases, the non-milk particle is attached to the exterior layer. It is contemplated that glycelles can vary in size and in ratios of different molecules that comprise the glycelles. In some cases, a glycelle comprises more than 1000 α_{S1}-casein molecules, more than 1000 α_{S2}-casein molecules, more than 1000 β-casein molecules, more than 1000 κ-casein molecules, more than 1000 β-casein molecules, or more than 1000 glycinin molecules.

As used herein, the term “7S” refers to β-conglycinin (or one or more subunits of β-conglycinin), and/or any other member within the 7S globulin family of proteins, whether derived from soybean or other plant species. As used herein, the term “11S” denotes glycinin (or one or more subunits of glycinin), and/or any other member within the 11S globulin family of proteins, whether sourced from soybean or other plant species. In some cases, “11S” consists of glycinin In some cases, “7S” consists of β-conglycinin, small amounts of γ-conglycinin and basic 7S globulin (Bg7S). β-Conglycinin has three unique peptides, α, α′ and β, that associate as trimers. In some cases, “7S” refers to one or more subunits of β-conglycinin, for example α subunit, α′ subunit, β subunit, or any combination thereof, or in combination with β-conglycinin Glycinin is a hexameric protein composed of six similar subunits. In some cases, “11S” denotes one or more subunits of glycinin, or in combination of glycinin

As used herein, the term “homogenous” means of uniform structure or composition throughout.

As used herein, the term “in-vitro” means outside a living organism.

As used herein, the term “milk” means a liquid composition that contains soluble casein micelles or soluble glycelles or both and where the weight of soluble casein micelles and/or soluble glycelles is equal to or greater than 1% of the total protein weight in the composition. As used herein, the term “cheese curd” is a solid or semi-solid mass made by gelating, coagulating, or curdling milk. As used herein, the term “cheese” is a food made from cheese curds. As used herein, the term “milk solid” refers to the solid (e.g., a powder) that would be left after milk is dried out (i.e., water is removed from milk). In some cases, “milk solid” can comprise casein proteins (for example, α_{S1}-casein, α_{S2}-casein, β-casein, or κ-casein), whey proteins (e.g., β-lactoglobulin, α-lactalbumin, or serum albumin), as well as lactose, colloidal calcium phosphate (CCP), etc.

As used herein, the term “monocot” refers to a flowering plant whose embryos have one cotyledon or seed leaf. Examples of monocots include turf grass, maize (corn), rice, oat, wheat, barley, sorghum, orchid, iris, lily, onion, palm, and duckweed.

As used herein, the term “naturally occurring” means without genetic modification. For example, a naturally occurring ratio of two plant proteins means a ratio of the two plant proteins found in a plant (e.g., plant seed), where the plant is not genetically modified to manipulate the expression levels of the two proteins.

As used herein,“bioactive compound” is any substance that exerts a specific and non-trivial influence on biological systems by interacting with fundamental cellular or molecular components, where this influence is not merely nutritional, energetic, or immunogenic in nature. Non-limiting examples of bioactive compounds include aspirin, caffeine, tamoxifen, and penicillin. By contrast, non-limiting examples of non-bioactive compounds include cellulose, starch, simple sugars, water, glycinin, conglycinin, stachyose, and typical allergens like pollen proteins.

As used herein, the term “plant” includes whole plant, plant organ, plant tissues, and plant cell and progeny of same, but is not limited to angiosperms and gymnosperms such as Arabidopsis, potato, tomato, tobacco, alfalfa, Lamiaceae, carrot, strawberry, sugarbeet, cassava, sweet potato, soybean, lima bean, pea, chick pea, maize (corn), turf grass, wheat, rice, barley, sorghum, oat, oak, eucalyptus, walnut, palm and duckweed a well as fern and moss. Thus, a plant may be a monocot, a dicot, a vascular plant reproduced from spores such as fern or a nonvascular plant such as moss, liverwort, hornwort and algae. The term “plant,” as used herein, also encompasses plant cells, seeds, plant progeny, propagule whether generated sexually or asexually, and descendants of any of these, such as cuttings or seed. Plant cells include suspension cultures, callus, embryos, meristematic regions, callus tissue, leaves, roots, shoots, gametophytes, sporophytes, pollen, seeds and microspores. Plants may be at various stages of maturity and may be grown in liquid or solid culture, or in soil or suitable media in pots, greenhouses or fields. As used herein, the term “plant protein” refers to a protein that is at least 70% homologous to a protein that naturally occurs in a plant.

As used herein, the term “recombinant” refers to nucleic acids or proteins formed by laboratory methods of genetic recombination (e.g., molecular cloning) to bring together genetic material from multiple sources, creating sequences that would otherwise not be found in the genome. Recombinant proteins may be expressed in vivo in various types of host cells, including plant cells, bacterial cells, fungal cells, avian cells, and mammalian cells. Recombinant proteins may also be generated in vitro.

As used herein, the term “stably expressed” refers to expression and accumulation of a protein in a plant cell over time. As an example, a recombinant protein may accumulate because it is not degraded by endogenous plant proteases. As a further example, a recombinant protein is considered to be stably expressed in a plant if it is present in the plant in an amount of 1% or higher per total protein weight of soluble protein extractable from the plant.

As used herein, the term “transgenic plant” means a plant that has been transformed with one or more exogenous nucleic acids. “Transformation” refers to a process by which a nucleic acid is stably integrated into the genome of a plant cell. “Stably transformed” refers to the permanent, or non-transient, retention, expression, or a combination thereof of a polynucleotide in and by a cell genome. A stably integrated polynucleotide is one that is a fixture within a transformed cell genome and can be replicated and propagated through successive progeny of the cell or resultant transformed plant. Transformation can occur under natural or artificial conditions using various methods. Transformation can rely on any method for the insertion of nucleic acid sequences into a prokaryotic or eukaryotic host cell, including Agrobacterium-mediated transformation as illustrated in U.S. Pat. Nos. 5,159,135; 5,824,877; 5,591,616 and 6,384,301, all of which are incorporated herein by reference in its entirety. Methods for plant transformation also include microprojectile bombardment as illustrated in U.S. Pat. Nos. 5,015,580; 5,550,318; 5,538,880; 6,153,812; 6,160,208; 6,288,312 and 6,399,861, all of which are incorporated herein by reference in its entirety. Recipient cells for the plant transformation include meristem cells, callus, immature embryos, hypocotyls explants, cotyledon explants, leaf explants, and gametic cells such as microspores, pollen, sperm and egg cells, and any cell from which a fertile plant can be regenerated, as described in U.S. Pat. nos. 6,194,636; 6,232,526; 6,541,682 and 6,603,061 and U.S. Patent Application publication US 2004/0216189 A1, all of which are incorporated herein by reference in its entirety.

As used herein, the term “vector” means a plasmid comprising operably linked polynucleotide sequences that facilitate expression of a coding sequence in a particular host organism (e.g., a bacterial expression vector or a plant expression vector). Polynucleotide sequences that facilitate expression in prokaryotes can include, e.g., a promoter, an enhancer, an operator, and a ribosome binding site, often along with other sequences. Eukaryotic cells can use promoters, enhancers, termination and polyadenylation signals and other sequences that are generally different from those used by prokaryotes.

### BRIEF DESCRIPTION OF THE DRAWINGS

The patent or application file contains at least one drawing executed in color. Copies of this patent or patent application publication with color drawings will be provided by the Office upon request and payment of the necessary fee.

The figures showing embodiments of the system are semi-diagrammatic, and not to scale and, particularly, some of the dimensions are for the clarity of presentation and are shown exaggerated in the figures. Similarly, although the views in the figures for ease of description generally show similar orientations, this depiction in the figures is arbitrary for the most part. Generally, the invention can be operated in any orientation.

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1A is a flow chart showing a non-limiting example of making soymilk enriched with glycinin or conglycinin

FIG. 1B shows a flow chart showing a non-limiting example of making cheese using soy proteins.

FIG. 2 shows a Sodium Dodecyl Sulfate Polyacrylamide Gel Electrophoresis (SDS-PAGE) of enriched soy fractions.

FIG. 3 shows images of soy augmented cheese samples.

FIG. 4 is a SDS-PAGE showing the results from Example 3, where conglycinin subunits α and α′ are reduced in the final retentate while glycinin subunits A1,2,4 and B1,2,4 remain the same compared to soy dairy blend.

FIG. 5 shows the experimental result in Example 3, where curd was formed in final retentate but not in control.

FIG. 6 is a flow chart illustrating the process in Example 4A.

FIG. 7 shows SDS-PAGE of samples produced from the process described in Example 4A and shown in FIG. 6. Curd and whey samples from process derivatives analyzed. The SDS-PAGE result shows the reduction of conglycinin and glycinin subunits between the dairy and soy blend and the final retentate.

FIG. 8 is a flow chart illustrating the rennet process to form a curd used in Example 4A and 4B.

FIG. 9 shows a curd formed in skim milk (control) curd (left), curd of supernatant (center), and curd of final retentate (right).

FIG. 10 shows a flow chart illustrating the process in Example 4B.

FIG. 11 shows SDS-PAGE result of samples from Example 4B using Calcium chloride to coagulate proteins and fat in the dairy and soy blend, using the process described in FIG. 8.

FIG. 12 shows from left to right: curd of supernatant (L), curd of final retentate (R) produced in Example 4B, using the process described in FIG. 8.

FIG. 13 shows MgCl₂ concentrations at 20, 40, 60, 80, and 200 mM do not cause precipitation in skim milk.

FIG. 14 shows MgCl₂ concentrations at 20, 40, 60, 80, and 200 mM cause precipitation in soymilk, demonstrated by pellet formation after centrifugation and solution turning clear.

FIG. 15 shows MgCl₂ causes precipitation in a mixture of soymilk and skim milk, in a similar manner as in pure soymilk without skim milk, while the solutions do not decrease in opaqueness, suggesting only soy proteins are precipitated while milk proteins remain soluble.

FIG. 16 shows MgCl₂ concentrations at 400 mM, 800 mM, 1.2 M, 1.6 M, and 2.0 M cause precipitation in bovine skim milk.

FIG. 17 shows glycinin/conglycinin separation procedure used in Example 6, producing a glycinin fraction enriched with glycinin and a conglycinin enriched in conglycinin.

FIG. 18 shows the process of making cheese using soy fractionations in Example 6.

FIG. 19 shows the procedure used for making cheese in Example 6.

FIG. 20 shows cheese curds formation status for different fractions in Example 6.

FIG. 21 shows curd dry solids/casein ratio for different fractions in Example 6.

FIG. 22 shows the total solids of the curds were measured for each curd produced in Example 6.

FIG. 23 shows a summary of data in Example 6.

FIG. 24 shows curds made from glycinin enriched soy fractions at 9 g/L and 18 g/L mixed with milk.

FIG. 25 shows elasticity measurements for different curds in Example 6.

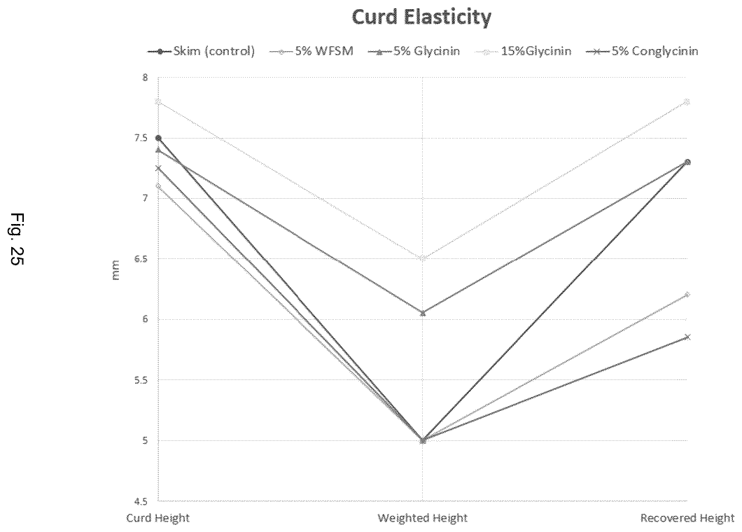

FIG. 26 shows curd elasticity % return to initial height for different curds in Example 6.

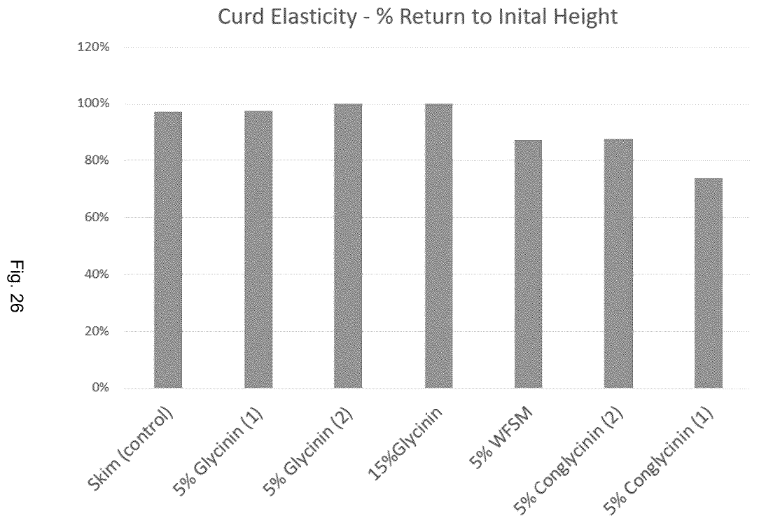

FIG. 27 shows meltability for different curds, initial and cooked, in Example 6.

FIG. 28 shows Mass Spectrometry data reflecting the extent of incorporation of κ-Casein, β-Casein, α_{S2}-Casein, and α_{S1}-Casein, as well as soy proteins into casein micelle structure, in Example 9.

FIG. 29 shows Mass Spectrometry data reflecting the extent of incorporation of casein proteins and soy proteins, in Example 9.

FIG. 30 shows additional Mass Spectrometry data reflecting the extent of incorporation of κ-Casein, β-Casein, α_{S2}-Casein, and α_{S1}-Casein, as well as soy proteins into casein micelle structure, in Example 9.

FIG. 31 shows additional Mass Spectrometry data reflecting the extent of incorporation of casein proteins and soy proteins, in Example 9.

FIG. 32 provides a visual representation of the mean values for each olfactory characteristic assessed in the study described in Example 11.

FIG. 33 shows Color Test photograph of experiment conducted to compare color of Glycelle-derived cheese with Micelle-derived cheese as described in Example 12.

FIGS. 34 and 35 show a graph of the dataset of the compounds inside the glycelle in the second and third sample (respectively) from Example 9, sorted by the GRAVY score on the Kyte-Doolittle Hydropathy Index.

FIG. 36 shows a violin plot summarizing data results from Atomic Force Microscopy (AFM) conducted on glycelle-derived cheese and micelle-derived cheese, as described in Example 13.

### EXAMPLES

The following examples and experiments are provided to further illustrate some embodiments of the present disclosure, but are not intended to limit the scope of the disclosure; it will be understood by their exemplary nature that other procedures, methodologies, or techniques known to those skilled in the art may alternatively be used.

### Example 1

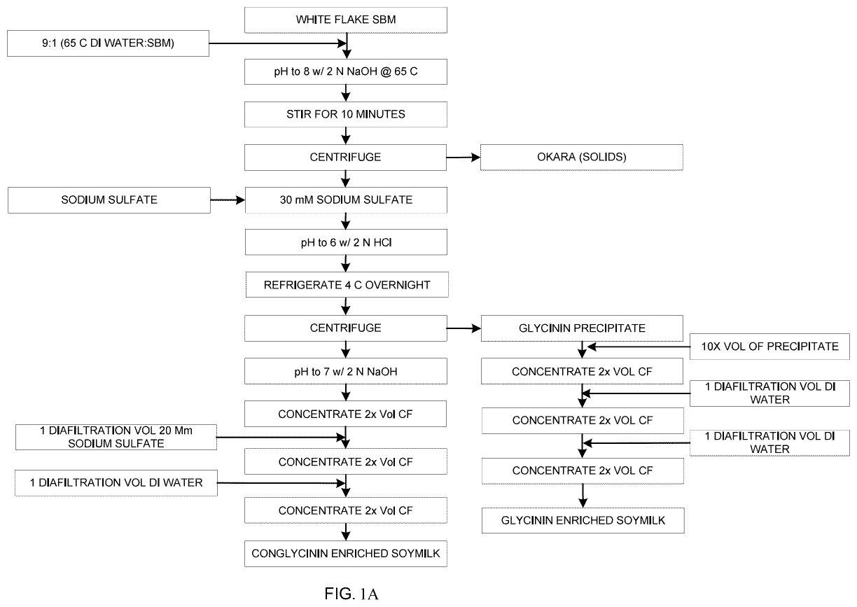

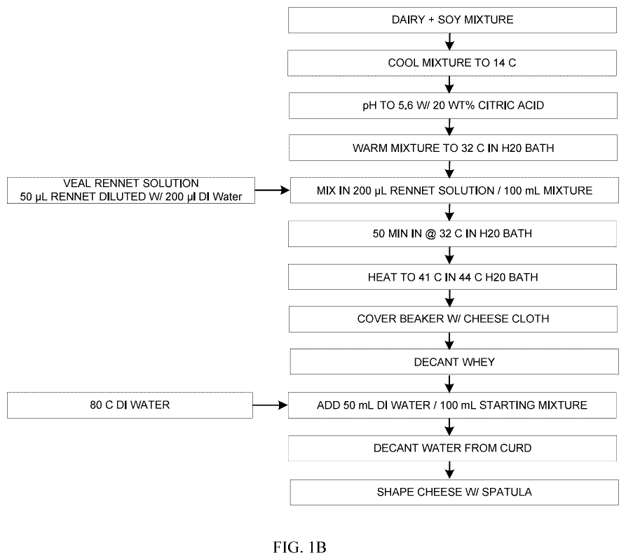

This non-limiting example shows adding soy proteins to milk or other compositions of casein micelles reduces the quality of casein micelle coagulation during the cheesemaking process. Increasing the ratio of glycinin to conglycinin in the soy protein enables a higher soy protein inclusion rate in curd-forming mixtures. The process is also illustrated in FIG. 1 (FIG. 1A and FIG. 1B).

Soymilk was produced from defatted soy white flakes with a high protein dispersibility index (PDI). The white flakes were mixed with warm, deionized (DI) water to produce a 10 wt % slurry. The pH was adjusted to pH of 8 with 2 N Sodium Hydroxide (NaOH). The slurry was mixed for 10 minutes to extract proteins, sugars, salts, and other materials from the white flake. The slurry was then centrifuged to separate the soluble soymilk (centrate) from the insoluble centrifuge cake (okara). This soymilk was the “standard” soymilk. The okara was discarded.

Sodium sulfate was added to the soymilk until the sodium sulfate concentration was 30 mM. The pH was adjusted down to 6.0 with 2 N Hydrochloric Acid (HCl). The combination of lower pH and salt addition precipitated a glycinin-rich protein fraction from the soymilk. The mixture was then refrigerated overnight.

The glycinin-rich precipitate was removed by centrifugation and set aside. The remaining centrate contained a majority of the conglycinin proteins and was labeled “CG” soymilk.

The glycinin-rich protein precipitate was resuspended in DI water and the pH was adjusted up to 7.5 using 2 N NaOH to produce “G” soymilk.

Homogenized, pasteurized skim milk was blended with one of three different soymilk types: “standard,” “CG,” or “G”. The soymilks were added at either a low or high dosage, where the low dosage was 9 grams of soy solids per liter of mixture and the high dosage was 18 grams per liter. In addition, a control sample was prepared with only skim milk and no soy protein added.

The blends of skim milk and soy proteins were then subjected to a typical rennet-based cheesemaking process (i.e., as described in example 8).

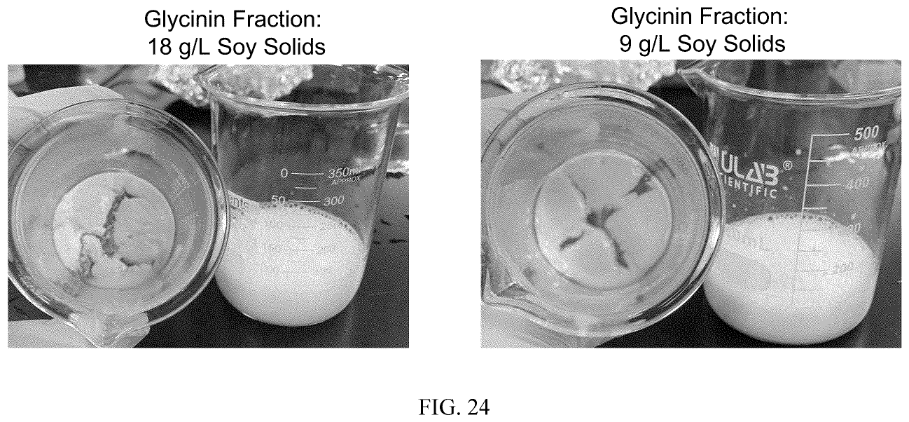

Of the seven blends tested, the only blends observed to produce a cheese curd were the control (no added soy) and both the low and high dosage “G” (glycinin-enriched) soymilk. Curds from the glycinin-enriched blends are depicted in FIG. 24. The “standard” and “CG” soymilks did not form curds.

### Example 2

In this non-limiting example, the major soy proteins, glycinin and β-conglycinin, were separated into two different fractions. One fraction was enriched in glycinin, and the second fraction enriched in β-conglycinin Milk was separately combined with the individual fractions as well as standard soymilk. The mixtures of soy and dairy milk were subjected to a rennet-based cheese process. At higher inclusions of soy, the milk augmented with the fraction enriched in glycinin produced a cheese curd, while the milks augmented with either conglycinin or standard soymilk did not.

In this experiment, soymilk was produced from defatted soy white flakes with a high protein dispersibility index (PDI). The white flakes were mixed with warm, deionized (DI) water to produce a 10 wt % slurry. The pH was adjusted to pH of 8 with 2 N Sodium Hydroxide (NaOH). The slurry was mixed for 10 minutes to extract proteins, sugars, salts, and other materials from the white flake. The slurry was then centrifuged to separate the soluble soymilk (centrate) from the insoluble centrifuge cake (okara). This soymilk is the “standard” soymilk. The okara was discarded.

Sodium sulfate was added to the soymilk until the sodium sulfate concentration was 30 mM. The pH was adjusted down to 6.0 with 2 N HCl. The combination of lower pH and salt addition precipitates the glycinin-rich protein fraction from the soymilk. The mixture was refrigerated overnight.

The glycinin-rich precipitate was removed by centrifugation and set aside. The remaining centrate contained a majority of the conglycinin proteins and was labeled as “CG” soymilk.

The glycinin-rich protein precipitate was resuspended in DI water and the pH was adjusted to 7.5 using 2 N NaOH to produce “G” soymilk.

The “G” soymilk was concentrated to a 2× concentration factor with a 100 kDa PVDF membrane in a benchtop tangential flow filtration system. The 100 kDa PVDF membrane was labeled “G membrane”. The permeate was discarded.

The concentrated “G” soymilk (retentate) was diluted with (1) volume of diafiltration DI water and concentrated to a 2× concentration factor with the G membrane. The permeate was again discarded.

The concentrated “G” soymilk (retentate) was diluted with (1) volume of diafiltration DI water and again concentrated to a 2× concentration factor with the G membrane. Diafiltration removed the dissolved proteins, sugars, minerals, and salts. The “G” soymilk was relabeled as “Washed G” and set aside. The permeate was again discarded.

With a clean, new 100 kDa PVDF membrane, the “CG” soymilk was concentrated to a 2× concentration factor using a benchtop tangential flow filtration system. This membrane was labeled “CG Membrane”.

The concentrated “CG” soymilk was washed with (1) volume of 20 mM sodium sulfate and re-concentrated to a 2× concentration factor with the CG membrane.

The concentrated “CG” soymilk was diluted with (1) volume of diafiltration DI water and concentrated to a 2× concentration factor with the CG membrane. The “CG” soymilk was relabeled as “Washed CG”.

The “Washed CG” and “standard” soymilk were diluted with DI water to the same total solids concentration as the “Washed G” soymilk.

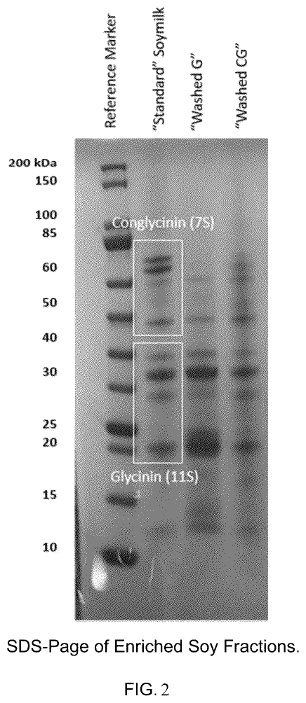

The individual protein fractions were analyzed with sodium dodecyl sulfate polyacrylamide gel electrophoresis (SDS-PAGE). The SDS-PAGE shows the conglycinin fraction depleted in glycinin, and the glycinin fraction depleted of conglycinin Protein levels were determined with a Millipore Bicinchoninic Acid (BCA) assay and each lane was dosed with 5 μg of protein. An image of the SDS-page described is presented in FIG. 2.

Homogenized, pasteurized skim milk was blended with one of three different soymilk types: “Standard,” “Washed CG,” or “Washed G”. The soymilks were added at a low and high dosage, where the low dosage was 4.5 grams of soy solids per liter of mixture and the high dosage was 13.5 grams per liter. A control sample was prepared with only skim milk and no soy protein added.

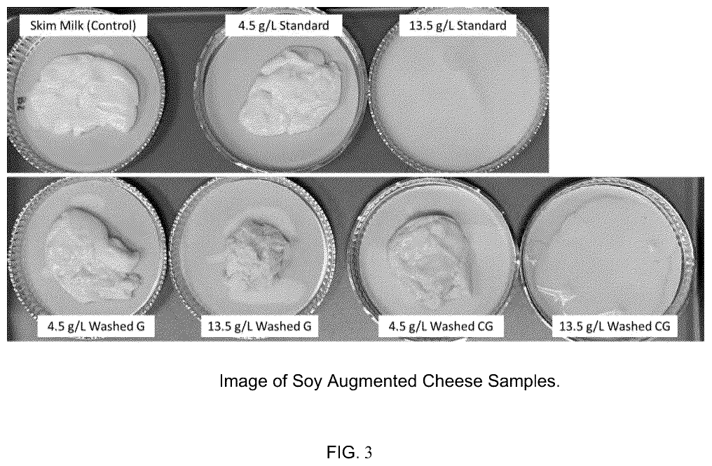

The blends of skim milk and soy proteins were then subjected to a rennet-based cheesemaking process. The mixture was coagulated for 50 minutes in a 37° C. water bath. The control and all samples with the low dose (4.5 g/L soy solids) produced a cheese curd. At the high dose, only the “Washed G” fraction produced a cheese curd. The high dose of “Standard” and “Washed CG” did not produce a cheese curd. An image of the cheese curds is presented in FIG. 3.

### Example 3

This is a non-limiting example demonstrating reducing conglycinin concentrations in soy/dairy blends improves curd quality when compared to soy/dairy blends with unaltered conglycinin: glycinin ratios. In this experiment, whole soymilk and bovine skim milk were combined and treated with a solution of calcium chloride to salt out soy proteins. The insoluble soy proteins were removed via centrifugation. The supernatant was concentrated and washed with a microfiltration (MF) membrane in a benchtop tangential flow filtration system to wash out and remove additional soy proteins while retaining casein micelles. The final retentate of the filtered soy and dairy blend was subjected to a rennet-based cheese making process. The soy/dairy blend control did not produce a curd while the filtered and washed retentate did make a curd.

In this experiment, soymilk was produced from defatted soy white flakes with a high protein dispersibility index (PDI). The white flakes were mixed with warm, deionized (DI) water to produce a 10 wt % slurry. The pH was not adjusted. The slurry was mixed for 10 minutes to extract proteins, sugars, salts, and other materials from the white flake. The slurry was centrifuged at 3200 g-force for 10 minutes to separate the soluble soymilk (centrate) from the insoluble centrifuge cake (okara). This soymilk is the “standard” soymilk. A sample of the “standard” soymilk was set aside for further analysis. The okara was discarded.

Ultra-High Temperature (UHT) pasteurized and homogenized bovine skim milk was combined with the “standard” soymilk at a volumetric ratio of 1:2 soymilk: skim milk. The pH of the soy/dairy blend was measured and recorded. This mixture was labeled as “soy/dairy blend”.

A solution of 200 g/L calcium chloride was made with warm DI water and solid calcium chloride.

The 200 g/L solution of calcium chloride was added to the soy dairy blend to achieve a 10 mM calcium chloride concentration. The pH was adjusted back to the soy/dairy blend's initial pH by adding 2 N sodium hydroxide. The calcium chloride addition and pH step was repeated twice. The final calcium chloride concentration of the solution was 30 mM. This material was called “30 mM soy/dairy blend”.

The 30 mM soy/dairy blend was heated to 50° C. on a hot plate while mixing with a stir bar. The solution was stirred for 10 minutes at 50° C.

The 30 mM soy/dairy blend was transferred to centrifuge bottles and centrifuged at 3200 g-force for 10 minutes. The supernatant was separated from the pellet of insoluble proteins. The supernatant was labeled “30 mM soy/dairy supernatant”.

The 30 mM soy dairy supernatant was concentrated to a 2× concentration factor with a 0.65 micron PES membrane in a benchtop tangential flow filtration system. The permeate was discarded.

The concentrated dairy soy blend (retentate) was diluted with (1) volume of diafiltration DI water and concentrated to a 2× concentration factor with the same 0.65 micron membrane. The permeate was again discarded.

The concentrated dairy soy blend (retentate) was diluted with (1) volume of diafiltration DI water and again concentrated to a 2× concentration factor with the 0.65 micron membrane. Diafiltration removed the dissolved proteins, sugars, minerals, and salts. The permeate was again discarded. The retentate was set aside and labeled as “Final Retentate”.

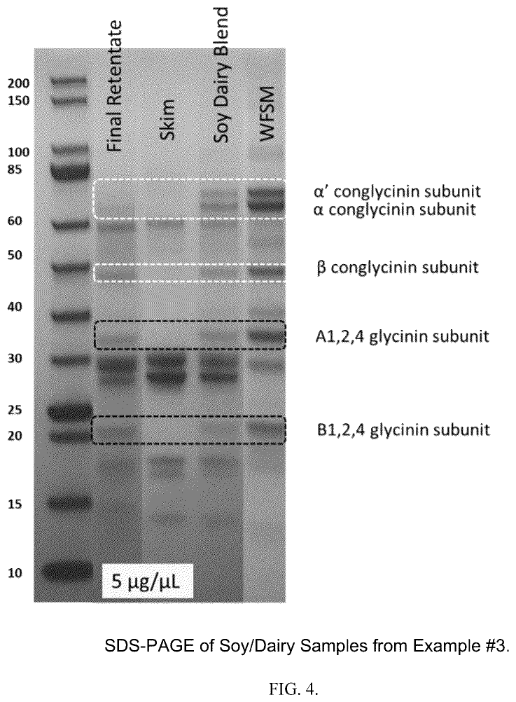

The individual protein fractions were analyzed with sodium dodecyl sulfate polyacrylamide gel electrophoresis (SDS PAGE). The SDS-PAGE of the final retentate shows conglycinin is reduced from the initial soy/dairy blend. The visible glycinin subunits A1,2,4 and B1,2,4 remain in the final retentate. Protein levels were determined with a Millipore Bicinchoninic Acid (BCA) assay and each lane was dosed with 5 μg of protein. An image of the SDS-page described is presented in FIG. 4.

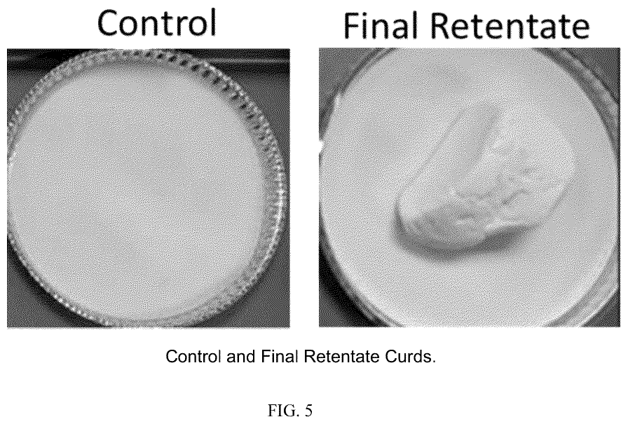

The final retentate and the initial soy/dairy blend (control) samples were subjected to a rennet-based cheesemaking process. The mixture was coagulated for 50 minutes in a 37° C. water bath. The control sample did not produce a rennet curd. The final retentate produced a rennet curd. An image of the cheese curds is presented in FIG. 5.

### Example 4A

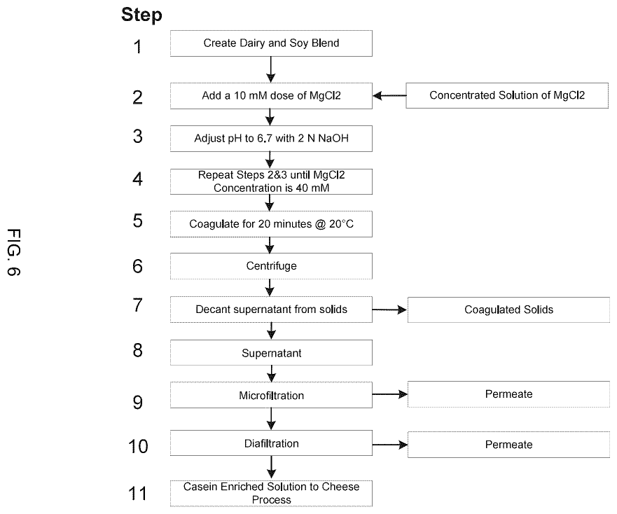

This non-limiting example shows soybean and casein micelles were separated as an example of the separation and purification process described herein. The example demonstrates native plant proteins can be selectively removed and casein micelles purified by first removing the soybean components through a coagulation process and purification in subsequent membrane filtration. The process carried out in Example 4A is illustrated in FIG. 6.

1. Full-fat soymilk was produced from whole soybeans (glycine max). The soybeans were first ground in a food processor to flour until a fine uniform distribution was produced. The soy flour was mixed with 65° C. deionized (DI) water to produce a 10 wt % slurry. The slurry was mixed for 10 minutes to extract proteins, sugars, salts, and other materials from the soybean. The slurry was then centrifuged to separate the soluble soymilk (centrate) from the insoluble centrifuge cake (okara). This soymilk is the “Full-Fat Soymilk”. The okara was discarded.

2. The full-fat soymilk was combined with bovine skim milk (homogenized and Ultra-high temperature (UHT) pasteurized) to produce a solution that contained equal parts casein protein and equal parts soy solids. The casein content of skim milk was assumed to be 27 g/L. A portion labeled “Dairy and soy Blend” was set aside for additional tests (SDS-PAGE, rennet process, moisture analysis, pH).

3. A 200 g/L concentrated solution of magnesium chloride was prepared by dissolving anhydrous magnesium chloride (MgCl₂, CAS No. 7786-30-3) in room-temperature DI water.

4. The dairy and soy blend was heated to 20C on a heated stir plate. After the solution reached 20° C., magnesium chloride was added to 10 mM magnesium chloride. The pH was adjusted back to 6.7 with 2 N NaOH. This process was repeated in 10 mM increments until the concentration reached 40 mM. The solution was held at 20° C. for 20 minutes after all the magnesium chloride was added to allow the proteins to coagulate.

5. The magnesium chloride treated dairy and soy blend was centrifuged for 10 minutes at 3700 rpm. The supernatant was decanted from the solids. The solids were weighed and the moisture content measured. An aliquot of supernatant was set aside for a rennet cheese process, SDS-PAGE, moisture measurement, and pH.

6. The supernatant was concentrated to a 2× concentration factor with a 0.65 micron polyethersulfone (PES) membrane in a benchtop tangential flow filtration system. The membrane was labeled 0.65 micron PES. The permeate was discarded.

7. The concentrated supernatant was washed with (1) volume of DI H₂O and reconcentrated to a 2× concentration factor with the 0.65 micron PES membrane.

8. The concentrated supernatant was again washed with (1) volume of DI H2O and reconcentrated to a 2× concentration factor with the 0.65 micron PES membrane.

9. The concentrated solution was diluted 2× with DI H₂O, labeled “final retentate” and set aside for rennet process, SDS-PAGE, moisture measurement, and pH.

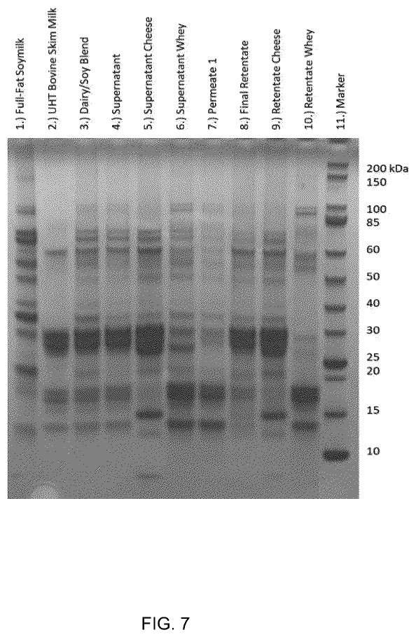

10. The individual protein fractions were analyzed with sodium dodecyl sulfate polyacrylamide gel electrophoresis (SDS-PAGE). The SDS-PAGE shows the final retentate has reduced levels of native soy proteins when compared with the initial dairy and soy blend. Protein levels were determined with a Millipore Bicinchoninic Acid (BCA) assay and each lane was dosed with 4 μg of protein. An image of the SDS-PAGE described is presented in FIG. 7. Final retentate has a reduced soy protein concentration compared to the supernatant, suggesting membrane filtration further removed soy proteins.

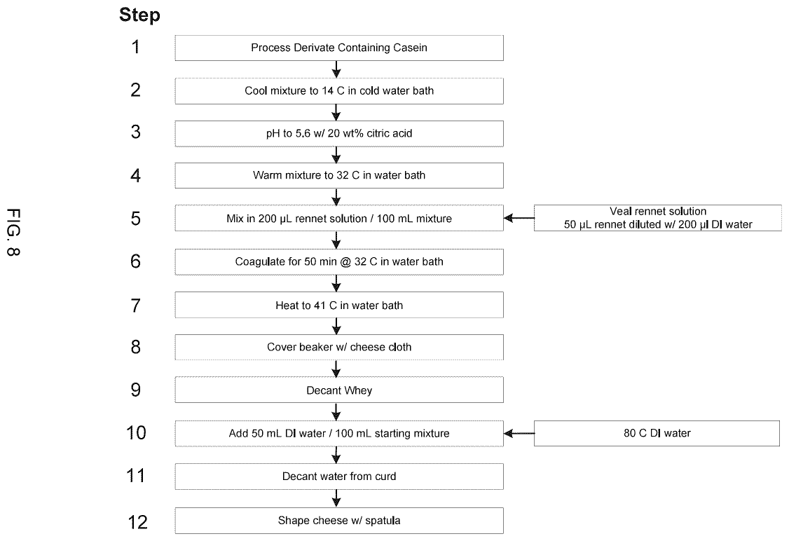

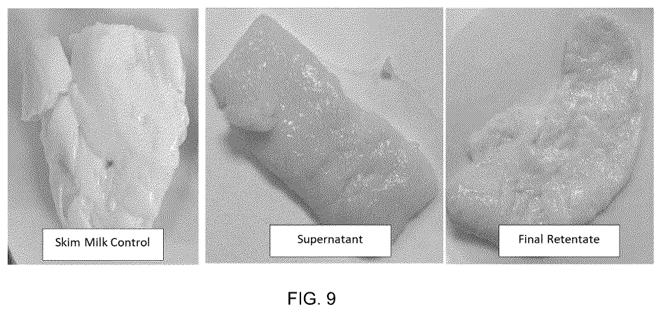

11. The final retentate, initial dairy and soy blend, supernatant, and skim milk were subjected to a rennet-based cheesemaking process. The mixtures were coagulated for 50 minutes at 32° C. The rennet process is described in FIG. 8. The initial dairy and soy blend did not produce a curd. The supernatant, final retentate, and skim milk produced a curd. An image of the curds is presented in FIG. 9. The final retentate curd was observed to have one or more improved dairy characteristics including, having a lower moisture content, better color (more white), and had better elasticity than the supernatant curd.

### Example 4B

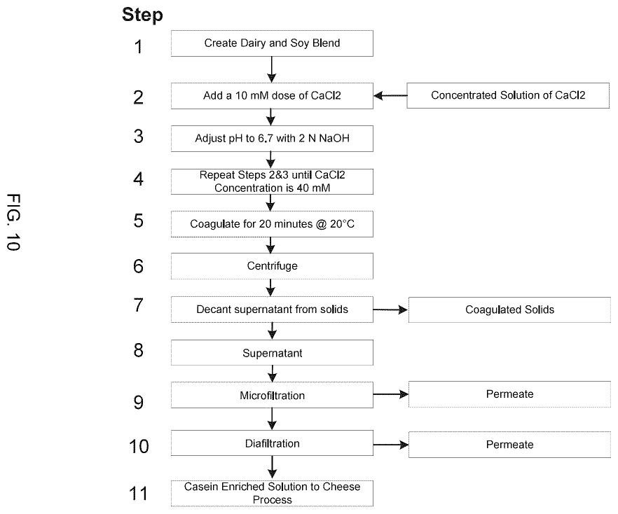

In this non-limiting example (illustrated in FIG. 10), which is an expansion of Example 4A, soy and casein proteins are separated using calcium chloride as the coagulant instead of magnesium chloride. Other coagulating agents can be used in the separation of recombinant proteins from plant materials.

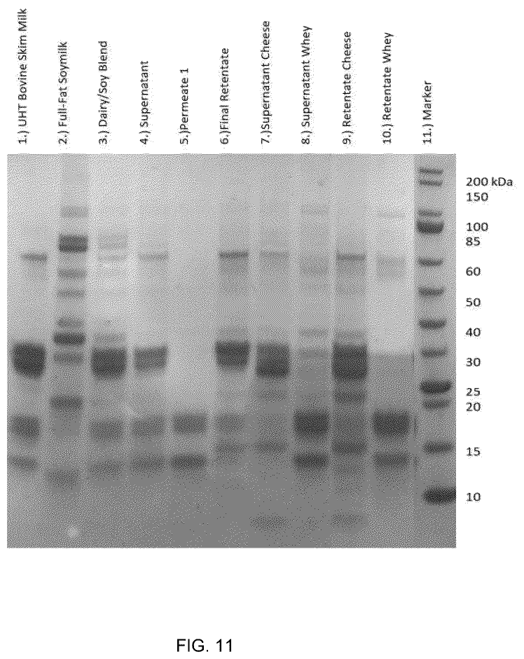

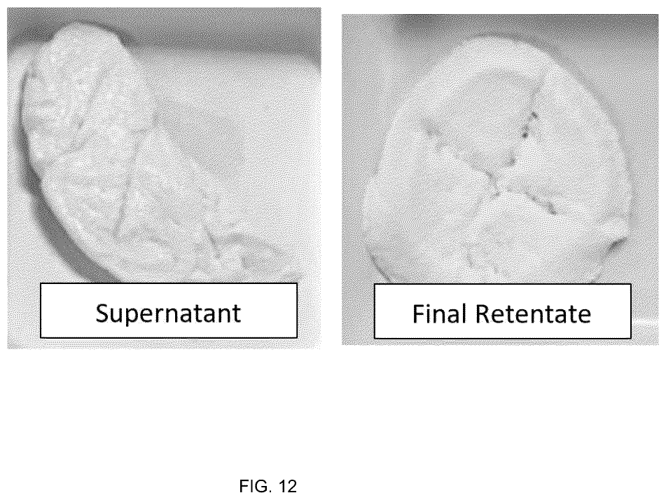

The same procedure executed in Example 1A was repeated except calcium chloride replaced magnesium chloride at the same 40 mM concentration. The results of Example 1B were similar to Example 1A. The SDS-PAGE (shown in FIG. 11) showed reduced conglycinin and glycinin in the supernatant and final retentate than the initial dairy and soy blend. The casein proteins became functional and formed a curd in a rennet process after the coagulation and membrane filtration processes. The curd produced in the rennet process possessed similar characteristics to that of cheese made from calcium fortified skim milk. The micelles were functional and did form a curd with higher moisture, reduced meltability, and limited elasticity compared to a skim milk control curd, as shown in FIG. 12.

### Example 5

In this non-limiting example, bovine skim milk, whole soymilk, and a dairy and soy blend, were each treated with different concentrations of magnesium chloride and then centrifuged.

1. In this experiment, full-fat soymilk was produced from whole soybeans (glycine max). The soybeans were first ground in a food processor until a fine flour was produced. The soy flour was mixed with 65° C. deionized (DI) water to produce a 10 wt % slurry. The slurry was mixed for 10 minutes to extract proteins, sugars, salts, and other materials from the soybeans. The slurry was then centrifuged to separate the soluble soymilk (centrate) from the insoluble centrifuge cake (okara). This soymilk is the whole soymilk. The okara was discarded.

2. The full-fat soymilk was combined with bovine skim milk (homogenized and Ultra-high temperature (UHT) pasteurized) to produce a solution that contained equal parts casein protein and equal parts soy solids (47 vol % soymilk, 53 vol % skim milk). The casein content of skim milk was assumed to be 27 g/L.

3. A concentrated salt solution was prepared with the anhydrous forms of magnesium chloride. The liquid coagulating agent was prepared to a concentration of 200 g/L by dissolving the salt in room-temperature DI water.

4. The soymilk, skim milk, and dairy and soy blend samples were each split into two beakers (six total). One of the two beakers was kept at room temperature (20° C.), while the other beaker was heated to 50° C. A 50 mL control sample was taken when the solutions reached 50° C. The salt solutions were added in 10 mM increments and the pH was adjusted to 6.7 with 2 N NaOH. This process was repeated until the salt concentration reached 200 mM. A 50 mL sample was taken at 20, 40, 60, 80, and 200 mM and labeled according to the salt concentration and sample type.

5. The 50 mL samples were centrifuged for 10 minutes at 3700 RPM. The gradient of samples were photographed. The supernatant was decanted from the solids. The solids were removed from the conical tubes with DI water and dried in an oven. The weight of the dry solids was measured and recorded. The ratio of (gram precipitated solids)/(starting solution volume) was compared between samples.

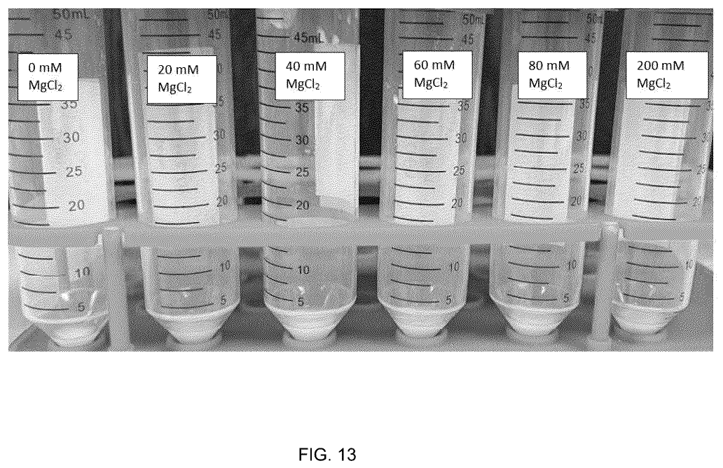

a. Skim milk: MgCl₂ concentrations 20, 40, 60, 80 and 200 mM did not cause precipitation noticeably different than the control (skim milk without magnesium chloride). The solutions at all concentrations of magnesium chloride remain opaque, and there is no pellet formation after centrifugation (as shown in FIG. 13).

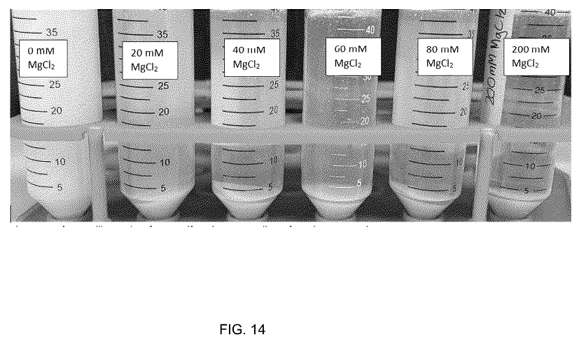

b. Soymilk: MgCl₂ treatment changed the color of soymilk samples from opaque to a yellow-tinted transparent fluid, and produced solid pellets after centrifugation. Magnesium chloride at concentrations 60, 80 and 200 mM did not further increase the amount of precipitated solids or decrease the opaqueness of the solutions, compared to 40 mM MgCl₂, as shown in FIG. 14.

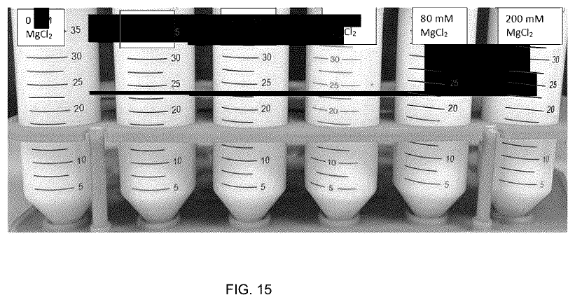

c. Skim milk and soymilk mixture: MgCl₂ treatment caused precipitation in a mixture of soymilk and skim milk, in a similar manner as in soymilk alone, but did not decrease the opaqueness of the solutions (as shown in FIG. 15), suggesting only soy components were precipitated while milk components remained soluble. A separate analysis of the weight of precipitated solids confirmed that the dry precipitated solids in skim milk and soymilk mixture is comparable to the amount of precipitated solids that would have precipitated from pure soymilk without skim milk (data not shown).

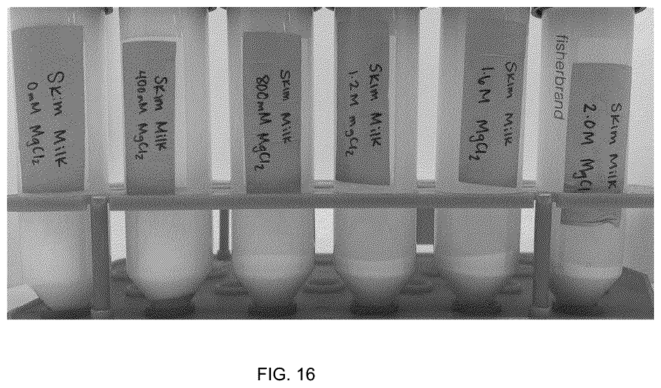

MgCl₂ at concentrations higher than 0.4 M caused precipitation in bovine skim milk. In this experiment, MgCl₂ was added in incremental doses to bovine skim milk while maintaining pH at 6.7 with 2 N NaOH. Magnesium chloride was added until the salt concentration reached 2.0 M. A 50 mL sample was taken at 0, 0.4, 0.8, 1.2, 1.6, and 2.0 M MgCl₂ and labeled according to the salt concentrations. The samples were held at 50° C. for 20 minutes and centrifuged for 10 minutes at 3700 RPM. Casein began precipitating at 0.4 M MgCl₂ and was nearly precipitated by 800 mM MgCl₂. This was evidenced by the reduction of turbidity and the consistent volume of the centrifuged pellet beyond 0.8 M, as shown in FIG. 16.

### Example 6

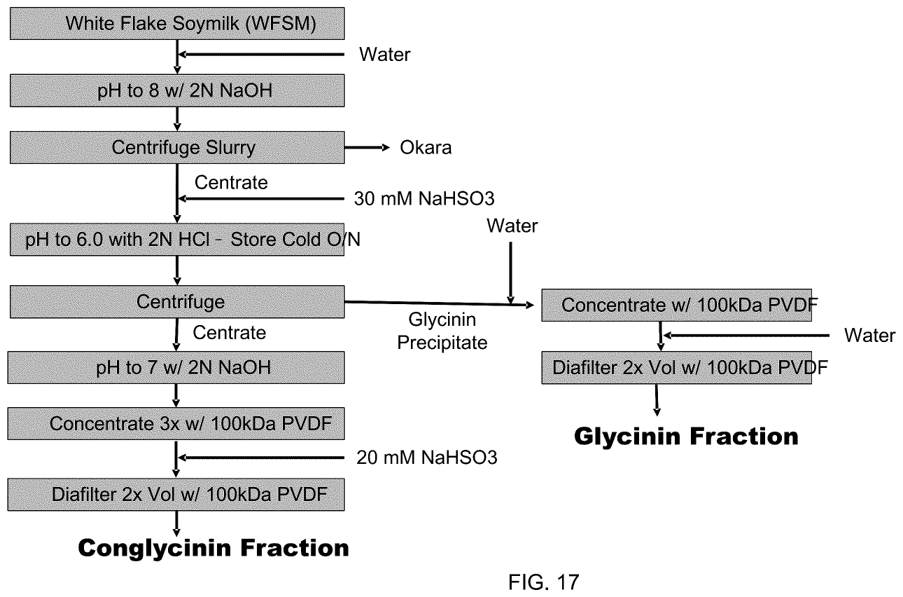

In this example, the effect of adding glycinin or conglycinin on curd formation of milk proteins is compared. Skim milk is used as positive control. The procedure is described in FIGS. 17-19. White Flake Soymilk (WFSM) is fractioned into a glycinin fraction and conglycinin fraction as shown in FIG. 17.

### Soymilk Procedure:

1. Measure 100 g of dry ZFS Creston white flakes into a 1,000 mL beaker. Record actual weight and measured moisture.

2. Add 900 mL water to a separate (empty) beaker. Heat water to 65° C. Targeting slurry total solids of 10%.

3. Adjust the pH to >8 using 2 N NaOH. Agitate on a stir plate for 10 minutes.

4. Centrifuge slurry for 10 minutes. Decant centrate from pellet. Save centrate and discard the okara fraction (pellet).

5. Prior to use, centrifuge decanted soymilk for 5 minutes. Decant soymilk from pellet. Record volume/mass of centrate.

### Glycinin Separation

6. Add solid sodium bisulfate to achieve a concentration of 30 mM 502. Adjust the pH to 6.0 with 2 N HCl.This should cause the glycinin fraction to “salt-out”.

7. Centrifuge mixture for 10 minutes. Decant centrate from pellet.

8. Combine pellets of glycinin and redissolve with water at ^{˜}10× the volume of the pellet. Adjust pH to 7.5 with 2 N Na0H. Record volume of pellet, water added, and final pH.

9. Set-up TFF System with a 100 kDa Synder PVDF membrane.

10. Record volume and TS of starting material

11. Concentrate mixture to about 3× concentration factor (ex. 500 ml→167 mL) with the membrane pressure at 5 psig and room temperature.

12. Dilute back to starting volume with water.

13. Save mixture for cheese test. This is the glycinin fraction, which is enriched with glycinin and depleted in conglycinin.

Conglycinin Separation: Adjust the pH of the supernatant of the last centrifugation step to 7.0 using 2 N NaOH.

14. Prepare a solution (about 500 mL) of 20 mM Sodium Bisulfite.

15. Set-up TFF System with a 100 kDa Synder PVDF membrane.

16. Concentrate mixture to about 3× concentration factor (ex. 500 ml→167 mL) with the membrane pressure at 5 psig and room temperature.

17. Dilute back to starting volume with water.

18. Concentrate diluted mixture to a ^{˜}3× concentration factor with same membrane and filtration conditions.

19. Save mixture for cheese test. This is the conglycinin fraction, which is enriched in conglycinin and depleted in glycinin.

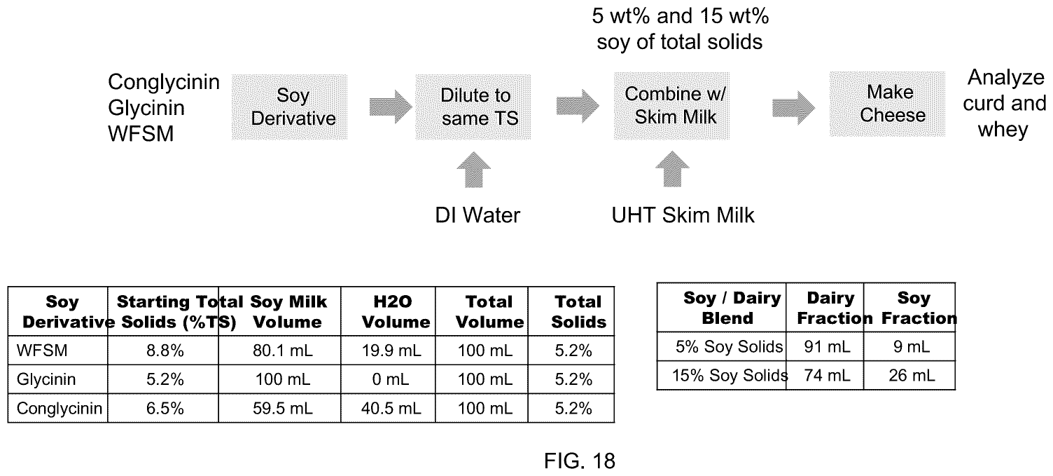

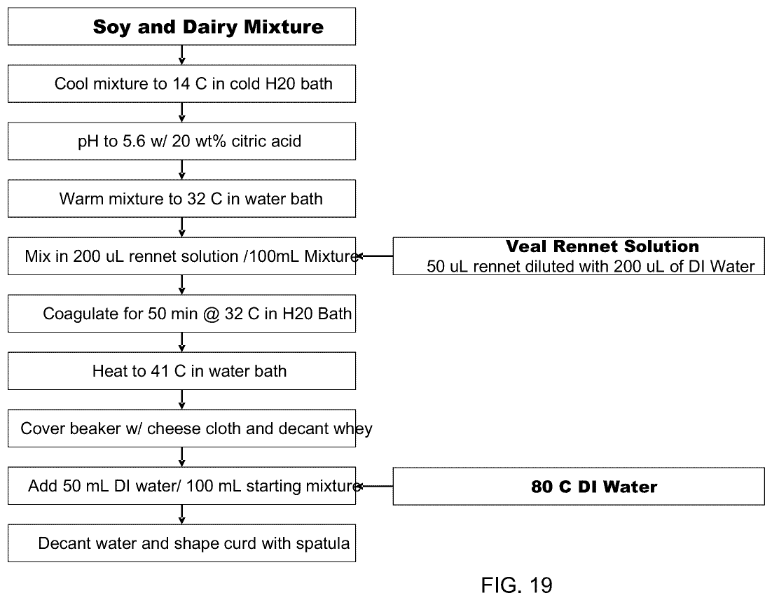

The WFSM, glycinin fraction and conglycinin fraction were each subject to the process of making cheese as shown in FIG. 18 and FIG. 19.

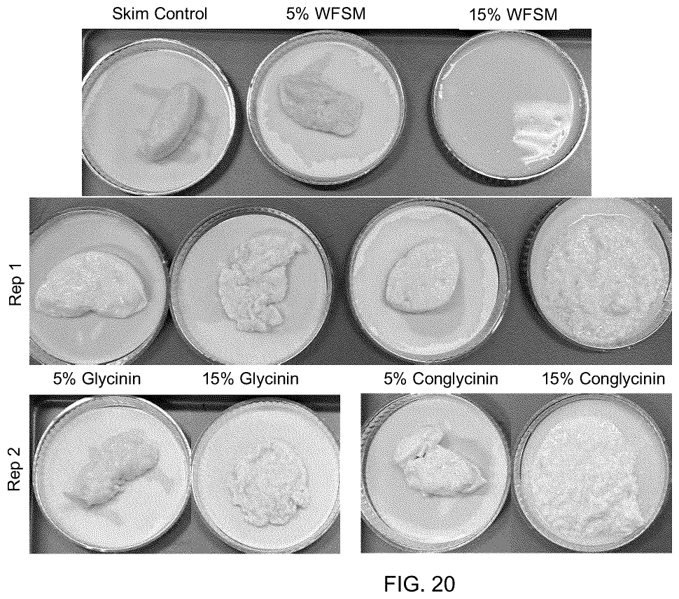

Results: As shown in FIG. 20, Skim control (100% milk solids from skim milk) formed a curd as did 5% WFSM (White Flake Soymilk 5% weight+95% weight milk solids). However, 15% WFSM (white flake soymilk solids 15% weight+85% weight milk solids) did not form a curd. Both 5% glycinin (glycinin 5% weight+95% weigh milk solids) and 15% glycinin (glycinin 15% weight+85% weigh milk solids) formed curds.5% conglycinin (conglycinin 5% weight+95% weigh milk solids) formed a loose curd, and 15% conglycinin (conglycinin 15% weight+85% weigh milk solids) formed loose solids (i.e., poor coagulation). In all cases, the glycinin curds had at least one improved dairy characteristic as compared to conglycinin and WFSM blends. However, conglycinin enriched curds still had at least one improved dairy characteristic as compared to similar soy/milk ratios in WFSM which failed to form even loose curds at 15% soy solids.

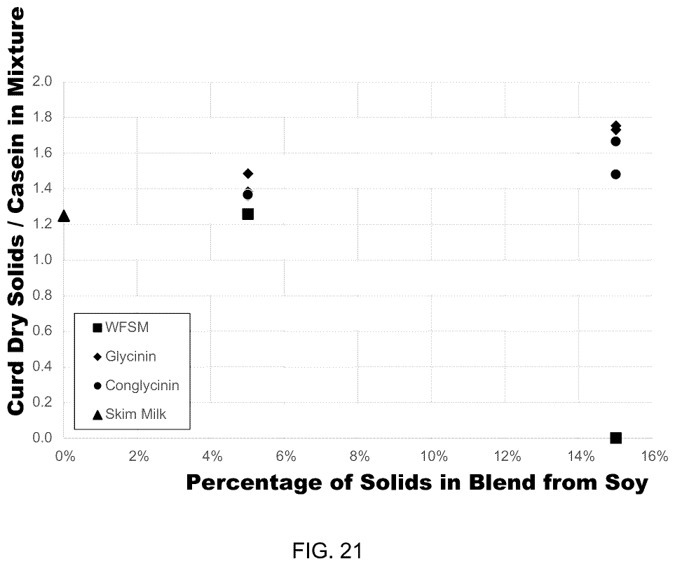

FIG. 21 shows curd yield for different fractions. Replacing some casein protein with soy protein increased the curd protein yield compared to casein protein alone. A less expensive protein (soy) can replace a more expensive (dairy) protein and produce a cheese curd with higher yields on the input casein. At 5% weight (95% milk solids), glycinin has the highest curd dry solids/casein ratio, followed by conglycinin, while WSFM has the lowest curd dry solids/casein ratio. At 15% weight (85% milk solids), glycinin has the highest curd dry solids/casein ratio, followed by conglycinin which does not form solid curds, while WSFM failed to form any curd.

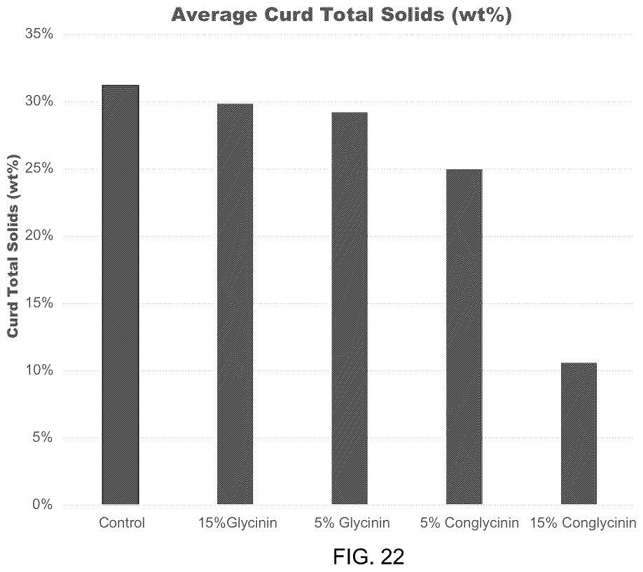

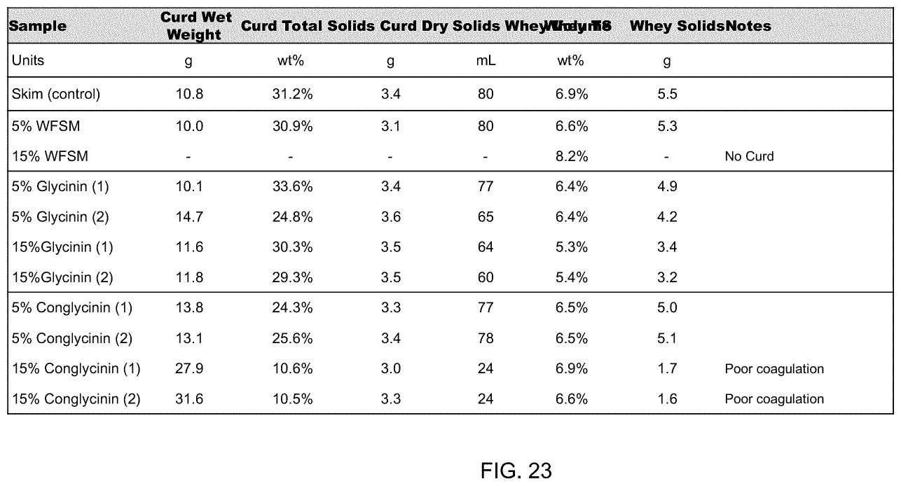

FIG. 22 shows the total solids of the curds were measured for each curd produced in the experiment. The average total solids of curds made from glycinin/dairy blends were higher than conglycinin/dairy blends. A summary of data is shown in FIG. 23.

Elasticity of the curds was tested using the following procedure.

1. Cheese plugs were cut from whole cheese curds using a 6.9 mm cork borer

2. Cheese plug dimensions were measured with calipers and recorded. Adjustments were made by cutting the cheese plugs with a razor blade if needed

3. Plugs were placed flatly in glass test tubes

4. The height of the cheese plugs in the test tubes were recorded

5. A 10 g weight was dropped onto the cheese in each test tube

6. The depressed height of the cheese curd was recorded

7. The weight was removed and the new height of the cheese in the test tube was recorded

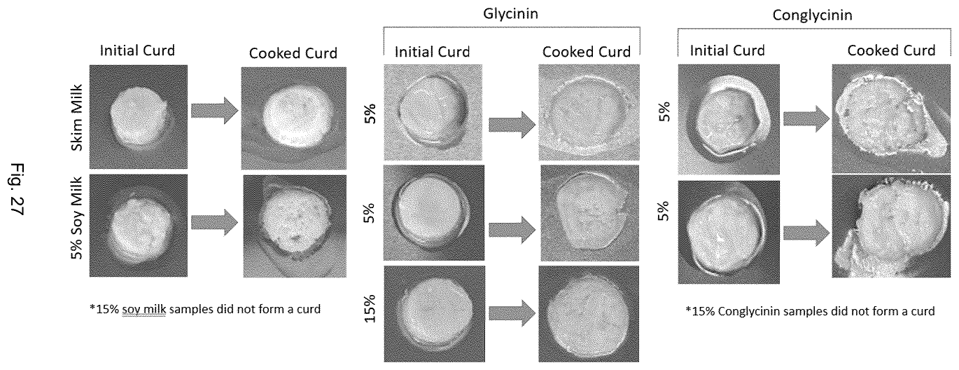

FIG. 27 shows curd elasticity measurements. Curd height, weighted height, and recovered height were measured for each curd. Glycinin curds had the closest elasticity to skim milk. Glycinin curds were firmer than the skim control, soymilk (also “WFSM”), and conglycinin curds. Skim milk curds had the largest change in height but recovered to nearly the same initial measurement. Conglycinin curds had poor elastic properties.

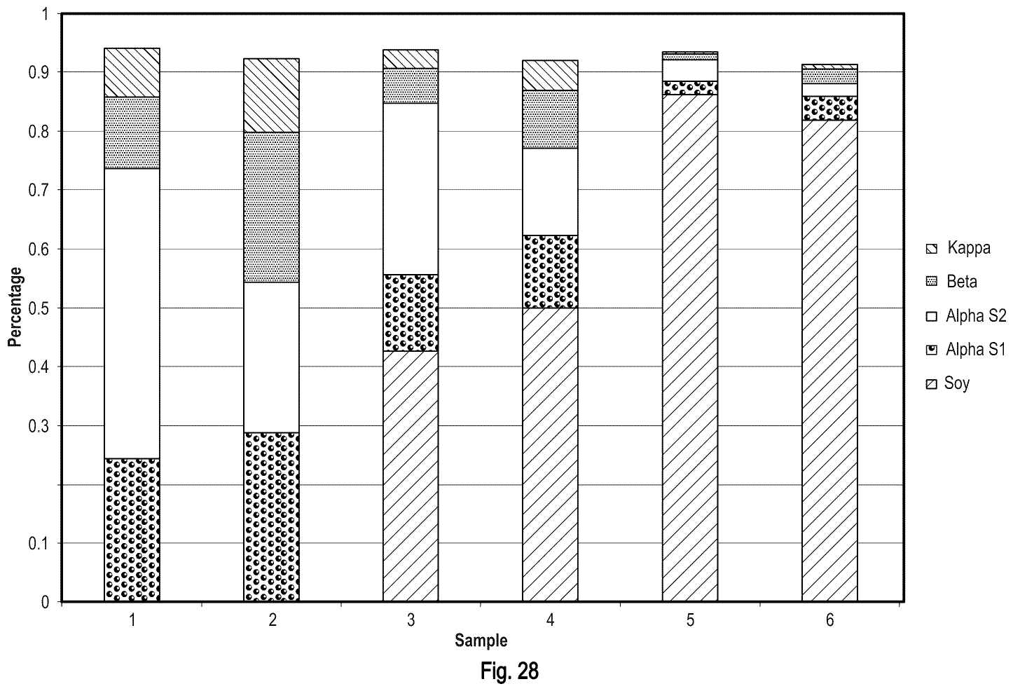

FIG. 28 shows Curd Elasticity % Return to Initial Height. The glycinin curds' elasticity was closest to the control (skim) curd. The elasticity of the conglycinin and soymilk curds was reduced from the control.

Meltability of the curds was tested using the following procedure.

1. Cheese disks were cut from whole curds with a 19.3 mm metal whole punch

2. Cheese disk dimensions were measured with calipers and recorded. Adjustments were made by cutting the cheese disks with a razor blade if needed

3. 100 uL of vegetable oil was placed directly on the aluminum pan near the center. Cheese disks were placed on top of the oil, and another 100 uL of vegetable oil was deposited on top of the cheese disk

4. Once oiled, samples were placed in the oven at 90 C for 5 minutes.

5. Samples were allowed to cool for 30 minutes at room temperature before remeasuring

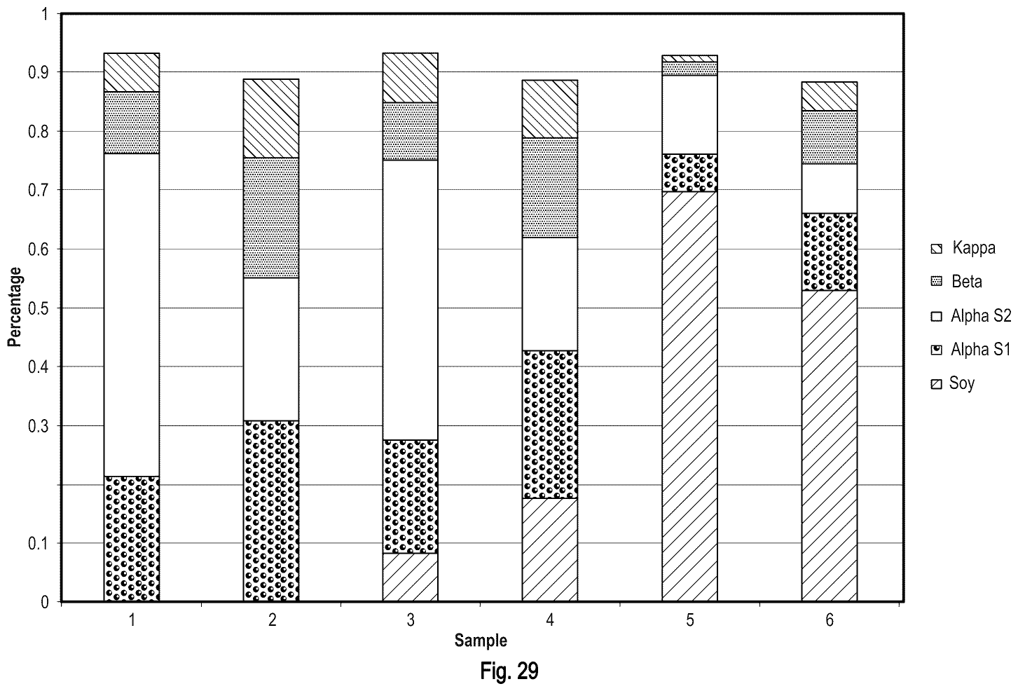

FIG. 29 shows cheese meltability. The observed stretchability of the curds containing soy was less than the skim control curd. The conglycinin's stretchability was impacted more so than the other soy containing curds.

### Example 7

### In-vitro Micelle Formation (Milk Making from Individual Casein Proteins)

Dissolve 0.324 g potassium citrate tribasic in 1.5 mL water to obtain tripotassium citrate.

Dissolve 0.383 g K₂HPO₄ in 11 mL water to obtain potassium phosphate.

Dissolve 0.470 g CaCl₂-2H₂0 in 15 mL of water to obtain calcium chloride.

Extract individual casein proteins from source organism or acquire purified caseins from sigma aldrich.

Dissolve casein proteins in water to a concentration of 50 mg/mL to obtain casein water (or casein-containing water).

Add 1 mL of casein-containing water to a 5 mL beaker.

Add a mini stir bar.

Place the 5 mL beaker inside of a 600 mL beaker on a hot plate containing approximately 125 mL of water. Submerge the 5 mL beaker about a third of its height, using a clamping system.

Make sure the 5 mL beaker is not touching the bottom or the sides of the 600 mL beaker.

Place a thermometer in the outer water, ensuring the bulb is not touching the glass but fully submerged in the water.

After all the casein is dissolved, set the hotplate to approximately around 65° C. Adjust as necessary to maintain a water temperature of 37° C.

Aim to reach a water temperature to 37° C. quickly to minimize evaporation.

Frequently check the temperature indicated on the thermometer.

Set the stirring to 1,000 RPM

Add the following:
20 μL tripotassium citrate,
70 μL potassium phosphate.

Wait 4 minutes.

Then, every 4 minutes, add the following 12 times:
12.5 μL potassium phosphate solution
25 μL calcium chloride solution

Let stir with the temperature at 37° C. for 1 hour.

Turn off the heat.

Add the following:
240 μL water,
180 μL heavy cream.

The resulting composition will contain casein in micellar form.

### Example 8

### Cheese Making

Any process for cheese making will be sufficient to make cheese from milk. Milk is heated in a large pot to 85-100° C. and then cooled down to around 33-38° C. Lactic acid bacteria is added to the milk. Once the milk has reached the desired acidity level, rennet is added. The milk will coagulate and form curds. The curds are then cut into small pieces and heated again, which releases additional whey. The curds are kneaded and stretched until they form a smooth, elastic texture.

### Example 9

### Glycelle Formation

Objective: To investigate the formation and composition of Glycelles Materials:
a. Purified Caseins (Sigma-Aldrich): α_{S1}-casein and α_{S2}-casein, β-casein, and κ-casein
b. Deionized (DI) water—1 L
c. Soy extract—10 mL
d. Cross-linking/fixing agent (Glutaraldehyde)
e. Filtration system equipped with 100 kDa filters
f. Mass spectrometer
g. Salts: Potassium citrate, Potassium phosphate and Calcium chloride
h. Liquid Nitrogen (LN₂)

Sample Identification Key:
a. Sample 1: Micelles formed in DI Water, without crosslinking, incubated with DI Water
b. Sample 2: Micelles formed in DI Water, crosslinked, incubated with DI Water
c. Sample 3: Micelles formed in DI Water, without crosslinking, incubated with filtered soy lysate
d. Sample 4: Micelles formed in DI Water, crosslinked, incubated with filtered soy lysate
e. Sample 5: Micelles formed in soy lysate, without crosslinking, incubated with filtered soy lysate
f. Sample 6: Micelles formed in soy lysate, crosslinked, incubated with filtered soy lysate

Procedure:
a. Remove approximately 20 soybeans (approximately 2000 mg) from pods and immediately freeze them with liquid nitrogen (LN₂)
b. Grind frozen soybeans into a fine powder
c. Extract soybean protein with DI water at a ratio of 1 mg of tissue to 1 μl of DI water for 30 mins boiling at 95° C.
   i. 12 g of soybeans was extracted with 12 mls of DI water
d. Dissolve the sigma caseins at the ratios below (vortexing vigorously after the addition of each casein) in the following solutions: 4 mL DI water and 2 mL soy lysate
   i. α casein (including α_{S1}-casein and α_{S2}-casein): 14.6 mg/mL
   ii. β-casein: 8.3 mg/mL
   iii. κ-casein: 2.65 mg/mL
e. Adjust the pH of the solutions to 6.9.
f. Incubate the solutions at 37° C. with shaking (225 rpm) for 5 mins.
g. Add the following salts to the solutions at the ratios below and incubate at 37° C. shaking for 4 mins:
   i. tripotassium citrate (216 mg/mL): 10 μL/mL of solution
   ii. potassium phosphate (35 mg/mL): 35 μL/mL of solution
h. Afterwards, add the following salts to the solutions at the ratios below and incubate at 37° C. shaking for 4 mins.
   i. potassium phosphate (35 mg/mL): 6.25 μL/mL of solution
   ii. calcium chloride (31 mg/mL): 12.5 μL/mL of solution
i. Repeat steps f through h 11 more times (12 total additions of the salts) keeping the solutions incubation at 37° C. shaking
j. Centrifuge the solutions at 1000 g for 5 mins to pellet the aggregates.
k. Transfer supernatant to a 100 kDa filter and centrifuge at 13000 g for 20 mins to separate micelles from monomeric caseins
l. Resuspend the retentate with DI water to their initial volumes and transfer the solutions into the following 2 mL tubes:
   i. Tube 1: 2 mL of DI micelle
   ii. Tube 2: 2 mL of DI micelle+glutaraldehyde
      1. Tubes 1+2 are aliquoted from the 4 mL of micelles made in DI water
   iii. Tube 3: 1 mL of soy micelle
   iv. Tube 4: 1 mL of soy micelle +glutaraldehyde
      1. Tubes 3+4 are aliquoted from the 2 mL of micelles made in soy lysate
m. To Tubes 2 and 4, add glutaraldehyde to a final concentration of 0.1% (v/v)
n. Incubate tubes at 4° C. rotating for 1 hour
o. To Tubes 2 and 4, add glycine powder to a final concentration of 500 mM (37.5 mg/mL)
p. Aliquot the tubes into 2 mL tubes with the following labels:
   i. Sample 1:500 μL of Tube 1
   ii. Sample 2: 500 μL of Tube 2
   iii. Sample 3: 500 μL of Tube 1
   iv. Sample 4: 500 μL of Tube 2
   v. Sample 5: 500 μL of Tube 3
   vi. Sample 6: 500 μL of Tube 4
q. Transfer samples to a 100 kDa filter and centrifuge at 13000 g for 20 mins
r. Additionally, filter the remaining soy lysate through a 100 kDa filter centrifuging at 13000 g for 25 mins
   i. Use the flow through (FT) for resuspension and incubation step below
s. Resuspend the retentate of the samples back to the initial volume with DI water or FT soy lysate and transfer to a new 2 mL tube
   i. Sample 1: DI water
   ii. Sample 2: DI water
   iii. Sample 3: FT soy lysate
   iv. Sample 4: FT soy lysate
   v. Sample 5: FT soy lysate
   vi. Sample 6: FT soy lysate
t. Incubate the samples at 4C rotating for 1 hour
u. Transfer samples to a new 100 kDa filter and centrifuge at 13000 g for 5 mins
v. Discard the flow through and resuspend the retentate with DI water up to 500 μL
w. Centrifuge at 13000 g for 5 mins
x. Discard the flow through and resuspend the retentate with DI water up to 500 μL
y. Repeat steps u-v one more time for a total of 2 washes
z. Resuspend the retentate with 500 μL of DI water back to 500 μL total and transfer to a new 2 mL tube
aa. Subject the samples to Liquid Chromatography-Mass Spectrometry (LC-MS) for analysis, where the samples will be digested with enzymes such as trypsin.

This experiment examines whether soy proteins are incorporated into the casein micelle structure, forming glycelles. This was achieved by examining two sets of two key samples: Sample 3 (micelles formed in deionized water, without crosslinking, and incubated with filtered soy lysate) and Sample 5 (micelles formed in soy lysate, without crosslinking, and incubated with filtered soy lysate); as well as Sample 4 (micelles formed in deionized water, glutaraldehyde crosslinking, and incubated with filtered soy lysate) and Sample 6 (micelles formed in soy lysate, glutaraldehyde crosslinking, and incubated with filtered soy lysate)

The baseline presence of soy proteins in Sample 3 was deducted from the soy presence in Sample 5. Similarly the baseline presence of soy proteins in Sample 4 was deducted from the soy presence in Sample 6. The resultant ratio is interpreted as the relative amount of soy protein incorporated into the micelle structure, rather than the basal amount that adheres to the micelle's exterior. This differentiation between mere adherence and genuine incorporation in the core is central to the analysis.

By comparing the relative abundance of soy particles in Sample 6 with the baseline presence in Sample 4, we isolated the effect of forming micelles in the presence of soy particles (as in Sample 5) from the mere adherence or loose association (as in Sample 3). Should the soy proteins have only been adhering to the exterior of the micelles, the mass spectrometry data would have exhibited similarity between Samples 4 and 6.

However, our results indicated a large enrichment increase in soy particles in Sample 6 as compared to Sample 4. This discrepancy provides compelling evidence that soy proteins are being incorporated into the micelle structure, rather than adhering superficially. The findings of this study contribute novel insights into the interaction between casein micelles and soy proteins and shed light on the mechanisms underlying their association.

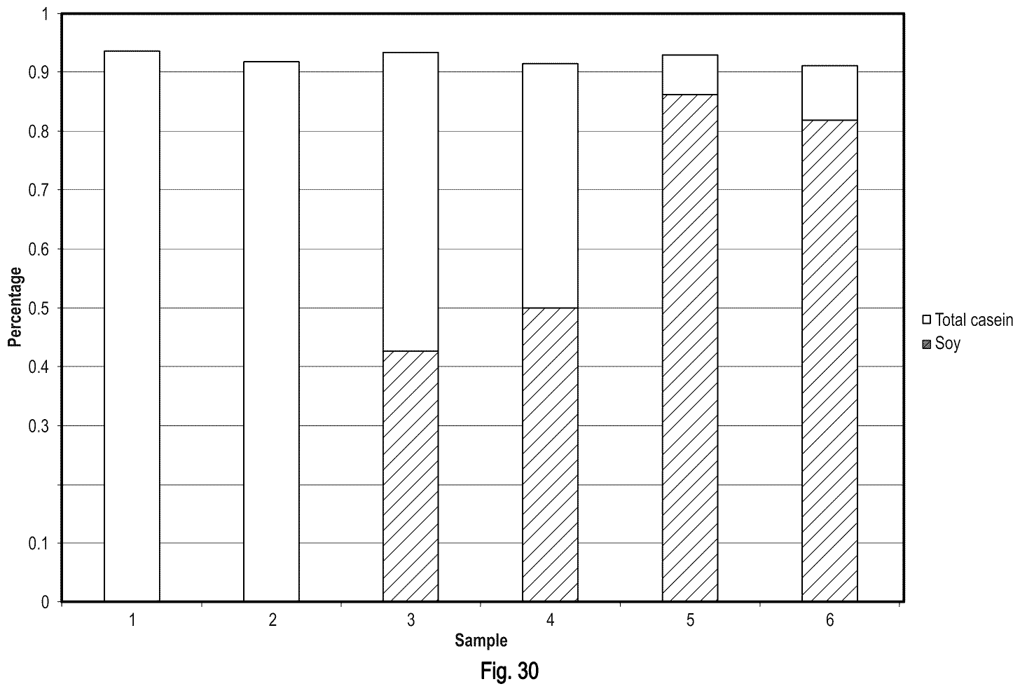

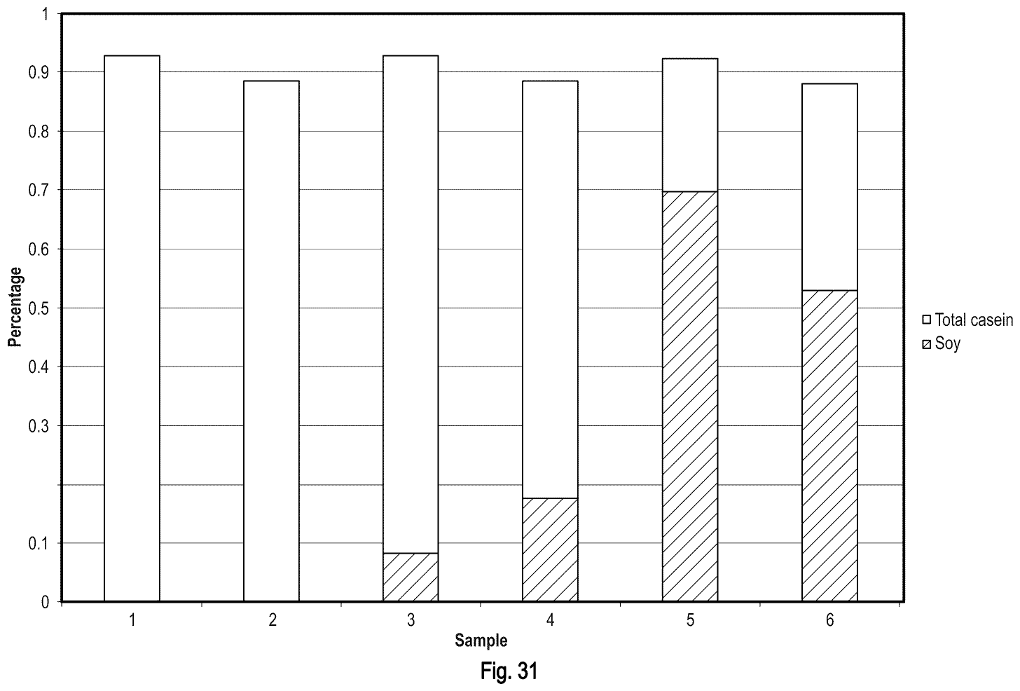

The experiment was performed on two separate occasions, with FIGS. 28 and 30 illustrating the results from the first experiment, and FIGS. 29 and 31 illustrating those from the second. In each of these four figures, columns 1 to 6 correspond to samples 1 to 6, as detailed in the protocol. FIGS. 28 and 30 display the percentages of κ-Casein, β-Casein, α_{S2}-Casein, and α_{S1}-Casein, as well as soy proteins, as determined by mass spectrometry (in step aa of the protocol). FIGS. 29 and 31, likewise, present the percentages of casein proteins and soy proteins, as reflected under mass spectrometry in the same step of the protocol.

With the use of cross-linkers, the first replicate reflected approximately 32% (w/w) of soy proteins inside the glycelle (FIG. 30 (col. 6 minus col. 4)) whereas the second reflected approximately 35% (w/w) of soy proteins inside the glycelle. (FIG. 31 (col. 6 minus col. 4)). Without the use of cross-linkers, the range of soy proteins inside the glycelle as a proportion of total proteins was larger, with 43% in the first replicate (FIG. 30 (col. 5 minus col. 3) and 62% in the second. (FIG. 31 (col. 5 minus col. 3).

It is known in the art that casein micelles are structures that encapsulate hydrophobic moieties. It is further known in the art that glycinin is amphiphilic, i.e. containing both hydrophobic and hydrophilic regions, but with an average hydropathicity that leans hydrophilic. For example the five glycinin genes GY1, GY2, GY3, GY4, and GY5 all score negative on the Kyte-Doolittle Hydropathy Index, scoring −0.700, −0.655, −0.617, −0.952, −0.839, respectively. In addition to finding soy proteins in the glycelle, the above experiment found GY4 in a greater amount than the other glycinin proteins, i.e., the most hydrophilic. This was a surprising result—both that hydrophilic compounds would be found in the hydrophobic core (at all) and that the glycinin that is the most hydrophilic would be found in the greatest amount in the hydrophobic core—as the state of the art suggested hydrophilic molecules would be segregated from the hydrophobic core of a casein micelle. In addition, the experiment found uncharacterized protein C6TC96, which has a hydrophilic GRAVY score of −1.125.

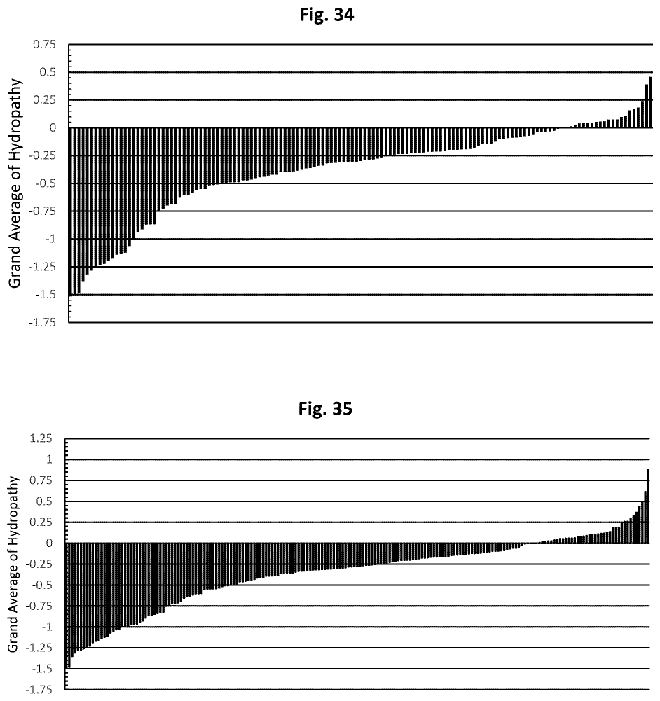

FIGS. 34 and 35 show the GRAVY (Kyte-Doolittle Hydropathy Index) scores for all the soy compounds found in the glycelles from samples 2 and 3 of the experiment, respectively. The first dataset (FIG. 34) consists of 139 GRAVY scores, which range from a minimum of approximately −1.51 to a maximum of approximately 0.45. These scores show the hydrophilic to hydrophobic continuum of soy compounds encapsulated in casein micelles. The mean GRAVY score across all compounds for the first set (FIG. 34) is approximately −0.37, with a standard deviation of 0.40, indicating a moderate level of dispersion in hydropathy among the compounds. The 25th percentile stands at about −0.51, the median at roughly −0.29, and the 75th percentile at approximately −0.09. This statistical distribution supports the notion that casein micelles can encapsulate a diverse array of soy compounds, ranging from highly hydrophilic to mildly hydrophobic. The second dataset (FIG. 35) consists of 199 GRAVY scores, which range from a minimum of approximately −1.49 to a maximum of approximately 0.88. The mean GRAVY score across all compounds for the second set (FIG. 35) is approximately −0.35, with a standard deviation of 0.42, indicating a moderate level of dispersion in hydropathy among the compounds. The 25th percentile stands at about −0.54, the median at roughly −0.28, and the 75th percentile at approximately −0.09.

### Example 10

### Determination of Varying Soy Concentrations on Formation of Glycelles

Objective: To investigate how varying the concentration of soy proteins impacts the formation and characteristics of glycelles.

Procedure:

1. Preparation of Soy Extracts with Varying Concentrations
Prepare soy extracts with different protein concentrations: 0.5×, 1×, 10×, and 50× (or up to the maximum concentration before the extract becomes overly viscous).
Determine the protein concentration of each soy extract using the Bradford Protein Assay.

2. Preparation of Hybrid Casein-Soy Micelle Solutions:
Prepare micelle solutions by mixing the standard concentration of Sigma caseins with each of the concentrated soy extracts.
As a control, prepare a micelle solution using distilled water instead of soy extract.

3. Quantification of Micelle Formation:
Measure the concentration of casein micelles formed in the control solution (with water) to approximate the concentration of micelles per 3 mL volume of sample.

4. Determination of Micelle-to-Soy Concentration Ratios:

Measure the concentration of micelles in each sample prepared with soy extracts.

Calculate the ratio of micelle concentration to soy protein concentration for each sample.

### Example 11

### Embodiment of an Experimental Procedure to Compare Olfactory Characteristics of Glycelle-Derived and Micelle-Derived Cheeses

Objective: The objective of the experiment is to evaluate and compare the olfactory characteristics of cheese derived from glycelles and micelle-derived cheese. Four key metrics were analyzed: strength of aroma, complexity of aroma, pleasantness of aroma, and duration of aroma.

Methodology: Synthesis of Glycelle-Derived Cheese and Micelle-Derived Cheese Samples: Two cheese specimens were prepared using glycelles and micelles respectively. Participant Selection: A limited sample size of individuals were selected to participate in the olfactory evaluation of both glycelle-derived and micelle-derived cheeses. Olfactory Evaluation: Participants were instructed to smell both types of cheeses separately and evaluate them based on a pre-established scorecard.

Evaluation Metrics: The cheese samples were compared on the characteristics of strength of aroma, complexity of aroma, pleasantness of aroma, and duration of aroma (lingering). A seven-point Likert scale was used for scoring. Scores of 1, 2, and 3 favored glycelle-derived cheese with “significantly,” “somewhat,” and “slightly” higher ratings, respectively. A score of 4 indicated “equal preference” for both types. Scores of 5, 6, and 7 favored micelle-derived cheese with “slightly,” “somewhat,” and “significantly” higher ratings, respectively.

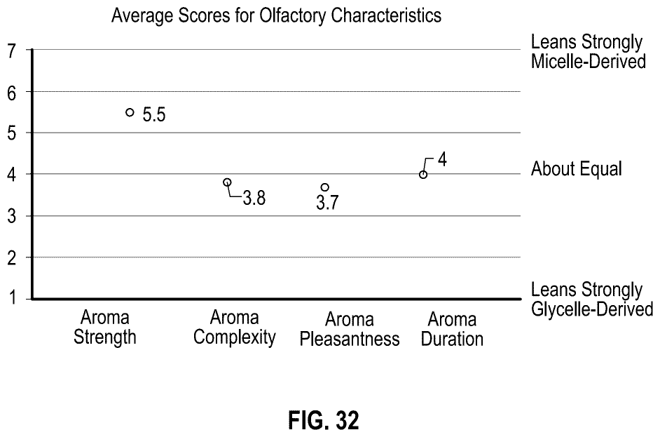

Results: The experiment was conducted and revealed nuanced preferences for olfactory characteristics between glycelle-derived and micelle-derived cheeses. For the Strength of Aroma, the mean score is 3.8 with a standard deviation of 2.2 and a mode of 1.0, ranging from a minimum of 1.0 to a maximum of 7.0. Complexity of Aroma has a mean of 3.7, a standard deviation of 1.25, and a mode of 4.0, with values ranging from 2.0 to 6.0. Pleasantness of Aroma shows a mean of 4.0, a standard deviation of 1.63, and a mode of 4.0, with a range between 1.0 and 6.0. Lastly, Duration of Aroma has a mean of 3.5, a standard deviation of 1.78, and a mode of 4.0, with values from 1.0 to 7.0. The modes and standard deviations further indicate that the evaluations are fairly evenly distributed across the cohort. FIG. 32 provides a visual representation of the mean values for each olfactory characteristic assessed in the study.

### Example 12

### Embodiment of an Experimental Procedure to Compare the Color of Glycelle-Derived Cheese with Micelle-Derived Cheese

The aim of this experiment is to evaluate the color differences between glycelle-derived and micelle-derived cheeses within the framework of the CIELAB color space. Both types of cheese are manufactured under identical conditions to isolate the impact of the derivation method on color attributes. Following production, the cheeses are subjected to colorimetric measurements for a comparative analysis.

Remove approximately 20 soybeans (approximately 2000 mg) from pods and immediately freeze them with liquid nitrogen (LN2)

Grind frozen soybeans into a fine powder

Extract soybean protein with DI water at a ratio of 1 mg of tissue to 1 μl of DI water for 30 mins boiling at 95° C.

12 g of soybeans was extracted with 12 mls of DI water

Dissolve the sigma caseins at the ratios below (vortexing vigorously after the addition of each casein) in the following solutions: 4 mL DI water and 2 mL soy lysate

α casein (including αS1-casein and αS2-casein): 14.6 mg/mL

β-casein: 8.3 mg/mL

κ-casein: 2.65 mg/mL

Adjust the pH of the solutions to 6.9.

Incubate the solutions at 37° C. with shaking (225 rpm) for 5 mins.

Add the following salts to the solutions at the ratios below and incubate at 37° C. shaking for 4 mins:

tripotassium citrate (216 mg/mL): 10 μL/mL of solution

potassium phosphate (35 mg/mL): 35 μL/mL of solution

Afterwards, add the following salts to the solutions at the ratios below and incubate at 37° C. shaking for 4 mins.

potassium phosphate (35 mg/mL): 6.25 μL/mL of solution

calcium chloride (31 mg/mL): 12.5 μL/mL of solution

Repeat the steps of adding these salts (paragraphs 364-366) 11 more times (12 total additions of the salts) keeping the solutions incubation at 37° C. shaking

Centrifuge the solutions at 1000 g for 5 mins to pellet the aggregates.

Transfer supernatant to a 100 kDa filter and centrifuge at 13000 g for 20 mins to separate micelles from monomeric caseins. Centrifuge at 13000 g for 20 mins two additional times.

Add 100 mg/ml citric acid solution in 5μl increments 6 times, invert the tube 3 times to mix well.

Make a stock of 10 μl vegetable rennet in 40 μl DI water and vortex. Add 4 μl of this stock solution to each tube, invert the tubes 3 times to mix well

Agitate the tubes at 41° C. for 20 minutes

Centrifuge the tubes for 3 minutes at 1000 g, remove supernatant and add 80° C. DI water to the tubes, mix well

Repeat the preceding step two more times

Place cheesecloth over the neck of an empty 50 ml tube and pour the solutions through the cheesecloth

Centrifuge the 50 ml tube with cheesecloth for 5 minutes at 2000 g

The cheeses are subjected to colorimetric measurements calibrated to the CIELAB color space after production. These measurements provide values for the L*, a*, and b* dimensions, which respectively quantify lightness and the green-red and blue-yellow chromatic components.

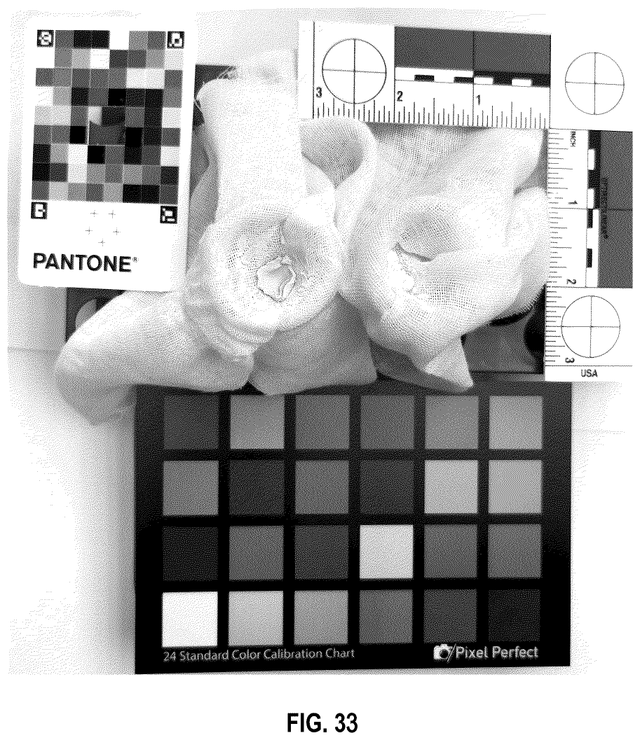

Result: As shown in FIG. 33, the color of glycelle-derived cheese, represented by CIELAB values (L*, a*, b*)=(87.486, −14.315, 30.563), was slightly darker and exhibits a pronounced greenish-yellow tint. In contrast, the color of micelle-derived cheese, characterized by (L*, a*, b*)=(89.59, 2.15, 9.30), is marginally lighter by 2.104 units in the L* scale and shows a subtle reddish-yellow tint. The most significant differences between the two types of cheese lie in their a* and b* values; the glycelle-derived cheese is substantially more green and yellow, with a difference of 16.465 units along the a* axis and 21.263 units along the b* axis compared to the micelle-derived cheese. Overall, the glycelle-derived cheese manifests as a light yellowish-green, while the micelle-derived cheese presents as a slightly lighter hue with faint reddish and yellowish tints.

### Example 13

### Embodiment of an Experimental Procedure to Compare Elasticity of Glycelle-Derived Cheese with Micelle-Derived Cheese Using Atomic Force Microscopy

The aim of this experiment is to evaluate the elasticity differences between glycelle-derived and micelle-derived cheeses using atomic force microscopy (AFM). Samples of glycelle-derived and micelle-derived cheese were prepared following the methods described in Example 12.

Each of the samples were then subjected to AFM elasticity measurement, wherein the tip of the AFM cantilever was brought into contact with the sample surface and then retracted. As the tip interacts with the surface, forces between the tip and the sample result in a deflection of the cantilever, which is measured as function of tip-sample separation, resulting in a force-distance curve. From this curve, various mechanical properties of the two samples were extracted, including Young's Modulus, by fitting the data to the Hertz model for elastic deformation.

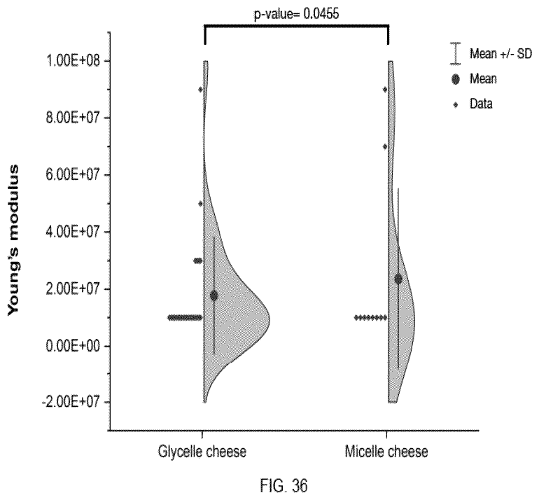

A summary of the resulting data is shown in FIG. 36. The cheeses have statistically-significant differences with respect to elasticity, with the glycelle-derived cheese showing enhanced “spreadability.” To assess the statistical significance of the observed elasticity differences, a two-tailed Mann-Whitney U test was employed. This is a non-parametric t-test for independent samples, ideal for comparing the medians of the two distributions in question.

### Prophetic Example A

In this proposed example, plant material is defatted in a hexane extraction process and subsequently processed according to salt coagulation and membrane filtration process described in Example 1a. In soybeans, the fat extracted in the soymilk process is removed with the coagulated protein. It is expected that removing the fat with the plant material will minimize membrane fouling from fat/oil. Plant oils are high in value. If the process economics dictate the fat first be captured, it is expected that the described process could still isolate and purify the recombinant protein.

### Prophetic Example B

In this proposed example a whole soymilk is first supplemented with dairy skim milk. The native plant proteins are coagulated and precipitated with magnesium chloride. The precipitated solids are removed in a centrifuge step and the supernatant collected. The ionic strength of the supernatant will be adjusted with sodium chloride to an ionic strength of 0.2 M. The salty supernatant is then concentrated and diafiltered with water containing sodium chloride at ionic strengths ˜0.2 M. It is expected that this example will improve the purity of the final retentate containing the casein protein.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the present disclosure may be employed in practicing the present disclosure. It is intended that the following claims define the scope of the present disclosure and that methods and structures within the scope of these claims and their equivalents be covered thereby.

1. A structure, comprising:
an outer layer comprising κ-casein; and
an interior comprising a non-milk particle and a casein protein comprising at least one of α_{S1}-casein, α_{S2}-casein, and β-casein.

2. The structure of claim 1, wherein the non-milk particle is hydrophilic or amphiphilic or both.

3. The structure in claim 1, wherein the non-milk particle is a non-bioactive compound.

4. The structure in claim 1, wherein the non-milk particle is a plant protein.

5. The structure in claim 1 wherein the non-milk particle comprises legumin, lectin, vicilin, prolamin, gliadin, β-conglycinin, or glycinin, or any combination thereof.

6. (canceled)

7. The structure in claim 1, wherein the non-milk particles comprise soy globulin 7S and 115 and wherein the ratio of the 7S and 115 (75/115) is lower than a naturally occurring ratio.

8. The structure claim 1, wherein the structure does not comprise at least one of α_{S1}-casein, α_{S2}-casein, or β-casein.

9. The structure in claim 1, wherein the interior comprises α_{S1}-casein, α_{S2}-casein, and β-casein.

10. The structure in claim 1, wherein the structure comprises at least two soy proteins.

11-13. (canceled)

14. A dairy or dairy-like composition comprising the structure in claim 1, wherein the structure confers upon characteristics of a dairy product selected from the group consisting of: taste, flavor, aroma, appearance, mouthfeel, density, structure, texture, elasticity, springiness, coagulation, binding, leavening, aeration, foaming, creaminess, and emulsification.

15-20. (canceled)

21. A method of making a structure of claim 1, comprising providing a solution comprising a non-milk particles; and mixing at least two casein proteins in a solution comprising a non-milk particle.

22-25. (canceled)

26. A composition, comprising: casein micelles; and a soy ingredient comprising at least one of a 7S or a 115, wherein the ratio of the 7S and the 11S (75/115) is lower than a naturally occurring ratio.

27. The composition of claim 26, wherein the casein micelle comprises a recombinant casein protein.

28-87. (canceled)

88. A method of making a dairy product, comprising:
providing a liquid mixture comprising casein micelles and at least one soy protein;
removing a portion of the soy protein from the liquid mixture; and adding an enzyme to the liquid mixture to cause the casein micelles to precipitate.

89. The method in claim 88, wherein at least one soy protein soy protein comprises a subunit of conglycinin.

90. (canceled)

91. The method in claim 88, wherein removing the portion of the soy protein from the liquid mixture decreases the ratio of the conglycinin to the glycinin (conglycinin/glycinin).

92. The method in claim 88, wherein the enzyme comprises at least one enzyme found in rennet.

93. The method in claim 88, wherein the enzyme comprises a protease.

94. The method in claim 88, wherein the enzyme comprises at least one of chymosin, pepsin or lipase.

95. The method in claim 88, wherein removing the portion of soy protein from the mixture comprises adding a salt to the liquid mixture to precipitate the portion of soy protein.

96. (canceled)

97. The method in claim 88, wherein removing the portion of soy protein from the mixture further comprises filtering the composition to produce a supernatant.

98-106. (canceled)

107. The method in claim 88, wherein the casein micelles precipitate to form a curd.

108. The method in claim 88, wherein the casein micelles precipitate to form a solid or semi-solid.

109-110. (canceled)

111. A composition, comprising: a casein micelle derived from a plant; and a plant protein comprising one of legumin, vicilin, prolamin, gliadin, β-conglycinin, or glycinin, or any combination thereof.

112-115. (canceled)

116. The composition of claim 111, wherein the plant protein is a soy protein.

117-314. (canceled)
